(19) United States
(12) Patent Application Publication
(10) Pub. No.: US 2022/0067241 A1
(43) Pub. Date: Mar. 3, 2022

(54) FLEX REPRESENTATION IN COMPUTER AIDED DESIGN AND COMPUTER AIDED ENGINEERING

(71) Applicant: Coreform LLC, Orem, UT (US)

(72) Inventor: Michael A. SCOTT, American Fork, UT (US)

(21) Appl. No.: 17/410,822

(22) Filed: Aug. 24, 2021

Related U.S. Application Data
(60) Provisional application No. 63/070,155, filed on Aug. 25, 2020.

(51) Int. Cl. G06F 30/23; G06F 30/17; G06T 17/20

(52) U.S. Cl. CPC G06F 30/23; G06F 2119/12; G06T 17/20; G06F 30/17

(57) ABSTRACT

Embodiments are presented for Flex Representation in Computer Aided Design (CAD) and Computer Aided Engineering (CAE). The Flex Representation Method (FRM) leverages unique computational advantages of splines to address limitations in the process of building CAE simulation models from CAD geometric models. Central to the approach is the envelope CAD domain that encapsulates a CAD model. An envelope CAD domain can be of arbitrary topological and geometric complexity. Envelope domains are constructed from spline representations, like U-splines, that are analysis-suitable. The envelope CAD domain can be used to approximate none, some, or all of the features in a CAD model. This yields additional simulation modeling options that simplify the model-building process while leveraging the properties of splines to control the accuracy and robustness of computed solutions. The potential of the method is illustrated through several carefully selected benchmark problems.

### 1 CROSS-REFERENCE TO RELATED APPLICATIONS

This application claims benefit of and priority to U.S. Provisional Patent Application Ser. No. 63/070,155, entitled “FLEX REPRESENTATION METHOD,” filed Aug. 25, 2020, the entire contents of which are included herein by reference.

### 2 BACKGROUND OF THE INVENTION

Prevailing computer aided design (CAD) representations, such as boundary representations, i.e., BREPs, must first be modified to admit a valid mesh and then meshed before a finite element simulation can be performed. These CAD preparation steps account for the majority of time spent in the overall simulation pipeline.

Most modern CAD software represent the shape of parts, and assemblies of parts, using BREPs. Many CAD objects are comprised of simple shapes that are amenable to current manufacturing techniques. These simple or analytical shapes include planar, conical, spherical, and toroidal surfaces and straight, arc, and elliptical curves. However, in many, if not most geometries of practical interest there are some surfaces and curves that cannot be described by analytic geometry. In these cases, splines, typically B-splines and NURBS (non-uniform rational B-splines), are used.

Examples of CAD geometry that include spline entities are shown in FIG. 1. FIG. 1, VIEW A is composed of analytic surfaces, analytic curves, and spline curves. FIG. 1, VIEW B is composed of analytic surfaces, analytic curves, spline surfaces, and spline curves. To form complex shapes like those shown in FIG. 1, multiple disconnected surfaces are trimmed and sewn together along curves of intersection.

Unfortunately, BREP CAD models composed of multiple trimmed surfaces also suffer from a very serious mathematical limitation: they are rarely watertight due to the mathematical properties of the surface intersection problem. Exact representation of intersection curves, when possible, requires unreasonably high degree polynomials and is limited by floating point implementations. Instead, low degree approximate intersection curves are used resulting in BREPs that appear watertight, but upon closer inspection, suffer from gaps, overlaps, and sliver surfaces. These artifacts of the trimming process are often called dirty geometry, since they negatively impact all downstream applications of the BREP geometry. For example, in simulation, it is preferable to have a watertight representation of geometry.

This means that all dirty geometry must be repaired before it can be used. Since the gaps and overlaps in a BREP result from rigid theoretical deficiencies in the representation, the entire BREP model is usually replaced with a mesh, which represents a faceted approximation to the original BREP geometry which can then be used during simulation. The process of generating a mesh from a BREP geometry is very often tedious, manual, time-consuming, expensive, and error-prone.

The mesh generation process also suffers from its own set of challenges that prevent automation, accuracy, and robustness in downstream processes like simulation. With an eye towards building U-splines, that require predominantly quadrilateral or hexahedral mesh layouts, we will focus on describing the challenges associated with hexahedral mesh generation.

There is no known algorithm that can produce a high-quality hexahedral mesh on any BREP input. This is demonstrated in FIG. 2 where each BREP surface has been meshed with a valid, but arbitrary, quadrilateral mesh. It is not possible to produce a quality hexahedral mesh on the interior of the BREP from the specified quadrilateral surface meshes.

Seemingly innocuous design features in a CAD model often complicate the meshing process, as shown on the quarter piston geometry in FIG. 3, VIEW A and 3, VIEW B. In this example, a standard fillet feature on the piston pin boss creates complex spline surfaces, as shown in FIG. 4, VIEW A, that are geometrically imprecise, as shown in FIG. 4, VIEW B, have boundaries that are not conducive to decomposition, as shown in FIG. 4, VIEW C, and, when decomposed into simpler subdomains that can be meshed, result in fragile meshes. By fragile it is meant that the subdomain admits a coarse hexahedral mesh, as shown in FIG. 3, VIEW B, that degrades in quality as it is refined, as shown in FIG. 4, VIEW D. As a result, when used in a computation these poorly shaped segments negatively impact the convergence characteristics of the solver in terms of increasing the time to convergence or impeding convergence altogether.

Another less appreciated challenge is that the application of simulation attributes to the BREP in traditional simulation workflows, like constraints or loads, must be respected by the layout of the hexahedral mesh. This means that if those attributes change, an entirely new hexahedral mesh must often be produced, typically requiring substantial additional time and/or cost.

An example of this is shown in FIG. 5. In FIG. 5, VIEW A to 5, VIEW D the circular surface over which a boundary condition will be applied gradually grows in size. The resulting decompositions grow in complexity, as seen in figures FIG. 5, VIEW E to 5, VIEW H which correspond to FIG. 5, VIEW A to 5, VIEW D, respectively.

One class of simulation techniques intended to address the challenges associated with simulation model preparation are called immersed finite element methods. In an immersed finite element method, the CAD model is immersed in a background mesh or grid that is simple to create. The literature on immersed finite element methods is vast. However, common to all approaches is the use of background grids that are created through simple affine mappings with rigid modeling limitations. In most cases, the background grid is a cube-like shape. Consequently, the salient, geometric features of the underlying CAD model are lost and, while these approaches may simplify the simulation model building process, steep accuracy and robustness limitations are incurred.

Of particular importance is that all these immersed approaches prescribe exactly one way to build the background grid. Very little modeling flexibility is available in these approaches, making it impossible to tailor the background grid to the problem at hand. This all or nothing approach has severely hampered the industrial adoption of immersed techniques for challenging industrial problems and applications where quantities of interest, like stress, must be accurate in prescribed areas of the model and convergence of nonlinear phenomena must be robust, and reliable. Without these core attributes, an immersed finite element model is not reliable as a tool for engineering decision making.

Smooth splines have recently gained some popularity in the context of these traditional immersed techniques. While their application to these traditional methods may improve the accuracy and robustness of these techniques, limitations similar to those described above still apply, especially in the context of BREP solid models.

An interesting line of research has been to adopt a trimmed BREP open surface model (e.g., a sheet metal part with well-defined boundaries for automotive application) as the background grid and to use the trimming information present in the BREP surface to apply quantities like tractions and boundary conditions.

However, this approach is limited. First, it is only applicable to surfaces since volumetric BREP technology (i.e., a BREP solid where the interior is also parameterized) does not exist. Next, even in the immersed surface case, the layout and parameterization of the underlying BREP is usually dirty and not suitable for simulation, requiring the same time consuming and expensive geometry cleanup procedures that, the immersed approach was expected to overcome. Last, since building high-quality quadrilateral meshes over CAD surfaces of arbitrary complexity is essentially a solved problem the advantages of an immersed surface approach are less apparent.

### 3 BRIEF SUMMARY OF THE INVENTION

Presented herein are embodiments for Flex Representation in Computer Aided Design (CAD) and Computer Aided Engineering (CAE). Embodiments include systems, methods, and computer program products for enabling a Flex Representation Method. As will be discussed herein, applications of the Flex Representation Method can improve upon, alleviate, or overcome many of the problems and limitations discussed above.

The Flex Representation Method (FRM) leverages unique computational advantages of smooth splines to address existing limitations and bottlenecks in the process of building CAE simulation models from CAD geometric models. A particular benefit of this work is simplifying the process of building simulation models from solid CAD parts although the approach can also be applied equally well to surfaces. While several approaches to this problem have been proposed, the FRM approach, as described herein, is novel and unique in the unprecedented and improved control over the properties of the simulation model that are available to the analyst. In summary, presented herein is a method capable of shortening the development cycle of a simulation model and produces simulation results that are accurate and tailored to the particular engineering application at hand.

Simulations and simulation results are a ubiquitous and necessary part of modern design and manufacturing. Simulations and simulation results produce information that predicts the expected performance of a natural or engineered part or system. For example, simulations in the automotive industry may predict failure of welded connections, forces felt by an occupant during a vehicle crash, or noise levels experienced by an occupant during normal operation of a vehicle.

Simulations and simulation results are important because they provide predictions of system performance that can be used enable engineers, analysts, and business decision-makers to improve the quality, cost, and efficiency of a natural or engineered system or part. Simulations and simulation results are used, for instance, to predict and determine the necessary strength of structural parts in myriad diverse applications such as buildings, bridges, automobiles, aircraft, bicycles, and countless others.

Central to the Flex Representation Method is the notion of an envelope CAD domain. An envelope CAD domain can be of arbitrary topological and geometric complexity. Envelope domains are constructed from spline representations that are mathematically formulated to be used as the basis for design and simulation. The envelope domain is in direct contrast to the use of simple, cube-like background grids in traditional immersed finite element methods. In particular, U-splines are used as an exemplary envelope CAD technology as it has the prerequisite mathematical properties to ensure accurate and robust computed solutions. The practical advantage of the envelope CAD domain is that it can be used to approximate none, some, or all of the features in the original CAD domain. This gives the analyst additional options that relax the geometric fit of the envelope domain to the CAD thus simplifying the process of producing a simulation model. In each case, the smooth, adaptive, higher-order spline basis recovers accurate simulation results. This continuum of simulation modeling possibilities is called the flex spectrum and the underlying modeling paradigm is called flex modeling.

Key contributions of the Flex Representation Method include the following:
The introduction of an analysis-suitable CAD representation, called the envelope domain, that is based on spline technology. U-spline technology is used to build the CAD envelope domain although this is not a requirement of the method.
A simple geometric modeling procedure, called flex modeling, for building complex envelope CAD domains that is based entirely on traditional CAD design paradigms and finite element meshing technology. As a consequence, the FRM approach should be familiar to users of finite element technology. Of particular importance is the introduction of virtual CAD topology as a means to guide the spline creation process, resulting in high-fidelity spline models that both fit the selected features of the underlying CAD to high precision and are suitable for the simulation at hand.
To build the envelope CAD domain, a generic spline to CAD fitting procedure is presented that is based on Bézier projection, is iterative, and is equally applicable to curves, surfaces, and volumes.
The designer or analyst can leverage the flex modeling spectrum to tailor the envelope CAD domain to capture only geometric features of interest, thus greatly simplifying the simulation model preparation process. By building an envelope domain that captures only the macroscopic features of a CAD model, it is shown that much more accurate simulation results can be achieved than is possible with both traditional immersed and finite element approaches, while still dramatically reducing both model preparation time and degree of freedom count.
Central to the FRM is the use of highly nonlinear spline-based geometric mappings to define the CAD envelope domain. Since quantities like tractions and boundary conditions are applied directly to the immersed CAD model, to accommodate them in the FRM simulation framework requires that these geometric mappings be inverted frequently and efficiently. To accomplish this, a robust and performant point inversion algorithm for unstructured spline representations like U-splines is described.
Although the focus is on volumetric envelope domains, the FRM approach can also be applied to constructing surface envelope domains as well.

### 4 BRIEF DESCRIPTION OF THE DRAWINGS

In order to describe the manner in which advantages and features described herein can be implemented and obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1: CAD geometry that includes spline geometry.

FIG. 2: Producing a high-quality hexahedral mesh on the interior of this BREP solid given the bounding quadrilateral surface mesh remains an unsolved problem.

FIG. 3: This seemingly simple example required twelve hours for an experienced FEA analyst to mesh.

FIG. 4: Common challenges that must be overcome to produce high-quality hexahedral meshes.

FIG. 5: Applying simulation attributes, like boundary conditions, often changes the underlying BREP requiring an entirely new mesh.

FIG. 6: A midsurface CAD geometry m[ [symbol] ] representing a sheet metal automotive component that will be converted into a U-spline.

FIG. 7: The highlighted surface is split into two surfaces that provide a more consistent representation of the blend feature.

FIG. 8: The CAD is further modified by compositing CAD surfaces into macrosurfaces. The macrosurface layout, guides the mesh generation algorithm to produce a high quality quadrilateral mesh.

FIG. 9: The geometry is meshed. The blend feature is accurately captured by the mesh.

FIG. 10: Finally, m[Δ] is converted into m[U].

FIG. 11: The decompose, imprint, and merge process.

FIG. 12: The process of converting a CAD volume into a U-spline volume leveraging CAD modification and hexahedral mesh generation.

FIG. 13: Bézier projection is used to determine the U-spline control points for the second cell of a cubic B-spline with [symbol] continuity.

FIG. 14: Geometric modeling concepts for U-spline flex modeling.

FIG. 15: An example flex spectrum. The CAD surfaces that will be defeatured (light highlight), immersed (medium highlight), and body-fit (dark highlight) are highlighted.

FIG. 16: The CAD envelope domains for each approach.

FIG. 17: A comparison of the decompositions and resulting hexahedral meshes for each approach.

FIG. 18: The U-spline envelope domains for each approach. The associated physical domain, when different than the envelope domain, is also shown.

FIG. 19: Detail of the immersed region for the [symbol] ₁ approach.

FIG. 20: Segment partitioning shown for the example envelope domain from FIG. 14.

FIG. 21: Graphical representation of the subdivision approach to building an integration rule for a given segment on the example U-spline mesh with a subdivision depth of k=3.

FIG. 22: Computation of the Bézier control points for a sequence of subsegments in a simple one-dimensional degree two Bézier curve.

FIG. 23: The quadrature points for the example segment from FIG. 21.

FIG. 24: Flowchart. of the inverse mapping spatial filter step.

FIG. 25: A BVH tree built from a partition of the envelope geometry into nine Bézier segments as shown in FIG. 14. Note that the bounding volume type has not yet been specified.

FIG. 27: Flowchart of the inverse mapping predictor and corrector step.

FIG. 28: Representation of the boundaries used in the derivation of the strong form for an abstract geometry embedded in an envelope domain.

FIG. 29: Example geometries for exploring surface CAD fitting.

FIG. 30: Three CAD objects describing the same geometry from FIG. 29, VIEW A, which consists of a planar surface with a raised section on its interior and fillets blending the two regions together.

FIG. 31: Generated mesh, m[Δ], on each CAD object using the same approximate global mesh size.

FIG. 32: Constructing a U-spline, m[U], from each method's m[Δ] and evaluating the error (scaled by the thickness of the entire part) for each fit.

FIG. 33: Three CAD objects describing the same geometry from FIG. 29, VIEW B, which consists of a planar surface with a recessed section on its interior and fillets blending the two regions together.

FIG. 34: Generated mesh, m[Δ], on each CAD object using the same approximate global mesh size.

FIG. 35: Constructing a U-spline, m[U], from each method's m[Δ] and evaluating the error (scaled by the thickness of the entire part) for each fit.

FIG. 36: Fitting a U-spline surface to the knuckle CAD solid part.

FIG. 37: Three CAD topology strategies for beginning the CAD fitting workflow.

FIG. 38: Comparing the generated m[Δ] produced by each approach.

FIG. 39: Resulting m[U] approximations to m[ [symbol] ].

FIG. 40: Plotting the fitting error, scaled by the height of the bracket, for each m[U].

FIG. 41: Time comparison of local vs global fitting for fitting a U-spline to a spherical shell with 6 to 24,000 quadrilateral segments.

FIG. 42: Convergence rates of the [symbol] ₂ error of the local fitting routine in approximating one half cycle of a sine function. Guide lines are included to indicate optimal p+1 convergence rates.

FIG. 43: Problem areas in the global [symbol] ₂ fitting routines which are fixed with progressive local fitting based on Bézier projection.

FIG. 44: Fitting a cubic U-spline to a sheet metal part.

FIG. 45: Fitting a quadratic U-spline to a gasket cover.

FIG. 46: Fitting a quadratic U-spline volume to a spinal implant model

FIG. 47: Fitting a quadratic U-spline volume to a knuckle geometry.

FIG. 48: Cast-iron C-Frame subjected to 3000-lb separating force. The expected location of failure is marked by ★.

FIG. 49: CAD model of the C-Frame as received by the FEM Analyst

FIG. 50: Load regions of the C-Frame. Reasonable approximations of these regions are allowable.

FIG. 51: Mesh layout for the Flex model. This is the coarsest Flex mesh used in the refinement study shown in FIG. 53.

FIG. 52: Comparing the computed principal stress, σ₁, results of a refined Flex model computed in Coreform IGA to results computed in an existing commercial FEA code.

FIG. 53: Comparing the computed maximum principal stress, σ₁, at ★, and mesh-convergence, between the Flex results computed in Coreform IGA and a commercial FEA solver using standard linear hex elements.

FIG. 54: Design constraints for an engine bracket. The left figure shows the design envelope and the other two figures show the applied load and boundary conditions.

FIG. 55: A design optimization work flow.

FIG. 56: Simulation results for each of the design candidates from FIG. 55, showing von Mises stress distribution.

FIG. 57: Boundary conditions and dimensions for the plate with a circular hole problem.

FIG. 58: Three envelope domains and meshes (light grey) in the flex continuum for the plate with a circular hole problem.

FIG. 59: A comparison of the convergence rates of the error in the relative strain energy for [symbol] _{0̅} with the symmetry constraints enforced strongly and weakly.

FIG. 60: Relative error in the strain energy norm for the different choices for the envelope manifold shown in FIG. 58.

FIG. 61: Relative error in the strain energy norm for [symbol] _{∞} with varying radii for different levels of uniform h-refinement.

FIG. 62: We change the orientation of the mesh while keeping the CAD geometry unchanged for [symbol] ₁ as shown on the left. The relative error in the strain energy norm is plotted for several levels of mesh refinement.

FIG. 63: A plate with an elliptical hole and the rotated envelope domain.

FIG. 64: Contour plots of the stress component that is orthogonal to the major axis of the elliptical hole with a=1, b=0.5.

FIG. 65: Contour plots of the stress component that is orthogonal to the major axis of the elliptical hole with a=2, b=0.5.

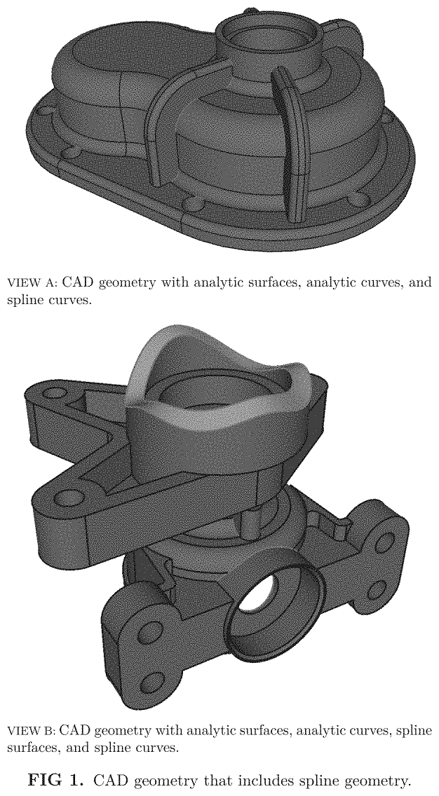

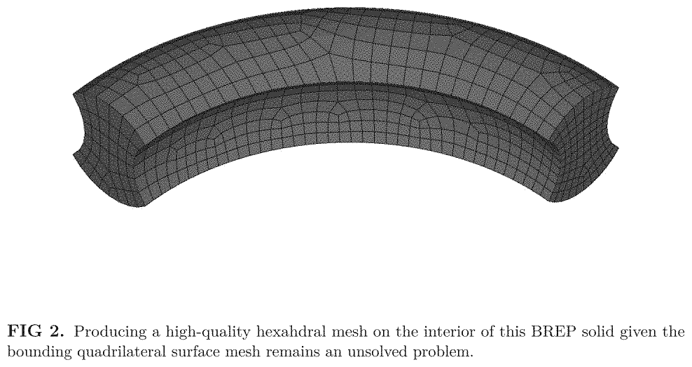

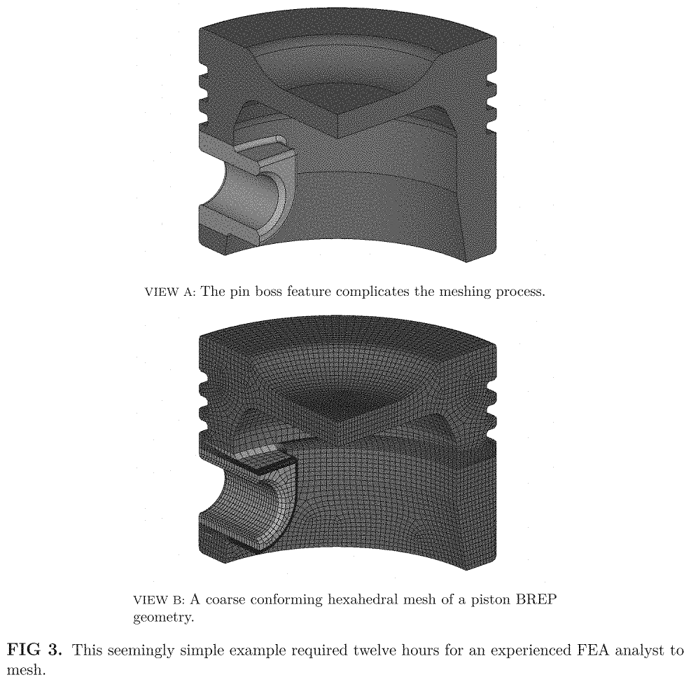

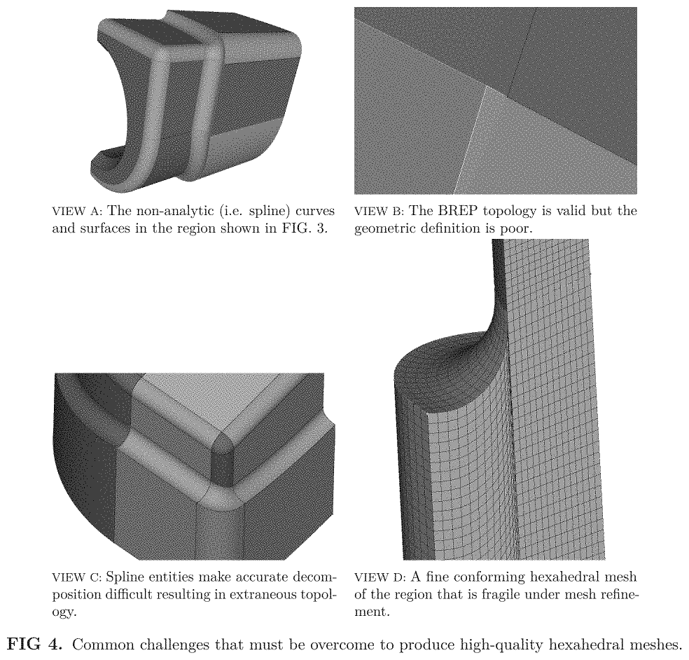

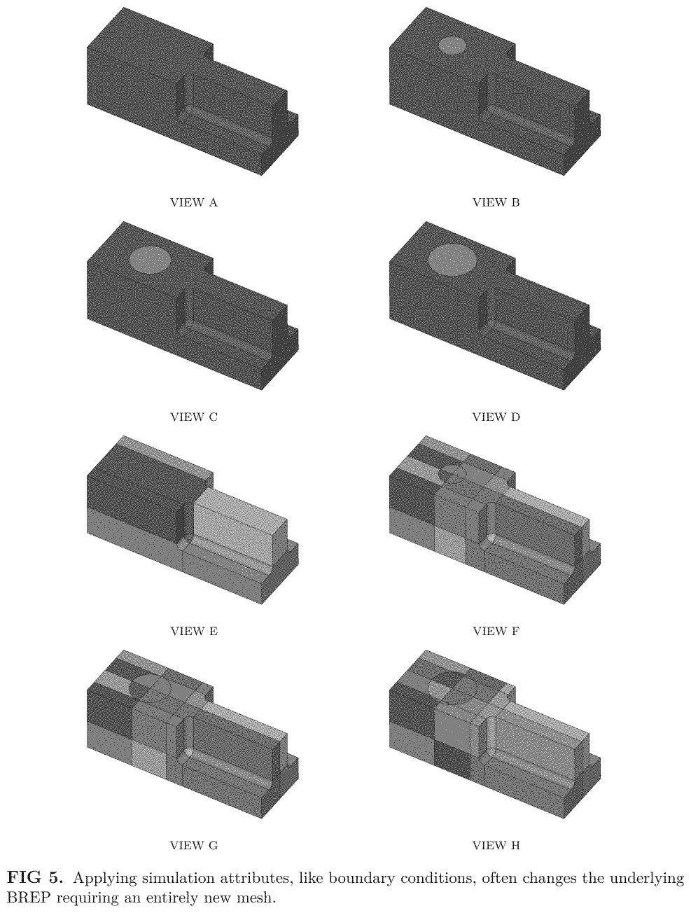

### 5 DETAILED DESCRIPTION

Presented herein are embodiments for Flex Representation in Computer Aided Design (CAD) and Computer Aided Engineering (CAE). Embodiments include systems, methods, and computer program products for enabling a Flex Representation Method. As will be discussed herein, applications of the Flex Representation Method can improve upon, alleviate, or overcome many of the problems and limitations discussed above.

The Flex Representation Method (FRM) leverages unique computational advantages of smooth splines to address existing limitations and bottlenecks in the process of building CAE simulation models from CAD geometric models. A particular benefit of this work is simplifying the process of building simulation models from solid CAD parts although the approach can also be applied equally well to surfaces. While several approaches to this problem have been proposed, the FRM approach, as described herein, is novel and unique in the unprecedented and improved control over the properties of the simulation model that are available to the analyst. In summary, presented herein is a method capable of shortening the development cycle of a simulation model and produces simulation results that are accurate and tailored to the particular engineering application at hand.

Simulations and simulation results are a ubiquitous and necessary part of modern design and manufacturing. Simulations and simulation results produce information that predicts the expected performance of a natural or engineered part or system. For example, simulations in the automotive industry may predict failure of welded connections, forces felt by an occupant during a vehicle crash, or noise levels experienced by an occupant during normal operation of a vehicle.

Simulations and simulation results are important because they provide predictions of system performance that can be used enable engineers, analysts, and business decision-makers to improve the quality, cost, and efficiency of a natural or engineered system or part. Simulations and simulation results are used, for instance, to predict and determine the necessary strength of structural parts in myriad diverse applications such as buildings, bridges, automobiles, aircraft, bicycles, and countless others.

### 5.1 U-Spline Preliminaries

### 5.1.1 the Bernstein Polynomials

A fundamental U-spline building block is the Bernstein polynomial basis. A univariate Bernstein polynomial Bᵢ^{p}:Ω̅→ [symbol] , i=0, . . . , p, is defined over a parent domain Ω̅=[0,1] as

$${B}_{i}^{p} ( ξ ) = ( \begin{matrix}p \\ i\end{matrix} ) {{ξ}^{i} ( 1 - ξ )}^{p - i} \qquad ( 5.1 )$$

where p is the polynomial degree and ξ∉Ω̅ is the parent coordinate. We denote the space spanned by the Bernstein polynomial basis by B and call it the Bernstein space. The Bernstein space is complete through polynomial degree |p|. In other words, all polynomials up through degree p are contained in B. The Bernstein polynomials possess many additional desirable properties such as pointwise nonnegativity and partition of unity.

### Multivariate Bernstein Polynomials

In a d-dimensional multivariate setting, Bernstein polynomials are commonly defined over boxes (e.g., quadrilaterals and hexahedra) and simplicial parent domains (e.g., triangles and tetrahedra). The multivariate Bernstein basis functions presented here possess similar derivative ordering properties to the univariate basis described previously. To accommodate this d-dimensional extension, we introduce a dimensional index k∉{0, . . . , d}.

### Box

A multivariate Bernstein polynomial Bᵢ^{p}:Ω̅→ [symbol] is defined the d-dimensional hypercube or box Ω̅=ₖ₌₀^{d-1}[0,1] as the tensor product of univariate Bernstein polynomials

$${B}_{i}^{p} ( ξ ) = {\prod }_{k = 0}^{d - 1} {B}_{{i}_{k}}^{{p}_{k}} ( {ξ}_{k} ) \qquad ( 5.2 )$$

where i=(i₀, . . . , i_{d-1}) and p=(p₀, . . . , p_{d-1}) are tuples with iₖ and pₖ representing the univariate Bernstein basis function index and degree in dimensional direction k, respectively, and the parent coordinate ξ=[ξ₀, . . . , ξ_{d-1}]∉Ω̅.

### Simplicial

A multivariate Bernstein polynomial Bᵢ^{p}:Ω̅→ [symbol] is defined over the convex hull of the d-dimensional unit simplex Ω̅={ξ=[ξ₀, . . . , ξ_{d}]∉ [symbol] ^{d+1}:Σₖ₌₀^{d} ξₖ=1 and ξₖ≥0 for k=0, . . . , d} as

$${B}_{i}^{p} ( ξ ) = p ! {\prod }_{k = 0}^{d} \frac{{ξ}_{k}^{{i}_{k}}}{{i}_{k} !} \qquad ( 5.3 )$$

where i={iₖ: 0≤k≤d, Σₖ₌₀^{d} iₖ=p} is an index tuple, p is the polynomial degree, and the parent coordinate ξ∉Ω̅ is commonly called a barycentric coordinate. For each boundary of the simplex, the nonzero entries in the basis are precisely the basis for the simplex of dimension d−1. Observe that the standard univariate Bernstein basis is merely a special case of the multivariate simplicial form.

### 5.1.2 the Bézier Mesh

As mentioned in the previous section, a key property of U-splines is the ability to construct a spline basis on an unstructured Bézier mesh. A Bézier mesh B is defined by
1. A polyhedral mesh topology,
2. A local parameterization on each cell in the mesh,
3. A Bernstein space B assigned to each cell in the mesh,
4. A minimum level of continuity specified on each interface between cells.

In this section, the notation used throughout the remainder of this paper to describe a Bézier mesh is introduced.

### Topology

Formally, the Bézier mesh is a tiling of a d-dimensional manifold with box and simplex k-cells, k≤d, where k is the dimension of the cell. More precisely, the Bézier mesh B is a cell complex where:
Each k-dimensional cell c is a closed subspace of [symbol] ^{d},
Any lower-dimensional cell a⊂c is also in B,
The non-empty intersection of any two cells a and b in B is a lower-dimensional cell contained in both.

We have the following correspondence to common mesh entities:

| | d = 1 | d = 2 |
|---|---|---|
| d-cell | Edge | Face |
| (d − 1)-cell | Vertex | Edge |
| (d − 2)-cell | — | Vertex |

When a dimension-agnostic description is appropriate for a concept, we employ the generic terminology d-cell, (d−1)-cell, etc. For simplicity, we occasionally refer to d-cells, or elements, by E, (d−1)-cells, or interfaces, by 1, 2-cells, or faces, by f, 1-cells, or edges, by e, and 0-cells, or vertices, by ν. We denote the set of cells of dimension k in the mesh B by C^{k}(B).

### Cell Domains and Parameterization

Building splines over a Bézier mesh requires that a domain and right-handed coordinate system be specified over each cell. These coordinate systems may change from cell to cell to accommodate extraordinary vertices or cells of different type, such as between box-like and simplicial cells.

Each cell c is assigned a parent domain Ω̅ and a right-handed orthogonal coordinate system ξ∉Ω̅ or when referencing a particular cell c, Ω̅^{c} and ξ^{c}, respectively. We define Ω̅^{B}=U_{c∉B} Ω̅^{c}. For box cells, Ω̅ is assumed to be a unit hypercube with a cartesian coordinate system and, for simplicial cells, Ω̅ is taken to be the convex hull of a unit simplex with barycentric coordinates. The parent domain is defined in this way to simplify or standardize the implementation and evaluation of a Bernstein basis.

Likewise, each cell c is also assigned a parametric domain \hat{Ω} and a right-handed orthogonal coordinate system s∉\hat{Ω} or, when referencing a particular cell c, \hat{Ω}^{c} and s^{c}, respectively. We define \hat{Ω}^{B}=U_{c∉B}\hat{Ω}^{c}. More specifically, the parametric domain of a box cell is assumed to be a hyperrectangle with Cartesian coordinates. The parametric domain of a simplicial cell will be the convex hull described by the simplex whose edges have been assigned arbitrary lengths but which are usually set to be equal to the parametric size of adjacent box cells. Barycentric coordinates are again assumed for the simplicial parametric domain. Although not discussed further in this work, the relative parametric sizes of adjacent cells must be chosen carefully so as to admit a well-defined smooth spline basis.

### Cell Space and Degree

A box or simplicial Bernstein space B is assigned to each cell c and is denoted by B^{c}. We denote the total degree of polynomial completeness of the Bernstein space on c by |p^{c}|.

### Interface Continuity

Given a d-dimensional mesh B, each interface I is assigned a required minimum continuity ν. We denote the continuity ν assigned to an interface | by ν^{|}. Note that for certain mesh configurations, the U-spline basis may be smoother than the specified conditions on the interfaces. We say that an interface | has reduced continuity with respect to an adjacent d-cell E if ν^{|}<p_{|}^{⊥}(E)−1 where p_{|}^{⊥}(E) is the degree on a d-cell E in the direction perpendicular to the adjacent interface |. We say that an edge is creased if it has been assigned [symbol] ⁰ or [symbol] ⁻¹ continuity and a vertex is creased if all adjacent edges are creased.

### 5.1.3 U-Spline Meshes and Spaces

To simplify the construction of a. U-spline basis, we define a class of admissible Bézier meshes, which we call U-spline meshes and denote by U. A U-spline mesh is a Bézier mesh with admissibility constraints placed on the layout of cells, the degree, and the smoothness of interfaces. Admissibility constraints are imposed through appropriate separation and grading conditions on degree and continuity transitions throughout the Bézier mesh. The mathematical properties of the corresponding admissible U-spline space [symbol] can be controlled a priori by specifying the properties of the underlying Bézier mesh topology.

The mathematical properties satisfied by a U-spline space are:
Local linear independence: The set of U-spline basis functions are locally linearly independent. This means that, for any submuesh K⊂U, Σ_{A} c_{A} N_{A}(s)=0 for all s∉\hat{Ω}^{K}, where c[U]={c_{A}} is a set of real coefficients, if and only if c[U]=0.
Completeness: A set of U-spline basis functions is complete through total polynomial degree

$$\vert {q}^{c} \vert = {min}_{a ∈ NI ( c )} \vert {p}^{a} \vert \qquad ( 5.4 )$$

over \hat{Ω}^{c}. Additionally, a U-spline space is complete through total polynomial degree

$$\vert {q}^{U} \vert = {min}_{c ∈ U} \vert {q}^{c} \vert \qquad ( 5.5 )$$

over \hat{Ω}^{U}. In other words, there exists a set of real coefficients {c_{A}} such that Σ_{A} c_{A} N_{A}(s)=s^{r} for any r≤|q^{c}|, s∉\hat{Ω}^{c} or r≤|q^{U}|, s∉\hat{Ω}^{U}.
Pointwise non-negativity: A set of U-spline basis functions are pointwise non-negative. More precisely, N_{A}(s)≥0 for all s∉\hat{Ω}^{U}, A=1, . . . , |UF(U)| where UF(U) is the set of U-spline basis functions that are non-zero over \hat{Ω}^{U}.
Partition of unity: A set of U-spline basis functions forms a partition of unity. In other words, Σ_{A} N_{A}(s)=1 for all s∉\hat{Ω}^{U}.
Compact support: Compact support simply means that for any U-spline basis function N_{A} there exists a submesh K_{A}⊂U such that for any s∉\hat{Ω}^{U}

$$\{ \begin{matrix}{N}_{A} ( s ) > 0 & s ∈ {\hat{Ω}}^{{K}_{A}} , \\ {N}_{A} ( s ) = 0 & otherwise .\end{matrix} \qquad ( 5.6 )$$

It is desirable for the submesh K_{A} to be as small as possible to preserve the sparsity of linear systems written in terms of the basis functions.

### 5.1.4 U-Splines in Extracted Form

A key practical and conceptual development in the field of IGA was the advent of Bézier extraction as an analysis technology. Bézier extraction allows global spline functions to be evaluated locally on a Bézier cell. More generally, Bézier extraction is a method of providing a Bernstein representation of spline functions while maintaining the connection to global spline representation. Bernstein representations are central to representing U-splines, and this section serves to present the necessary notation that will be used throughout the rest of this paper.

For convenience, we often arrange the Bernstein an(d U-spline basis functions that are nonzero over cell c into vectors, denoted by B^{c} and N^{c}, respectively. We can then arrange the Bernstein basis vector coefficients on k-cell c for each U-spline basis function into corresponding rows in a matrix C^{c}∉ [symbol] ^{|N}^{^{c}}^{|×|B}^{^{c}}^{|}, called a cell or element extraction matrix. We then have the extracted form of the U-spline basis:

N^{c}(ξ^{c})=C^{c}B^{c}(ξ^{c}),ξ^{c}∉Ω̅^{c}. (5.7)

In this case, we call the Bernstein basis vector coefficients extraction coefficients. Note that at times it is convenient to combine the cell extractions matrices into a global extraction matrix C. Representing U-spline basis functions in extracted form is a powerful and convenient abstraction when generalizing finite element frameworks to accommodate smooth spline bases like U-splines. In particular, it is the preferred and simplest representation for smooth splines when the underlying algorithms used to generate the spline basis are not the primary concern.

### 5.1.5 U-Spline Manifolds

We associate a closed subset of [symbol] ⁿ, called a k-manifold m^{k} or m, for short, to every k-cell c in a U-spline mesh U. A k-dimensional manifold is constructed through an invertible mapping m[\hat{Ω}^{c}]:\hat{Ω}^{c}→m[c]. The k-dimensional manifold corresponding to U is denoted by m[U] and is defined as

$$\begin{matrix}m [ U ] = {⋃}_{c ∈ U} m [ c ] ( 5.8 ) \\ = {⋃}_{c ∈ U} m [ {\hat{Ω}}^{c} ] . ( 5.9 )\end{matrix} \qquad$$

Each geometric mapping m[\hat{Ω}^{c}] is defined as

$$m [ {\hat{Ω}}^{c} ] ( {s}^{c} ) = {\sum }_{{N}_{A} ∈ UF ( c )} {X [ U ]}_{A} {N}_{A} ( {s}^{c} ) , {s}^{c} ∈ {\hat{Ω}}^{c} \qquad ( 5.10 )$$

where UF(c) is the set of U-spline basis functions that are non-zero over \hat{Ω}^{c} and X[U]_{A} is an n-dimensional manifold coefficient.

We use the following common geometric terms for k-manifolds, k≤d≤n:

| | d = 1 | d = 2 | d = 3 |
|---|---|---|---|
| d-manifold | Curve c | Surface s | Volume v |
| (d − 1)-manifold | Point p | Curve c | Surface s |
| (d − 2)-manifold | — | Point p | Curve c |
| (d − 3)-manifold | — | — | Point p |

We also use, for notational simplicity, \hat{Ω} and Γ̅ to indicate d− and d−1-dimensional parametric domains, respectively. We call a point x∉ [symbol] ⁿ a spatial point.

We call an arbitrary subdomain ∉⊂m a segment, or if more specificity is required we use ∉^{m}. A set of segments is denoted by Δ. The parametric domain of a segment is denoted by \hat{Ω}[∉]. A set consisting of all segments generated by some generic partitioning of a manifold m is given by Δ(m). A bounding volume of ∉^{m} is a superset of ∉^{m} and is denoted by bν(∉^{m}) while a set of bounding volumes associated with a given manifold m is denoted by BV(m). We also frequently use the power set P. The power set of an arbitrary set S, denoted by P(S), is defined as the collection of all the subsets of S including the empty set and the set S itself.

5.2 Building U-Splines from CAD

We focus on constructing U-spline manifolds through a fitting procedure to an existing CAD representation. To accomplish this, the U-spline k-manifold m[U] or m for short is designed through the following process:
1. A CAD model of the desired envelope shape, denoted by m[ [symbol] ], is created.
2. CAD modification is performed as needed on m[ [symbol] ] to create m[ [symbol] ]. The CAD modification process is used to both eliminate dirty geometry in m[ [symbol] ] and to produce a topological layout to guide the mesh generation algorithm to produce a mesh that is optimal for the U-spline basis construction and subsequent CAD fitting steps.
3. A mesh generation algorithm is then used to create a piecewise d-linear approximation to m[ [symbol] ], denoted by m[Δ], where Δ denotes the underlying mesh. The mesh provides the topology and a parametric domain for the construction of the U-spline basis and initial approximate CAD mapping m[Δ][\hat{Ω}^{Δ}]:\hat{Ω}^{Δ}→m[Δ]. Numerous techniques are available for constructing m[Δ]. We focus on leveraging techniques widely available in mesh generation software, with a particular focus on Coreform Cubit.
4. We assume that m[ [symbol] ] is sufficiently well-defined that a closest point mapping can be constructed efficiently. This closest point mapping, denoted by κ [symbol] : [symbol] ⁿ→m[ [symbol] ], maps a given spatial point in [symbol] ⁿ to the closest point, in m[ [symbol] ]. Given the mesh an the closest point mapping, we can define the following map

[symbol]

Δ[\hat{Ω}^{Δ}](s)=κ [symbol] ∘m[Δ][\hat{Ω}^{Δ}](s),s∉\hat{Ω}^{Δ}. (5.11)
This map both provides an initial approximation to m[ [symbol] ] and parameterization for U-spline fitting.
5. A Bézier mesh B is created from the mesh topology in m[Δ]. Cell domains, parameterizations, degrees, and Bernstein-like spaces are assigned to B.
6. The Bézier mesh B is modified to ensure admissibility and that the resulting U-spline mesh U and space [symbol] are appropriate for the problem at hand.
7. A U-spline manifold m[U] is created by fitting to the CAD m[ [symbol] ]⊂ [symbol] ⁿ. A set of U-spline manifold coefficients (also called control points) X[U] is determined such that the resulting U-spline manifold mapping m[U][\hat{Ω}^{U}]:\hat{Ω}^{U}→m[U] closely approximates m[ [symbol] ], i.e., m[U]≈m[ [symbol] ]. The overall U-spline to CAD fitting workflow is dimension agnostic and includes a progressive approach to volume, surface, curve, and point fitting and iteration to improve the fit as dictated by an appropriate error metric.

### 5.2.1 CAD Modification and Meshing for U-Spline Surfaces

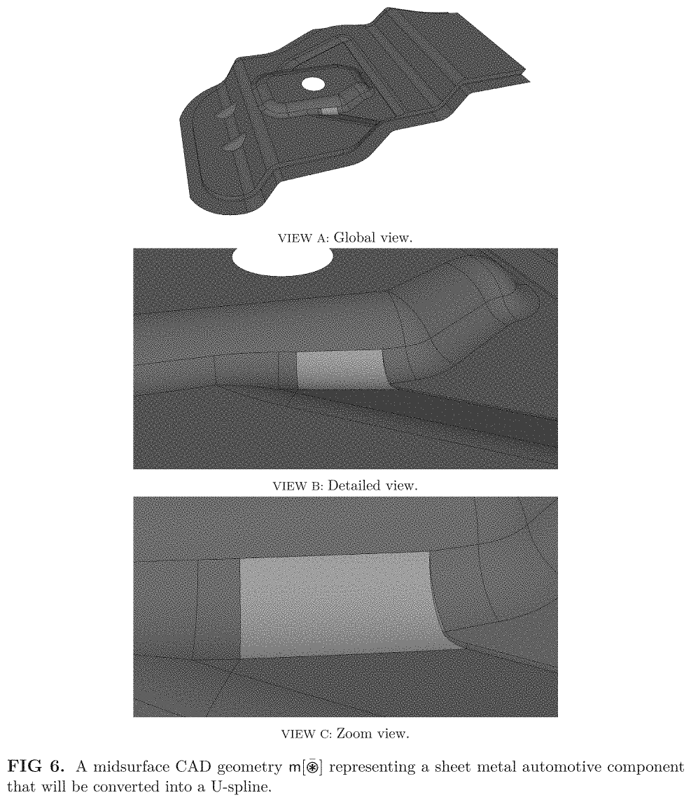

We demonstrate in FIGS. 6 to 10 an example of CAD modification and meshing for a simple CAD surface that results in a high-quality U-spline surface s that closely approximates m[ [symbol] ]. As shown in FIG. 6, VIEW A to 6. VIEW C, a CAD geometry representing a sheet metal automotive part is considered. As a first step, a highlighted surface associated with a blend feature is split producing a modified CAD object, denoted by m[ [symbol] ], that will maximize the quality of the mesh. Additionally, a potentially troublesome sliver surface is identified immediately to the right of this surface. This sliver surface, if meshed in its current state, would require a very small mesh size and likely lead to poor mesh quality due to the small angle at its upper vertex.

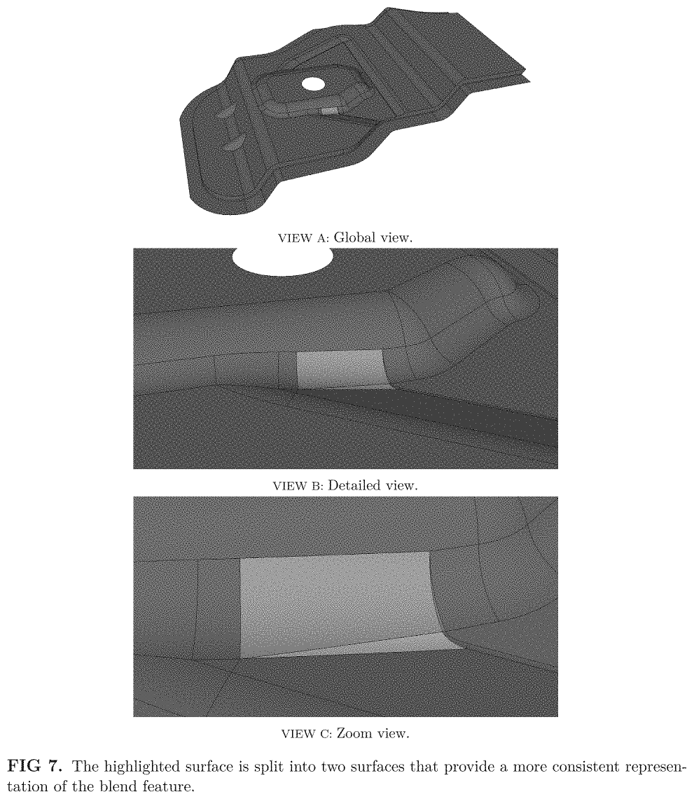

In FIG. 7, VIEW A to 7, VIEW C, a surface-splitting operation is performed on the highlighted surface, decomposing it into two regions as shown in FIG. 7, VIEW C. The top region retains a clear association with the blend feature while the lower smaller surface is now more clearly associated with the surfaces below the blend feature.

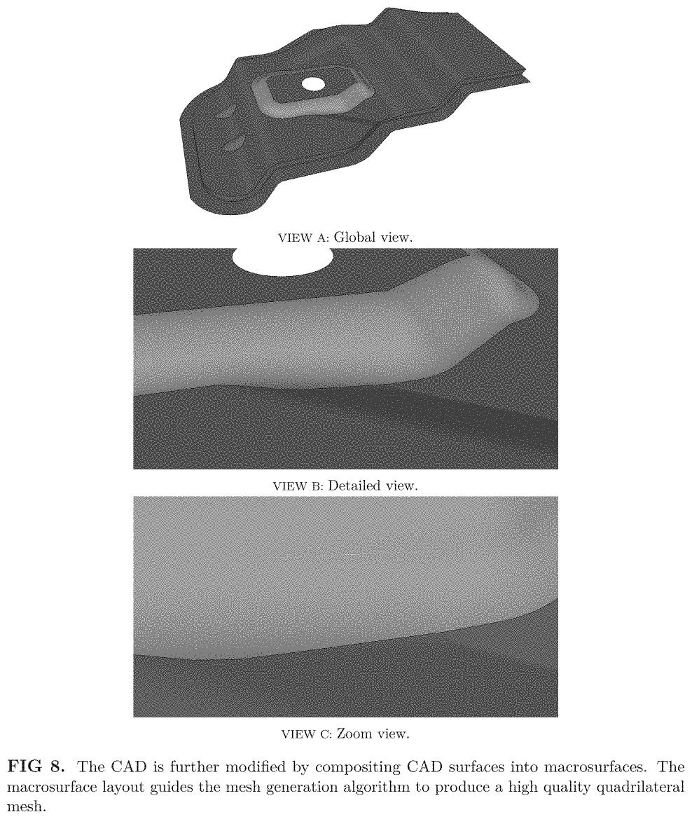

In FIG. 8, VIEW A to 8, VIEW C, the surfaces associated with the fillet are composited into a single macrosurface (highlighted). This operation eliminates the problematic sliver surface but retains the geometric information provided by the surface. The meshing operation will enjoy increased robustness since it will only consume the composited surfaces during execution. As a final CAD modification step, eight additional macrosurfaces are created through compositing.

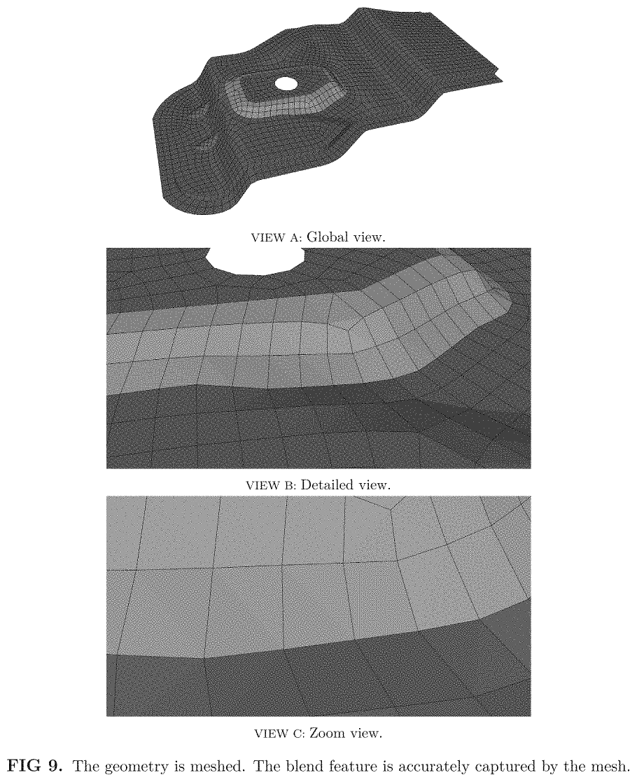

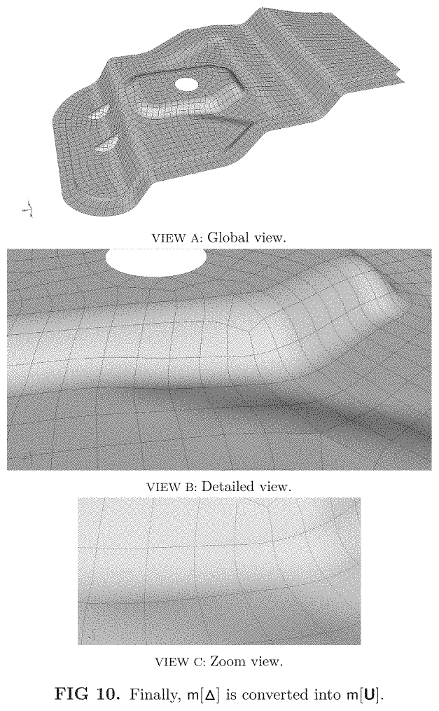

The modified CAD can now be meshed using any number of quadrilateral meshing schemes. In this example, an advancing front meshing algorithm called paving is used. The resulting mesh, denoted by m[Δ] and shown in FIG. 9, VIEW A to 9, VIEW C, respects the topological layout produced by the macrosurfaces created previously and is of high quality. As described in the following sections and shown in FIG. 10. VIEW A to 10. VIEW C, the mesh can then be converted into a U-spline.

### 5.2.2 CAD Modification and Meshing for U-Spline Volumes

The CAD modification and meshing procedure to create a U-spline volume ν is more complex than for surfaces. This is because, the interior of ν must also be filled with a mesh and, to maximize the benefit of the U-spline basis, the mesh should be a high-quality hexahedral mesh. High-quality hexahedral meshes are an ideal input into the U-spline basis construction process resulting in efficient, accurate, and robust simulation models.

The current state-of-the-art in hexahedral mesh generation is to first decompose the BREP into simpler subdomains, each of which can then be meshed individually with a semi-structured hexahedral mesh generation scheme. To facilitate recombining the subdomains after meshing an imprint and merge step is performed which ensures that adjacent subdomains share common BREP topology. The imprinted topology on each subdomain is then leveraged by the hexahedral mesh generation algorithms on each subdomain to ensure the resulting mesh m[Δ] is conforming or, in other words, that no hanging nodes or T-junctions are present in m[Δ].

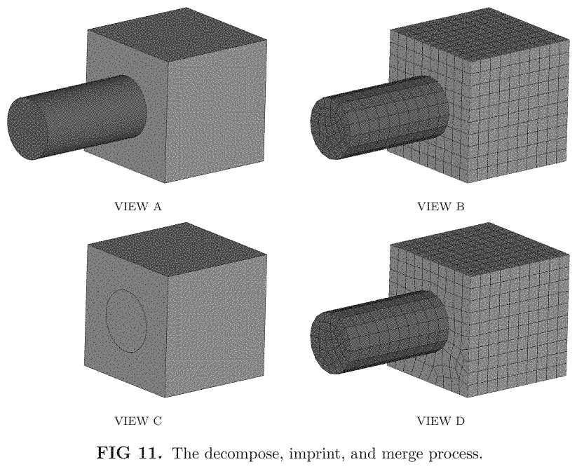

This decompose, imprint, and merge process is shown in FIG. 11. After a decomposition step (see FIG. 11, VIEW A), two disconnected BREP volumes are created that do not share any topological information. A non-conforming (i.e., mismatched) hexahedral mesh is created (see FIG. 11, VIEW B) if the imprint and merge steps are not performed. Imprinting and merging the geometry across the interface (see FIG. 11, VIEW C) adds the cylinder BREP topology to the cube face. The duplicate surfaces are then merged resulting in two BREP volumes with matching topology. A conforming hexahedral mesh can then be created (see FIG. 11, VIEW D).

Once a BREP is decomposed into simpler subdomains a (semi) structured hexahedral mesh generation scheme can be applied to each domain. The workhorse algorithms are usually based on a tensor product or mapped mesh generation algorithm or a sweeping mesh generation algorithm where an unstructured quadrilateral mesh is swept along a curve defined by adjacent linking surfaces. Other, more sophisticated hexahedral mesh generation schemes exist but are usually a combination of these simple approaches. The hexahedral mesh can then be converted into a U-spline volume and fit to the original CAD model such that ν≈m[ [symbol] ].

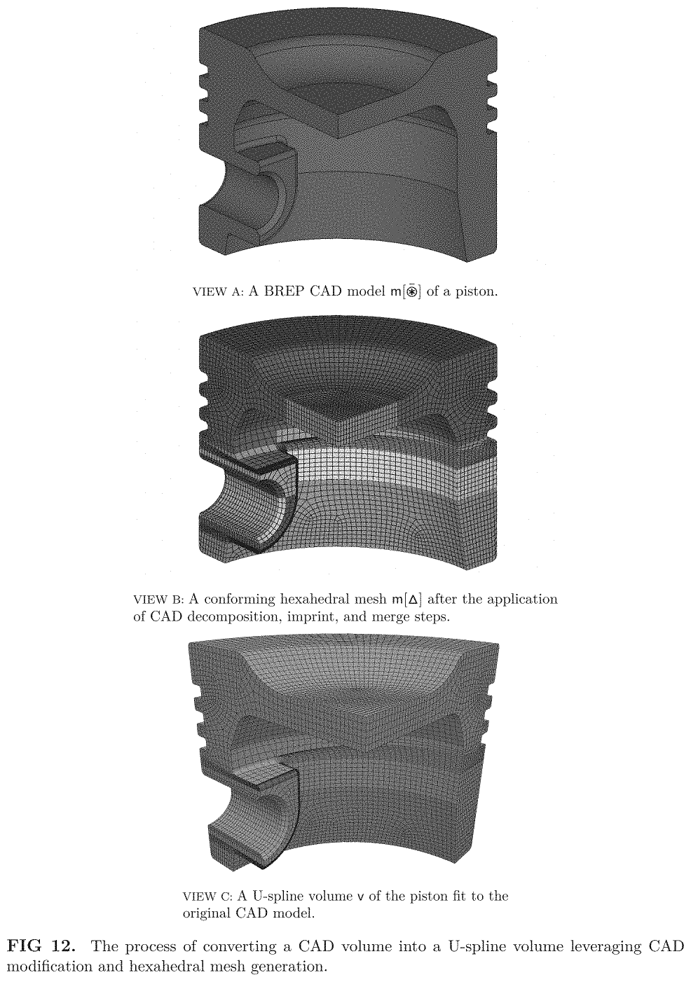

This process applied to a BREP CAD model of a piston is shown in FIG. 12, VIEW A to 12, VIEW C. Notice that the piston CAD model is decomposed into multiple subdomains each of which is swept to produce the final conforming hexahedral mesh. The resulting U-spline volume smoothly and accurately captures the features of the original CAD model m[ [symbol] ].

### 5.2.3 CAD Fitting

We present a dimension-agnostic approach to fitting a d-dimensional U-spline manifold to a d-dimensional CAD manifold. The core procedure consists of a local projection operation onto a Bézier mesh B followed by the creation of an appropriate U-spline mesh U and set of U-spline manifold control points through Bézier projection. The fitting operation is both iterative and progressive meaning the fitting workflow applies a (d-manifold fitting sequentially for volumes, surfaces, curves, and points, overwriting manifold control point values from previous steps. The progressive fitting process iterates until either an error threshold is met or the maximum number of iterations is reached.

### Bézier Representation

We first create a Bézier manifold m[B] by constructing a Bézier mesh B from the cell topology in the partition Δ and then projecting m[ [symbol] ] into the Bernstein space assigned to each cell in B. This projection, denoted by π[c]:m[ [symbol] ]→B^{c}, is computed for each cell c∉B as

X[c^{B}]=π[c]( [symbol] Δ[\hat{Ω}^{Δ}]). (5.12)

This local projection operation over each cell results in a piecewise discontinuous approximation to m[ [symbol] ] in Bernstein form. In other words, the map m[B][\hat{Ω}^{B}]:\hat{Ω}^{B}→m[B] is generated such that

$$\begin{matrix}m [ B ] ( s ) = m [ B ] [ {\hat{Ω}}^{B} ] ( s ) & ( 5.13 ) \\ = {\sum }_{i ∈ ID ( B )} {x [ B ]}_{i} {B}_{i} ( s ) ∀ s ∈ {\hat{Ω}}^{B} & ( 5.14 )\end{matrix}$$

where x[B]ᵢ∉ [symbol] ⁿ is the Bernstein control point associated with the ith Bernstein basis function. The local projector π[c] can be chosen from a variety of options such as a least-squares projection or a local polynomial interpolation problem. The Newton-Bernstein interpolation schemneis particularly efficient, and robust.

### U-Spline Representation

To determine m[U] we apply Bézier projection to m[B]. This projection operation, denoted by π[U]:B^{B}→ [symbol] ^{U}, can be written as

X[U]=π[U](m[B][\hat{Ω}^{B}]). (5.15)

First, additional modifications may be made to B to produce the U-spline mesh U. The U-spline basis UF(U) is constructed over U in extracted form. Now, for a given cell extraction operator, defined over U, the corresponding cell reconstruction operator is defined as

R^{c}=(C^{c})⁻¹. (5.16)

Using the cell reconstruction operator we can compute U-spline control points from Bernstein control points for a given cell as

X[c^{U}]=(R^{c})^{T}X[c^{B}]. (5.17)

Note that in most cases m[B] may be less smooth than the U-spline basis. This means the computed U-spline control points may differ from cell to cell. In this case, the global set of U-spline control points, denoted by X[U], may be calculated from the cell-level U-spline control points X[c^{U}] using a weighted averaging scheme as described in. Importantly, Bézier projection never solves a global linear system to determine the U-spline control points.

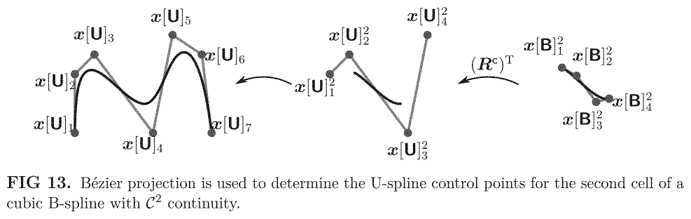

In FIG. 13, Bézier projection is used to determine the U-spline control points for the second cell of a cubic B-spline with [symbol] continuity. The cell-local U-spline control points (center) are calculated as a linear combination of the Bernstein control points (right) through the application of the reconstruction operator R^{c}. Cell-local spline control points are then mapped to the global U-spline control points (left) through an appropriate cell-to-global index map.

The fully defined m[U] provides another approximation of and parameterization for m[ [symbol] ], defined as

[symbol]

U[\hat{Ω}^{U}](s)=κ [symbol] ∘[U][\hat{Ω}^{U}](s),s∉\hat{Ω}^{U}. (5.18)

### Leveraging Reduced Smoothness

We currently only process a U-spline curve c[U] whose continuity ν^{cell(c[U])}≤0 and on points p[U] for which ν^{cell(c[U])}≤0 for all cell(c[U])∉ADJ¹(cell(p[U])). Note that the operator cell(m) returns the cell c∉U corresponding to the given geometric manifold quantity m[U].

To fit a U-spline curve c[U] to a CAD curve c[ [symbol] ] we define a U-spline submnesh K⊆U containing the cells that correspond to c[U]. Because the smoothness of the basis on K is less than or equal to zero, every basis function in UF(K) corresponds to a unique basis function in UF(U). The U-spline manifold control points for basis functions in UF(U) that correspond to basis functions in UF(K) are overwritten by the control points computed during the fitting of c[U].

Since the U-spline basis is interpolatory at each point p[U] the fitting procedure can simply set the value of the control point associated with the basis function corresponding to p[U] to the corresponding value p[ [symbol] ]∉s[ [symbol] ].

### Iteration

The fitting iteration scheme uses the U-spline reparameterization of the CAD [symbol] U[\hat{Ω}^{U}], defined in (5.18), to recompute a fit until an error threshold is reached. It is assumed that [symbol] U[\hat{Ω}^{U}] is a better approximation to the CAD than [symbol] Δ[\hat{Ω}^{Δ}]. As such, the updated Bernstein control points for each c∉B are calculated as

X[c^{B}]^{(k)}=π[c]( [symbol] U[\hat{Ω}^{U}]^{(k-1)}) (5.19)

and the U-spline control points as

X[U]^{(k)}=π[U](m[B][\hat{Ω}^{B}]^{(k)}), (5.20)

where [symbol] U[\hat{Ω}^{U}]⁽⁰⁾ is assumed to be [symbol] Δ[\hat{Ω}^{Δ}]. This process can be repeated until an error tolerance is reached or the iteration counter k reaches a specified maximum value.

### 5.3 U-Spline Flex Modeling

The bottlenecks described previously are eliminated by leveraging the beneficial properties of U-splines to create a more general mesh generation and simulation modeling approach ideally suited to splines. This approach minimizes the time required to produce a hexahedral mesh and associated U-spline for a particular problem while maximizing the accuracy and robustness in computed solutions that is possible with a smooth spline basis. Throughout, we call this new approach U-spline flex modeling or just flex modeling, for short. Note that we only discuss flex modeling in the context of U-spline solids because generating high-quality body-fitted quadrilateral U-spline meshes is possible in nearly every case. However, the flex modeling approach can be applied to surfaces should the need arise.

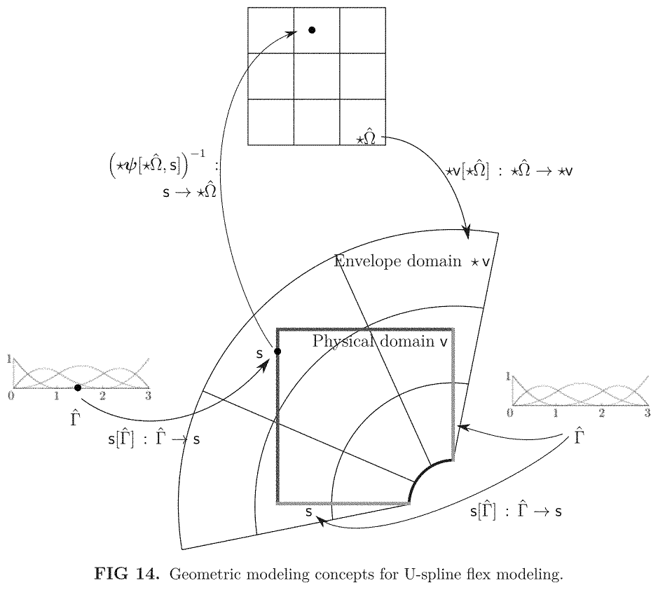

As shown in FIG. 14, the primary geometric ingredients to this approach are:
A CAD manifold (usually a BREP) that represents the physical domain, denoted by m[ [symbol] ],
A U-spline manifold that represents the envelope domain, denoted by ★ν, where m[ [symbol] ]⊆★ν,
Immersed U-spline boundary manifolds, denoted for simplicity by s, where s⊆★ν.

### 5.3.1 the Envelope and Physical Domains

To overcome the issues associated with BREPs, the physical domain m[ [symbol] ] is embedded into the envelope domain ★ν, as shown in FIG. 14. The envelope manifold is a watertight U-spline, i.e., ★ν=m[\hat{Ω}^{U}]. Once m[ [symbol] ] is embedded into ★ν we can replace the BREP by an implicit indicator function

$$χ ( x ) = \{ \begin{matrix}1 & if x ∈ m [ ] , \\ 0 & otherwise ,\end{matrix} \qquad ( 5.21 )$$

or a U-spline. Since the envelope geometry is watertight and the implicit indicator function is robust against defects in the underlying BREP we have successfully sidestepped the issues associated with dirty geometry that complicate the simulation model preparation process. For generality, we will focus on a m[ [symbol] ] represented by an implicit indicator function.

The portions of the immersed boundary of m[ [symbol] ], denoted by s, that will be used for loads, constraints, output, etc. are converted to U-splines so as to eliminate the impact of dirty BREP geometry on the specification and processing of these quantities. We often integrate quantities over s that are defined over ★\hat{Ω}. To accomplish this, we construct inverse manifold mappings of the form (★ψ[★\hat{Ω}, s])⁻¹:s→★\hat{Ω}.

The U-spline manifold mapping associated with s is given by s[\hat{Γ}] and is illustrated in FIG. 14. In contrast to prevailing immersed methods, geometry representation in the flex modeling approach provides the flexibility to create an envelope geometry that selectively captures important geometric features of m[ [symbol] ]. Geometric features may include fillets, sharp creases, small holes, highly curved surfaces, etc. The process of removing or changing the geometric features of a CAD model is often called defeaturing. For example, given the geometry in FIG. 14, the stress near the curved surface may be of interest, so the boundary of the envelope manifold is fitted to the boundary as shown in FIG. 14, whereas other geometric features are embedded in ★ν to simplify the modeling process.

Note that if ★ν is chosen such that ★ν≈m[ [symbol] ] then this method behaves like a traditional isoparametric finite element method. If ★ν is a bounding box of m[ [symbol] ] and ★ν[★\hat{Ω}] is an affine mapping, this method behaves like existing immersed methods that use rectilinear envelope domains.

Even though the shape of ★ν can be arbitrary, it should simplify the construction of the U-spline while maintaining the critical geometric characteristics of m[ [symbol] ] as dictated by the needs of the problem. In this way we overcome the most critical issues associated with hexahedral mesh generation for BREP models while still achieving accurate solutions.

### 5.3.2 The Flex Spectrum

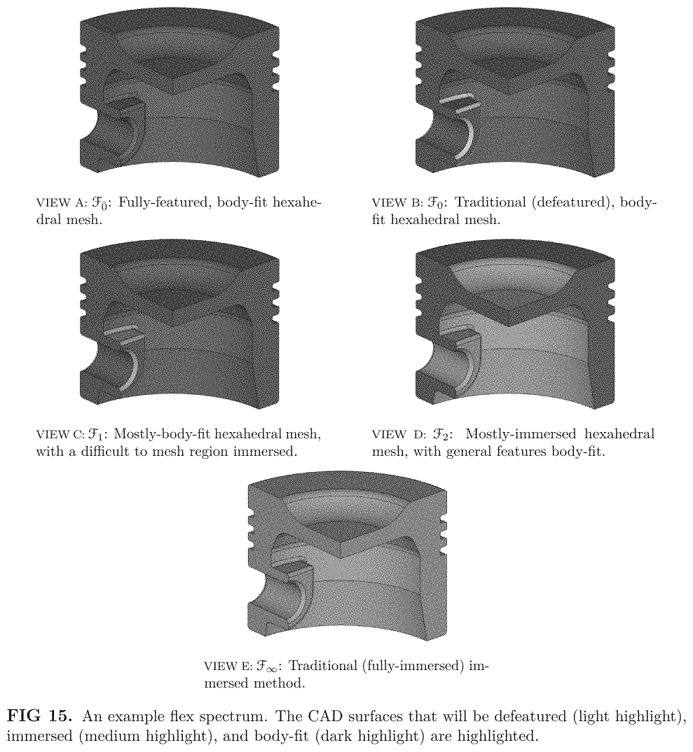

U-spline flex modeling allows the analyst to choose the optimal level-of-effort to generate a mesh for a given problem. In all cases, the approximation power of the higher-order, smooth, locally-adaptive U-spline basis will continue to produce accurate solutions. We call the set of all potential flex modeling approaches for a given problem the flex spectrum and denote it by [symbol] and refer to a unique instance within the spectrum as [symbol] . By convention, we use [symbol] _{0̅} to represent the fully-featured body-fit approach (shown in FIG. 15, VIEW A); [symbol] ₀ to represent the partially defeatured body-fit approach (shown in FIG. 15, VIEW B); and [symbol] _{∞} represents a traditional fully-immersed approach where all geometric features are retained but immersed in a background mesh. These symbols represent, the extremum of [symbol] . Positive integers are then used to communicate the ordering of instances or indexing along the interior of [symbol] , with larger indices suggesting higher levels of immersion. A single flex model in the interior of [symbol] will simply be denoted by [symbol] .

### 5.3.3 Example

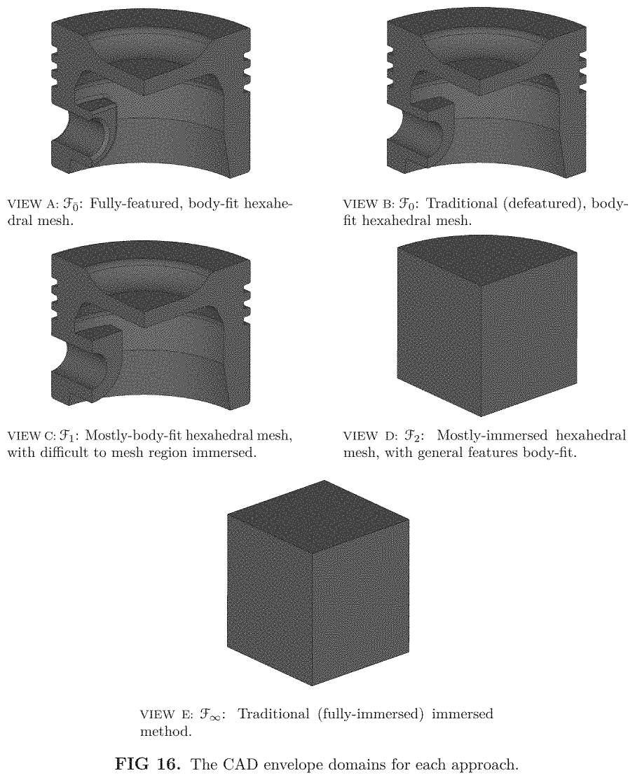

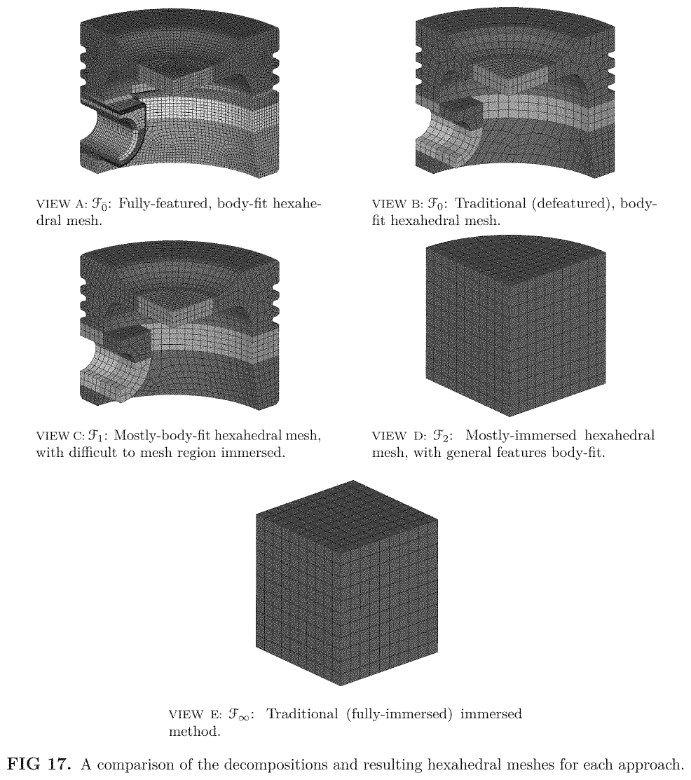

In the example shown in FIGS. 15 to 18, an experienced analyst has devised five potential simulations within [symbol] . In FIG. 15, the features that the analyst has selected for defeaturing (light highlight), immersion (medium highlight), or body-fitting (dark highlight) are shown. Note that while a possibility within the flex spectrum, for simplicity none of the examples shown demonstrate features that are both defeatured (thus modifying the physical domain) and immersed.
[symbol] _{0̅}: In [symbol] ₀, shown in FIG. 15, VIEW A, 16, VIEW A and 17, VIEW A, no surfaces have been selected for defeaturing or immersion. In other words, the envelope domain, shown in FIG. 16, VIEW A, is equivalent to the physical domain m[ [symbol] ]. The mesh for [symbol] _{0̅}, shown in FIG. 17, VIEW A, requires twelve labor hours for an experienced analyst to produce, including time spent correcting inconspicuous geometry errors in the native CAD definition that nevertheless complicate or even prevent the successful generation of a mesh.
[symbol] ₀: A more sensible approach is taken in [symbol] ₀, shown in FIG. 15, VIEW B, 16, VIEW B and 17, VIEW B, where the analyst recognizes that the CAD features shown in FIG. 15, VIEW B will complicate the meshing process and can be safely removed resulting in a defeatured CAD model m[ [symbol] ] shown in FIG. 16, VIEW B. The mesh generation process is much simpler for [symbol] ₀ than for [symbol] _{0̅}, only requiring a few minutes of analyst time to produce as shown in FIG. 17, VIEW B.
[symbol] ₁: Wishing to retain the computational efficiency of [symbol] ₀, but hoping to avoid potential errors due to CAD defeaturing, the analyst instead immerses the complex CAD features, as shown in FIG. 15, VIEW C, 16. VIEW C and 17, VIEW C. The resulting envelope domain, shown in FIG. 16, VIEW C, is similar to [symbol] ₀, shown in FIG. 16, VIEW B, and can be meshed using a similar strategy, as shown in FIG. 17, VIEW C, although this will not generally be the case. In fact, the envelope domain mesh generation process should simplify as the spectrum index increases and more of the model is immersed.
[symbol] ₂: In [symbol] ₂, the analyst seeks to eliminate the meshing problem entirely, by immersing all but the outermost features, as shown in FIG. 15, VIEW D, 16, VIEW D and 17, VIEW D. As a result, the analyst produces the envelope domain, shown in FIG. 16, VIEW D, that, in this case, does not require a decomposition step to produce the envelope mesh shown in FIG. 17, VIEW D. In contrast to [symbol] _{∞}, by fitting major features of the physical domain, significant accuracy gains are realized.
[symbol] _{∞}: In [symbol] _{∞}: all features of the CAD geometry, shown in FIG. 15, VIEW E, 16, VIEW E and 17, VIEW E, are immersed within the rectilinear envelope domain, shown in FIG. 16, VIEW E, which is trivial to mesh, as shown in FIG. 17, VIEW E. In this case, the analyst has eliminated all manual labor associated with mesh generation. While all the previous approaches can utilize adaptivity to drive accurate results, [symbol] _{∞} will require local adaptivity in most cases.

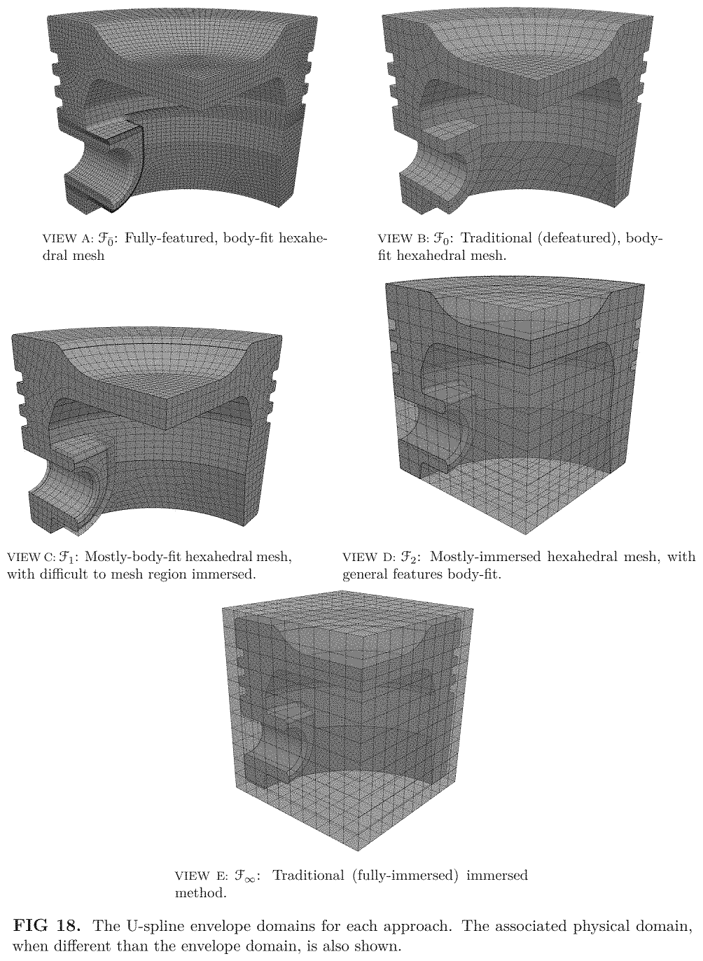

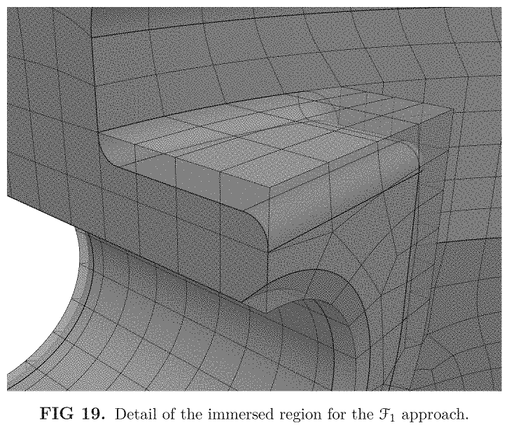

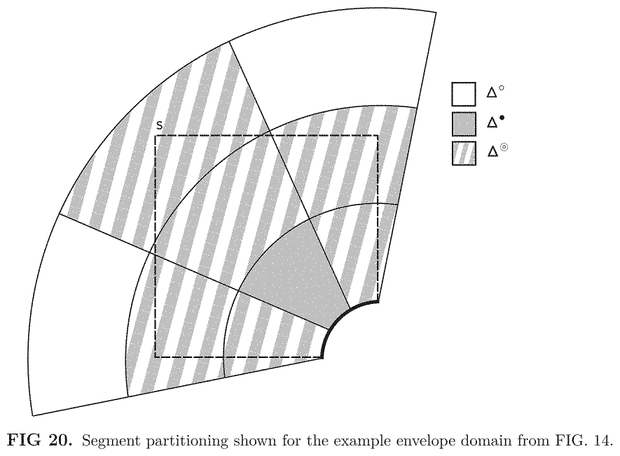

The U-spline envelope domains associated with each flex model are shown in FIG. 18, VIEW A to 18, VIEW E. We again note that both [symbol] _{0̅} and [symbol] ₀ have envelope domains that are equivalent to their respective physical domains, while [symbol] _{>0} have at least part of the physical domain immersed within the envelope domain. As expected, [symbol] _{0̅} has more elements than any other approach due to the requirement that the mesh fit all small features in the CAD model and be a conforming hexahedral mesh. A closeup of a partially immersed CAD feature is shown in FIG. 19.

### 5.3.4 Envelope Segment Partitioning

The segments in the envelope domain partition Δ(★ν) are further partitioned into three sets that indicate each segments proximity to the boundary s[ [symbol] ]:
A set containing envelope segments that intersect an approximate boundary partition Δ(s[ [symbol] ]) of the physical domain, denoted by

Δ^{⊚}={∉^{★ν}:bν(∈^{★ν})∩bν(ε^{s[} [symbol] ^{]})≠θ,∀ε^{★ν}∉Δ(★ν),∀ε^{s[} [symbol] ^{]})}. (5.22)
A set containing all remaining envelope segments that are inside the physical domain, denoted by

Δ^{★}={ε^{★ν}:ε^{★ν}⊂m[ [symbol] ],ε^{★ν}∈Δ^{⊚}}. (5.23)
A set containing all remaining envelope segments that are outside the physical domain, denoted by

Δ^{⊚}={ε^{★ν}:ε^{★ν}⊂m[ [symbol] ],ε^{★ν}∈Δ^{⊚}}. (5.24)

An example of this segment partitioning is shown in FIG. 20. Segments in Δ^{∘} and Δ^{⊚}lie completely outside or inside of s[ [symbol] ]), respectively, and Δ^{⊚} are the remaining segments that intersect s[ [symbol] ].

An efficient and simple implementation of the algorithm for determining Δ^{⊚} uses a surface tessellation Δ(s[ [symbol] ]) [symbol] Δ^{T}(s[ [symbol] ]). Each bν(∉^{s[} [symbol] ^{]})∉Δ^{T}(s[ [symbol] ]) is organized into a bounding volume hierarchy BVH(s[ [symbol] ])) to efficiently compute intersections. Additional details on the construction of bounding volumes and the bounding volume hierarchy can be found in Section 5.3.6.

### 5.3.5 Numerical Integration

We define two sets of parametric points and weights

Q^{⊚}={(s^{C},w^{C}):w^{C}∉ [symbol] ₊,★ν[★\hat{Ω}](s^{C})∉m[ [symbol] ],c∉U}, (5.25)

Q^{∘}={(s^{C},w^{C}):w^{C}∉ [symbol] ₊,★ν[★\hat{Ω}](s^{C})∉★ν\m[ [symbol] ],c∉U} (5.26)

which satisfy

$$\begin{matrix}{\int }_{v} {N}_{A} dv \approx {\sum }_{i}^{\vert {Q}^{•} \vert} {N}_{A} ( {s}_{i}^{c} ) {w}_{i}^{c} , {N}_{A} ∈ UF ( U ) , & ( 5.27 ) \\ {\int }_{★ v} {N}_{A} dv \approx [ {\sum }_{i}^{\vert {Q}^{•} \vert} {N}_{A} ( {s}_{i}^{c} ) {w}_{i}^{c} + {\sum }_{i}^{\vert {Q}^{∘} \vert} {N}_{A} ( {s}_{i}^{c} ) {w}_{i}^{c} ] , {N}_{A} ∈ UF ( U ) . & ( 5.28 )\end{matrix}$$

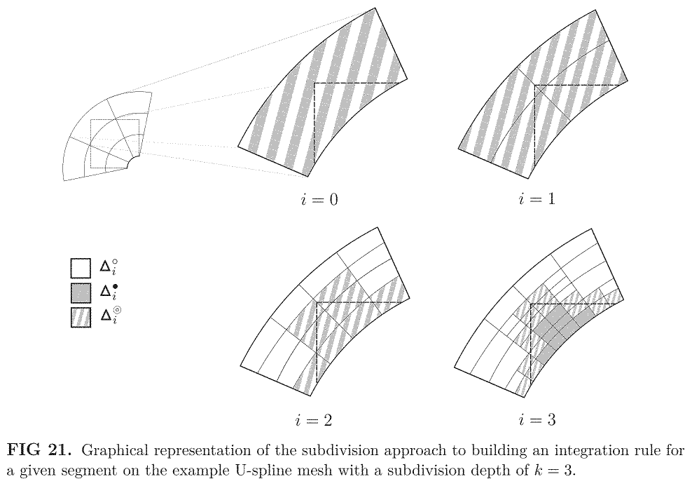

To improve the accuracy of the numerical integrations in Eqs. (5.27) and (5.28), a hierarchical spatial subdivision of each hybrid segment is used, as shown in FIG. 21. In this case, each ∉^{★ν}∉Δᵢ^{⊚} is bisected and categorized until the specified depth k is reached. In FIG. 21, the subdivision depth k=4 is specified and an exemplary hybrid segment is called out. The hierarchical subdivision process begins with the single hybrid segment. ∉^{★ν}, shown at i=0, and proceeds to hierarchically subdivide the segment until the maximum subdivision iterate i=3 is reached. A composed Gauss quadrature rule then constructs Q^{∘} and Q^{⊚} on the remaining integration subsegments.

A recursive bisection algorithm subdivides each ∉^{★ν}∉Δᵢ^{⊚} into integration subsegments (in the sense of a quadtree or octree) where i indicates the current subdivision level beginning with i=0 (the original segment) to a maximum specified subdivision depth k.

Each integration subsegment is categorized into either Δᵢ₊₁^{∘}, Δᵢ₊₁^{●}, or Δᵢ₊₁^{⊚} using the techniques described in Section 5.3.4 where

Δᵢ^{∘}∪Δᵢ^{●}∪Δᵢ^{⊚}⊆Δᵢ₋₁^{⊚}. (5.29)

Essential to finding the bounding volume bν(∉^{★ν}) of an integration subsegment ∉^{★ν}∉Δᵢ^{⊚}, i>0 is the computation of the transformed Bézier control points X[∉^{★ν}]ᵢ of that subsegment. In one dimension, these control points can be found using a transformation on the points from the previous subdivision level X[∉^{★ν}]ᵢ₋₁ by

X[ε^{★ν}]ᵢ=AX[ε^{★ν}]ᵢ₋₁ (5.30)

where A is given by

$${A}_{jk} = {\sum }_{i = max ( 1 , j + k - p + 1 )}^{min ( j , k )} {B}_{i}^{j - 1} ( {ξ}_{0} ) {B}_{k - i}^{p - j - 1} ( {ξ}_{1} ) for j , k = 1 , 2 , … , p + 1 \qquad ( 5.31 )$$

and ξ₀ and ξ₁ represent the parent coordinates of the lower and upper bounds of the one-dimensional subsegment.

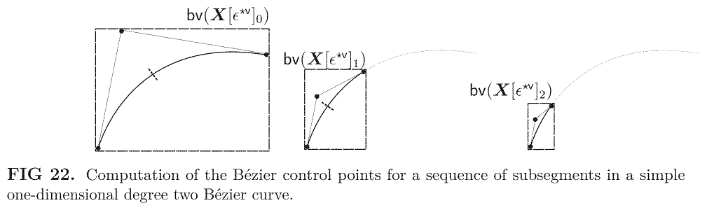

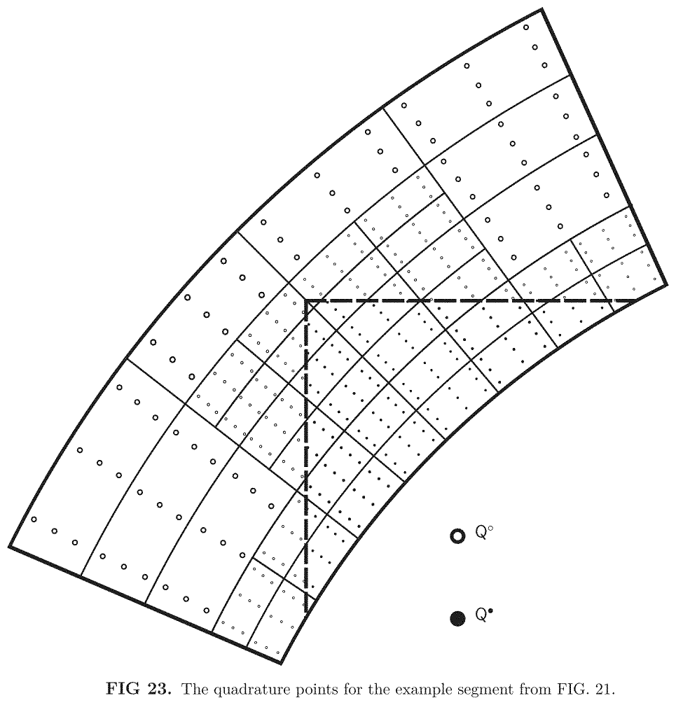

Because each integration segment is subdivided uniformly and the same degrees p are assigned to each subsegment, the transformation A can be computed once and reused at each subsequent subdivision level. Higher dimensional transformations can be computed using the various tensor product permutations of the one-dimensional case. The process of transforming the Bézier control points of integration subsegments is shown in FIG. 22 where, working from left to right, a Bézier curve is repeatedly subdivided, with the new Bézier control points for each successive subsegment illustrated by circles. Note that the geometry and parameterization of the original curve is preserved exactly during this process.

Lastly, we assume there is a function q which takes a set of integration subsegments and produces the set of appropriately scaled Gauss quadrature points and weights. Our composed Gauss quadrature rule can thien be assembled by

Q^{●}=Uᵢ₌₀^{k}q(Δᵢ^{●})∪{(s^{C},w^{C}):(s^{C}w^{C})∉q(Δₖ^{⊚}),χ(★ν[★\hat{Ω}](s^{C}))=1} (5.32)

Q^{∘}=Uᵢ₌₀^{k}q(Δᵢ^{∘})∪{(s^{C},w^{C}):(s^{C}w^{C})∉q(Δₖ^{⊚}),χ(★ν[★\hat{Ω}](s^{C}))=0} (5.33)

which satisfies Eqs. (5.27) and (5.28) according to the given subdivision depth k. An example showing the spatial locations of a set of quadrature points are shown in FIG. 23.

### 5.3.6 Point Inversion

To integrate quantities over an immersed boundary s⊂★ν, that are defined over ★\hat{Ω}, an inverse mapping (★ν[★\hat{Ω}])⁻¹ is required. In flex modeling, the manifold mapping ★ν[★\hat{Ω}] is usually given in terms of a higher-order U-spline basis. As a result, for a given spatial point x₀∉s, there is no explicit expression for computing

s₀=(★ν[★\hat{Ω}])⁻¹(x₀)∉★\hat{Ω}. (5.34)

Instead, the inverse mapping in Eq. (5.34) is solved by a so-called point inversion algorithm. We develop a robust point, inversion algorithm composed of a spatial filtering initialization followed by a predictor/corrector step.
Spatial filter: Given a set of discrete points in s denoted by X(s), the spatial filter step defines a map Δ^{f}:X(s)→P(Δ(★ν)), where x₀∉X(s), and P(Δ(★ν)) is the power set of Δ(★ν).

Given some target point x₀∉X(s), the mapping Δ^{f} is given by

Δ^{f}(x₀)={ε^{★ν}:ε^{★ν}∉Δ(★ν),x₀∉bν(ε^{★ν})}. (5.35)
Predictor: For x₀∉X(s), the predictor defines an approximate inverse map ( [symbol] ):s→★\hat{Ω}.

The map is given by

( [symbol] )⁻¹(x₀)={s:s∉\hat{Ω}[ε^{★ν}]∀ε^{★ν}∉Δ^{f}(x₀)}. (5.36)
For ∉^{★ν}∉Δ^{f}(x₀), a naive approach would be to simply choose s, in Eq. (5.36), to be the center of the segment's parametric domain \hat{Ω}[∉^{★ν}]. While this does not require any extra computation, it may be a poor initial guess for the nonlinear iteration used to solve Eq. (5.34) for a U-splines manifold.
Corrector: Given x₀∉X(s), the corrector uses s∉( [symbol] )⁻¹ (x₀) for a given ∉^{★ν}∉Δ^{f}(x₀) as an initial guess and then finds the pair (s₀, ∉^{★ν}) such that ∥x₀−★ν(s₀)∥ is minimized for all ∉^{★ν}∉Δ^{f}(x₀).
   The following algorithm describes a specialization of the generic approach described above.

### Inverse Rapping Spatial Filter

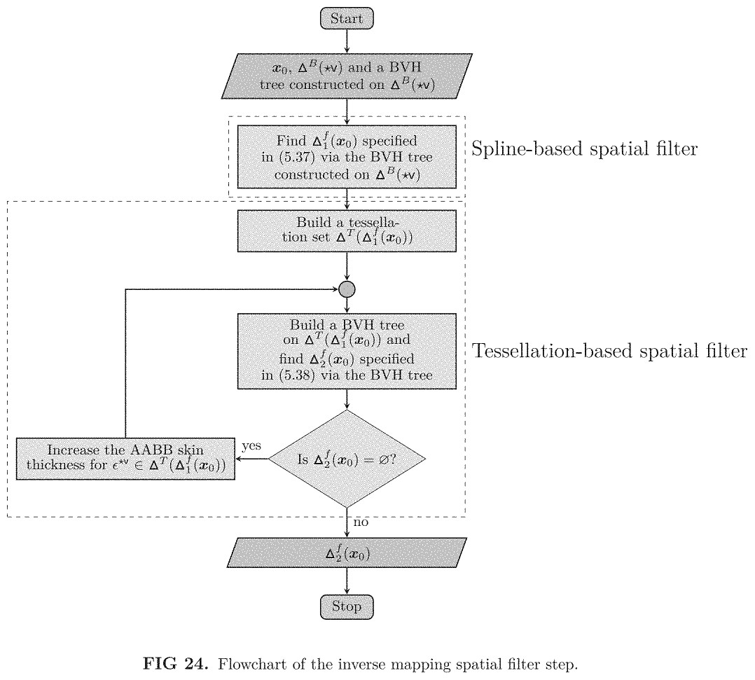

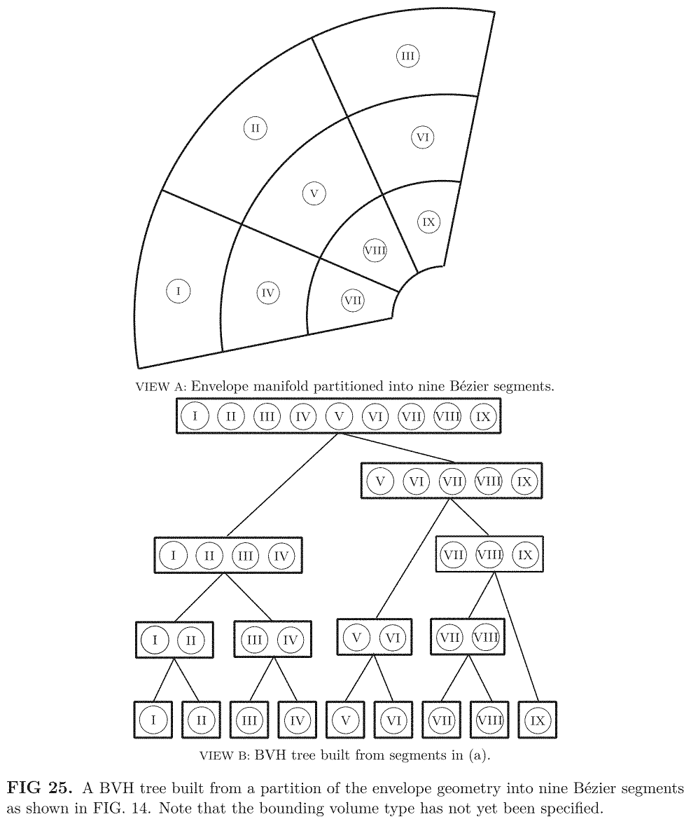

FIG. 24 is a flowchart illustrating the proposed spatial filtering technique. The tessellation Δ^{T}(Δ₁^{f}(x₀)) linearly approximates the Bézier segments in Δ₁^{f}(x₀), which might, not capture the target point x₀ exactly. As a result, the containment query specified in Eq. (5.38) can be empty and it is then corrected by inflating the skin thickness of the AABBs for the simplices in Δ^{T}(Δ₁^{f}(x₀)).

The spatial filter is a combination of two subfilters. Both of these subfilters use bounding volume hierarchical (BVH) tree structures to reduce the number of containment queries between x₀ and bν(∉^{★ν}) in Eq. (5.35) from [symbol] (n) to [symbol] (log n) where n is the total number of segments in Δ(★ν).

### Bounding Volume Hierarchy (BVH)

Given a partition Δ(m) of a manifold m, a BVH tree is constructed for Δ(m) using a bottom-up approach through the following steps:
Step 1: Each element in m is first wrapped into a basic bounding volume.
Step 2: Every two bounding volumes are grouped into a larger bounding volume.
Step 3: Step 2 proceeds in a recursive manner, eventually resulting in a binary tree structure with a single bounding volume at the top.

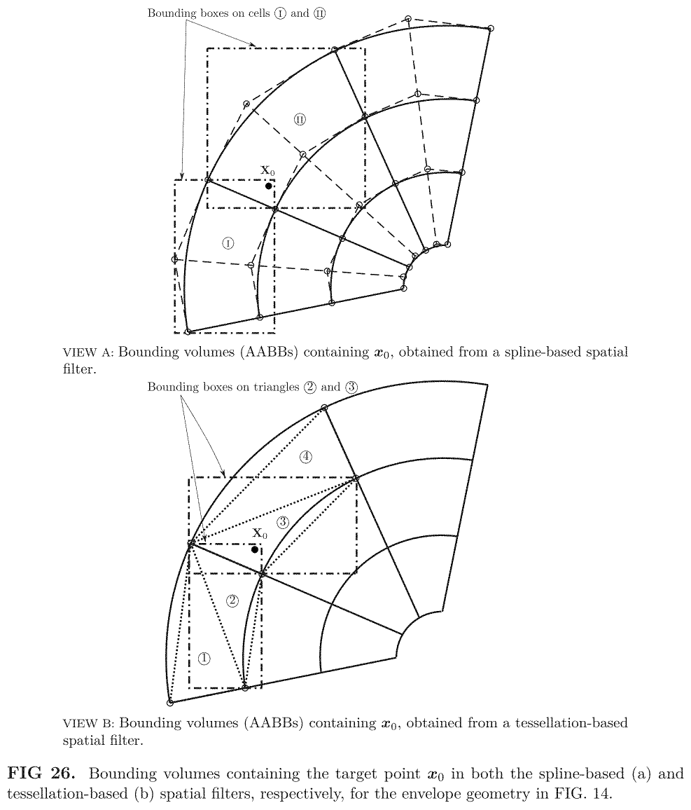

FIG. 25, VIEW A and 25, VIEW B illustrate a BVH tree built on a nine element domain for the envelope geometry given in FIG. 14. The choice of bounding volume type plays an important role in the efficiency of the search algorithm provided by the BVH tree structure. Generally, the bounding volume should have a simple shape so that less storage is required for the BVH tree structure and detecting whether the spatial point x₀ is contained in a bounding volume is simple and fast. Additionally, the bounding volumes are expected to fit the elements tightly so that fewer bounding volumes satisfy Eq. (5.35) for x₀. Various bounding volume types are used for collision detection in the animation industry and for ray tracing in computational geometry, such as spheres, axis aligned bounding boxes (AABB), oriented bounding boxes (OBB), k-direction discrete oriented polytopes (KDOP), and convex hulls. Among them AABB is the most widely used bounding volume type as it is easy to construct, requires little memory, and intersection or containment tests are easy to implement and extremely fast. In this work, we use AABB as our bounding volume type. However, we note that the proposed point inversion algorithm is general and independent of the bounding volume type.

### Spline-Based Spatial Filter

The spline partitioning used in this work is based on Bézier extraction. The partition created by the Bézier extraction of the U-spline ★ν is denoted by Δ^{B}(★ν). Given a target point x₀ and Δ^{B}(★ν), the first spatial filter is given by Δ₁^{f}(x₀):X(s)→P(Δ^{B}(★ν)). More specifically, the mapping

Δ₁^{f}(x₀)={ε^{★ν}:ε^{★ν}∉Δ^{B}(★ν),x₀∉bν(ε^{★ν})} (5.37)

is realized through a top-down binary tree search algorithm applied to the BVH tree structure constructed from Δ^{B}(★ν). It is important to note that any segment, ∉^{★ν}∉Δ^{B}(★ν) satisfies the condition ∉^{★ν}⊂★ν. The AABB for some ∉^{★ν}⊂★ν is constructed such that it wraps the convex hull of the Bézier segment. This is simple and very efficient because the Bézier control points for a given segment, can be determined at, almost no additional cost. FIG. 26, VIEW A gives an example where the envelope geometry given in FIG. 14 is partitioned into nine Bézier segments. Two AABBs are returned by the binary tree algorithm as they both contain the spatial point x₀. Segments \textcircled{I} and \textcircled{II} are wrapped by these two bounding volumes.

### Tessellation-Based Spatial Filter

The spline-based spatial filter rapidly narrows the solution domain of the inverse mapping down to a few Bézier segments given by Δ₁^{f}(x₀). To further reduce the number of remaining Bézier segments we implemented a second spatial filter based on a tessellation of each segment in Δ₁^{f}(x₀). A tessellation consists of simplices, such as triangles for a surface and tetrahedrons for a volume. FIG. 26, VIEW B gives an example where elements \textcircled{I} and \textcircled{II} in FIG. 26, VIEW A are tessellated into triangles \textcircled{1} to \textcircled{4}. We employed the Rivara splitting algorithm to produce adaptive tessellations of any domain. For a manifold m, the set of simplices generated by the tessellation of m is denoted by Δ^{T}(m). The mapping for the tessellation-based spatial filter is given by Δ₂^{f}(x₀):X(s)→P(Δ^{T}(Δ₁^{f}(x₀))), where P(Δ^{T}(Δ₁^{f}(x₀))) is the power set of Δ^{T}(Δ₁^{f}(x₀)). Given x₀∉X(s), this mapping is given by

Δ₂^{f}(x₀)={ε^{★ν}:ε^{★ν}∉Δ^{T}(Δ₁^{f}(x₀)),x₀∉bν(ε^{★ν})}. (5.38)

Here, the AABB for a simplex in Δ^{T}(Δ₁^{f}(x₀)) is created from the corner points of the simplex as shown in FIG. 26. VIEW B.

### Inverse Mapping Predictor

The inverse mapping spatial filter returns a set of simplices, Δ₂^{f}(x₀), given by Eq. (5.38).

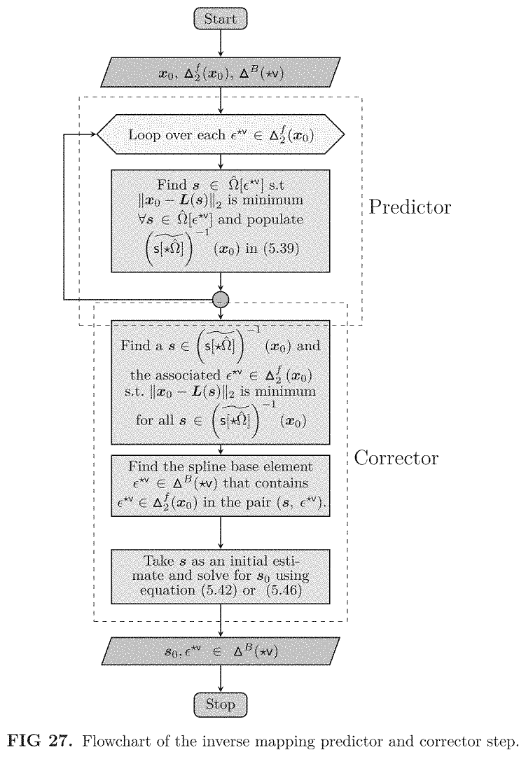

The predictor, as illustrated in the flowchart of FIG. 27, predicts an initial estimate for s₀ for each simplex ∉^{★ν}∉Δ₂^{f}(x₀) by finding the point so that is closest to ∉^{★ν}. The corrector, also illustrated in the flowchart of FIG. 27, zeros down one cell and corrects the initial estimate using the Newton-Raphson method.

An initial estimate s of s₀ is determined for each ∉^{★ν}∉Δ₂^{f}(x₀) by computing the point on ∉^{★ν} that is closest to x₀ using a simple geometric approach based on simplices. More precisely, given a target point x₀ and a set of simplices, Δ₂^{f}(x₀), the predictor solves Eq. (5.36) as the linear problem

$${( )}^{- 1} ( {x}_{0} ) = \{ s : {min}_{s ∈ \hat{Ω} [ {ϵ}^{★ V} ]} {‖ {x}_{0} - L ( s ) ‖}_{2} ∀ {ϵ}^{★ V} ∈ {Δ}_{2}^{f} ( {x}_{0} ) \} . \qquad ( 5.39 )$$

In equation Eq. (5.39), L(s) is a linear map L(s):\hat{Ω}[∉^{★ν}]→∉^{★ν}Δ^{T}(Δ₁^{f}(x₀)) where s is the parametric coordinate calculated from the barycentric coordinate of the closest point to x₀ on ∉^{★ν}.

### Inverse Mapping Corrector

The corrector first finds a single pair consisting of s∉( [symbol] )⁻¹ (x₀) and the associated ε^{★ν}∉Δ₂^{f}(x₀) such that ∥x₀−L(s)∥₂ is minimum for all s∉( [symbol] )⁻¹(x₀). This can be easily obtained by comparing ∥x₀−L(s)∥₂ for all s∉( [symbol] )⁻¹ (x₀). Once a single pair, (s, ε^{★ν}), is found, one can find the associated spline base element ε^{★ν}∉Δ^{B}(★ν) that contains the simplex ε^{★ν}∉Δ₂^{f}(x₀). With the geometry information, provided by the spline element. ε^{★ν}, and the initial guess, s, the Newton-Raphson method is then used to find the final solution s₀. Two formulations for solving equation Eq. (5.34) using the Newton-Raphson method are described as follows.

Minimizing ∥★ν(s)−x₀∥₂

The inverse mapping in equation Eq. (5.34) can be posed as a nearest point problem by minimizing ∥★ν(s)−x₀∥₂. To facilitate the derivation, we define the objective function as one half the square of the distance between two spatial points x₀ and ★ν(s), i.e.,

f(s)=½∥★ν(s)−x₀∥₂². (5.40)

The necessary condition for the minimization f(s) is

∇f(s)=(★ν(s)−x₀)·∇★ν(s)=0. (5.41)

Due to the nonlinear nature of Eq. (5.41), it is solved iteratively through a series of linearized problems, i.e.,

s⁽ⁱ⁺¹⁾=s⁽ⁱ⁾−H⁻¹(s⁽ⁱ⁾)·∇f(s⁽ⁱ⁾), (5.42)

where the superscript i denotes the iteration step and H is the Hessian matrix of f(s) with components

Hⱼₖ=★νⱼ(s)·★νₖ(s)+★νⱼₖ(s)·(★ν(s)−x₀). (5.43)

An alternative approach is to simply find the root of the equation

R(s)=★ν(s)−x₀=0 (5.44)

directly. Note that this condition is closely related to Eq. (5.41). Typically, if ★ν(s) is differentiable and ∇ ★ν(s) is invertible, both conditions are equivalent to each other. The consistent tangent is then the gradient

∇R(s)=∇★ν(s) (5.45)

and the solution at the ith iteration is

s⁽ⁱ⁺¹⁾=s⁽ⁱ⁾−(VR(s⁽ⁱ⁾))⁻¹R(s⁽ⁱ⁾). (5.46)

Remark 5.3.1. [0163] The first formulation is general in the sense that without limitations on the parametric and spatial dimensions d and n, it can be used for solving both the inverse mapping problem, ★ν(s)=x₀, and the nearest point problem encountered in contact. However, it requires the second derivatives of the manifold mapping and must be computed at each Newton-Raphson iteration, which is computationally expensive. Additionally, if the Hessian matrix is not strictly positive-definite (or negative-definite), it is possible for the Newton-Raphson algorithm to return a stationary point rather than an extreme point. In this case, a better initial guess is required.
Remark 5.3.2. [0164] The second formulation does not require second derivatives and it guarantees that we are moving in a descent direction even if the Hessian is not strictly positive definite. This is because, from Eqs. (5.41) and (5.46), we have

∇f·Δs=((★ν(s)−x₀)·∇★ν(s))·(−(∇★ν(s))⁻¹(★ν(s)−x₀))=−2f<0, (5.47)

which indicates that Δs is the descent direction. However, as this second method is just finding the root of Eq. (5.44), it can not be used for contact problems. Additionally, it requires that the parametric dimension d and spatial dimensions in be the same. Otherwise, ∇ ★ν(s) will not be square and a pseudoinverse must be used in Eq. (5.42), which can affect the accuracy and robustness of the Newton-Raphson algorithm.

### 5.4 an Electrostatic Flex Formulation

To illustrate the potential of the flex representation approach we develop a nonlinear electrostatic formulation in the setting of a flex model and apply it to several challenging benchmark problems.

### 5.4.1 Envelope Kinematics

In the flex representation method, the kinematic description is written in terms of the reference and current envelope manifolds. Consider a reference envelope manifold ★V⊆ [symbol] ⁿ with a right-handed orthogonal coordinate system X^{★V}∉★V and a motion or deformation of the reference envelope manifold defined by the mapping ★ν[★V]:★V→★ν⊆ [symbol] ⁿ where the mapped envelope manifold ★ν is called the current or deformed envelope manifold. We can measure the change in position of each coordinate X^{★V}∉★V under the mapping ★ν[★V] through a displacement field U:★V→ [symbol] ⁿ where

U(X^{★V})=★ν[★V](X^{★V})−X^{★V} (5.48)

The motion can also be written in terms of the displacement field as

★ν[★V](X^{★V})=X^{★V}+U(X^{★V}). (5.49)

The deformation gradient F:V→ν is a linear operator defined as

$$\begin{matrix}F {=}^{def} {∇}^{{X}^{★ V}} ★ v [ ★ V ] & ( 5.50 ) \\ {=}^{def} I + {∇}^{{X}^{★ V}} U & ( 5.51 )\end{matrix}$$

where

$${∇}^{{X}^{★ V}} f {=}^{def} \frac{\partial f}{\partial ★ V [ ★ \hat{Ω} ]}$$

and I is the identity mapping on ★V. The nonlinear Green-Lagrange strain operator, denoted by E:★V→★ν, is defined as

$$E {=}^{def} \frac{1}{2} ( {F}^{2} - I ) . \qquad ( 5.52 )$$

### 5.4.2 Energy Statement

For simplicity, we assume a hyperelastic material and that the applied boundary conditions and loads are independent of the motion ★ν[★V]. A naive approach would be to use a standard potential energy functional Π^{●}: [symbol] (★V)→ [symbol] , [symbol] (★V)⊆ [symbol] (★V), posed over V such that

Π^{●}(U)=∫_{V}Ψ(F(U))dV−∫_{V}B·U dV−∫_{S}_{^{h}}H·U dS (5.53)

where Ψ:★V→ [symbol] is the strain energy density, B:★V→ [symbol] ⁿ is the body force, and H:S^{h}→ [symbol] ⁿ is the traction force. Notice that in this case we are integrating over V not ★V. The solution U to this problem can then be found by minimizing Eq. (5.53), i.e.,

$${min}_{U ∈ 𝒰 ( ★ V )} {\prod }^{•} ( U ) . \qquad ( 5.54 )$$

### Regularized Envelope Energy

If V⊂★V, the discrete version of Eq. (5.53) will result in poorly conditioned linear systems and the imposition of boundary conditions is not accounted for. To overcome these issues, we combine Eq. (5.53) with another convex potential energy functional, Π^{∘}, that extends Ψ and B into the envelope domain ★V in a smooth manner. We have that

Π^{∘}(U)=∫_{★V\V}Ψ(F(U))d V−∫_{★V\V}B·U dV. (5.55)

Combining Eqs. (5.53) and (5.55) yields the following two equivalent constrained minimization problems

$$\begin{matrix}{min}_{U ∈ 𝒰 ( ★ V )} {\prod }^{∘} ( U ) \\ s . t . U minimizes {\prod }^{•} ( U )\end{matrix} ⟺ \begin{matrix}{min}_{U ∈ 𝒰 ( ★ V )} {\prod }^{∘} ( U ) \\ s . t . δ {\prod }^{•} ( U ) = 0.\end{matrix} \qquad ( 5.56 )$$

that can be solved in a variety of ways to control the overall conditioning of the discrete problem. For simplicity, we leverage a penalty approach. In this case, we can approximately solve the constrained minimization problem by first defining the regularized envelope energy

★Π(U)=Π^{●}(U)+εΠ^{∘}(U) (5.57)

and solving the associated minimization problem

$${min}_{U ∈ 𝒰 ( ★ V )} ★ \prod ( U ) \qquad ( 5.58 )$$

where ε behaves like the inverse of a standard penalty factor. If we want to recover the exact problem Eq. (5.53) we let e go to zero instead of infinity. However, by dividing Eq. (5.57) by e we can manipulate Eq. (5.57) into a traditional penalty form where

$$\frac{1}{ɛ} \to ∞ .$$

In Eq. (5.57), the penalty ε can be used to control the conditioning of the discretized problem. In other words, we want ε to be large enough to yield an accurate solution while small enough to produce well-conditioned linear systems.

Finally, substituting Eqs. (5.53) and (5.55) into Eq. (5.57) gives

★Π(U)=∫_{★V}χ_{ε}(X^{★V})Ψ(F(U))dV−∫_{★V}χ_{ε}(X^{★V})B·U dV−∫_{S}_{^{h}}H·U dS (5.59)

where χ_{ε}:★V→ [symbol] ₊ is a regularized indicator function that determines whether an envelope point X^{★V} is inside or outside the physical domain V:

$${χ}_{ɛ} ( {X}^{★ V} ) = \{ \begin{matrix}1 , & {X}^{★ V} ∈ V , \\ ɛ , & {X}^{★ V} ∉ V .\end{matrix} \qquad ( 5.60 )$$

Note that although S^{h}⊂★V⊂ [symbol] ⁿ it may be the case that S^{h} and ★V are defined with different manifold mappings S^{h}[\hat{Γ}^{h}] and ★V[★Ω], respectively.

### Displacement Constraints

In the trial displacement space [symbol] (★V) there is no control over the behavior of the displacement on S^{u}. This means that any displacement constraints imposed on S^{u} will not be respected by any solution to Eq. (5.57). To overcome this issue, the displacement constraint G:S^{u}→ [symbol] ⁿ, defined as

G(U(X^{S}^{^{h}}))=U(X^{S}^{^{h}})−U₀(X^{S}^{^{h}})=0, (5.61)

is enforced through a standard Augmented Lagrangian (AL) approach where a space of Lagrange multipliers [symbol] (S^{u})⊆ [symbol] ₂(S^{u}) is defined over S^{u}. The energy Π^{Λ}: [symbol] (★V)⊗ [symbol] (S^{u})→ [symbol] associated with enforcing the displacement constraint G is then defined as

$${\prod }^{Λ} ( U , Λ ) = \frac{α}{2} {\int }_{{S}^{u}} {( U - {U}_{0} )}^{2} dS + {\int }_{{S}^{u}} Λ \cdot ( U - {U}_{0} ) dS \qquad ( 5.62 )$$

where α∉ [symbol] ₊ is a regularization penalty applied to the AL energy to increase robustness and the convexity of the functional.

### The Final Energy

The energy functional of the final nonlinear electrostatic problem can now be written as

Π(U,Λ)=★Π(U)+Π^{Λ}(U,Λ). (5.63)

and solved through the minimization problem

$${min}_{U ∈ 𝒰 ( ★ V ) , Λ ∈ ℒ ( {S}^{u} )} \prod ( U , Λ ) . \qquad ( 5.64 )$$

### 5.4.3 Weak Form

Taking a variational derivative of Eq. (5.63) results in the weak form of the nonlinear electrostatic problem: Find (U, Λ)∉ [symbol] (★V)⊗ [symbol] (S^{u}) such that for all (δU, δΛ)∉δU(★V)⊗δ [symbol] (S^{u})

δΠ(U,δU,Λ,δΛ)=∫_{★V}χx_{ε}P:∇^{X}^{^{★V}}δU dV−∫_{★V}χ_{ε}B·δU dV−∫_{S}_{^{h}}H·δU dS+α∫_{S}_{^{u}}(U−U₀)·δU dS+∫_{S}_{^{u}}Λ·δU dS+∫_{S}_{^{u}}δΛ·(U−U₀)dS=0 (5.65)

where

$$P = \frac{\partial Ψ}{\partial F}$$

is called the first Piola-Kirchhoff stress tensor.

### 5.4.4 Strong Form

Applying integration by parts and the Gauss divergence theorem to the first term on the left-hand side of Eq. (5.65) we have that

$$\begin{matrix}{\int }_{★ V} {χ}_{ɛ} P : {∇}^{X ★ V} δ UdV = {\int }_{V} {χ}_{ɛ} P : {∇}^{X ★ V} δ UdV + {\int }_{★ V \backslash V} {χ}_{ɛ} P : {∇}^{X ★ V} UdV & ( 5.66 ) \\ = [ - {\int }_{V} {χ}_{ɛ} ( {∇}^{X ★ V} \cdot P ) \cdot δ UdV + {\int }_{S} ( {χ}_{ɛ} P \cdot δ U ) \cdot NdS ] + [ - {\int }_{★ V \backslash V} {χ}_{ɛ} ( {∇}^{X ★ V} \cdot P ) \cdot δ UdV + {\int }_{{S}^{f}} ( {χ}_{ɛ} P \cdot δ U ) \cdot NdS ] & ( 5.67 ) \\ = - {\int }_{★ V} {χ}_{ɛ} ( {∇}^{X ★ V} \cdot P ) \cdot δ UdV + {\int }_{S} ( P \cdot δ U ) \cdot NdS + {\int }_{{S}^{f}} ( ɛ P \cdot δ U ) \cdot NdS & ( 5.68 )\end{matrix}$$

where S^{f} denotes the boundary of ★V\V and N is the unit outward normal of S^{j} or S.

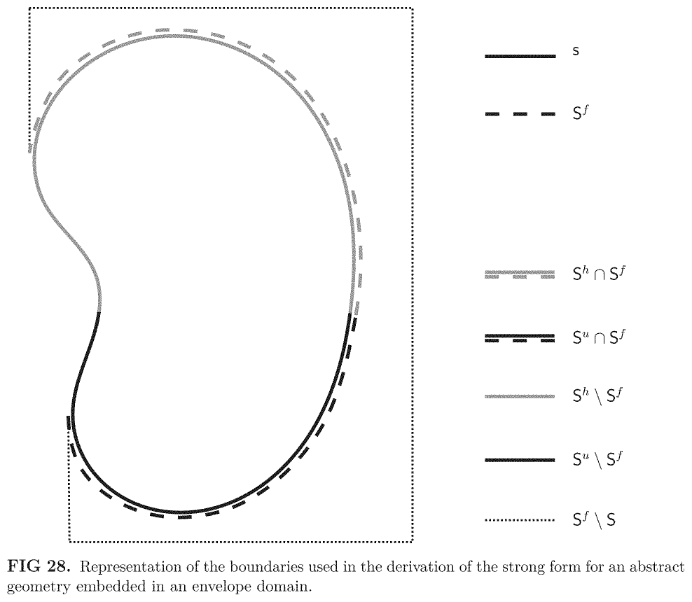

Assuming that S=S^{u}∪S^{h} and noting that, in general, S^{f}∩S^{u}≠θ and S^{f}∩S^{h}≠θ, we can substitute Eq. (5.68) into Eq. (5.65) and combine terms on the boundaries S^{f}\S, S^{f}∩S^{h}, S^{f}∩S^{u}, S^{h}\S^{f}, and S^{u}\S^{f}, as seen in FIG. 28, to obtain

δΠ(U,δU,Λ,δΛ)=−∫_{★V}χ_{ε}(∇X^{★V}·P+B)·δU dV+∫_{S}_{^{f}}_{†S}(εP·N)·δU dS+∫_{S}_{^{h}}_{∩S}_{^{f}}((1−ε)P·N−H)·δU dS+∫_{S}_{^{u}}_{∩S}_{^{f}}[((1−ε)P·N)+α(U−U₀)+Λ]·δU+δΛ·(U−U₀)dS+∫_{S}_{^{h}}_{\S}_{^{f}}((P·N)−H)·δU dS+∫_{S}_{^{u}}_{\S}_{^{f}}[(P·N)+α(U−U₀)+Λ]·δU+δΛ·(U−U₀)dS=0. (5.69)

Finally, given that the test functions δU and δΛ are arbitrary we arrive at the strong form

∇^{X★}^{^{V}}·P+B=0 on ★V, (5.70)

P·N=0 on S^{f}\S, (5.71)

(1−ε)P·N−H=0 on S^{h}∩S^{f}, (5.72)

(1−ε)P·N+α(U−U₀)+Λ=0 on S^{u}∩S^{f}, (5.73)

P·N−H=0 on S^{h}\S^{f}, (5.74)

P·N+α(U−U₀)+Λ=0 on S^{u}\S^{f}, (5.75)

U−U₀=0 on S^{u}, (5.76)

where Eqs. (5.72) and (5.73) include the (1−ε) term constituting an abrupt change in P between boundaries.

### 5.4.5 Consistent Tangent

The second Piola-Kirchhoff stress S is related to the first Piola-Kirchhoff stress P through the deformation gradient as

S=F⁻¹P. (5.77)

Since

δE=½((δF)^{T}F+(F)^{T}δF) (5.78)

and S is a symmetric tensor, we have

S:δE=S:((F)^{T}δF)=(FS):δF=P:∇^{X}^{^{★V}}δU. (5.79)

Using Eq. (5.79), the weak form Eq. (5.65) can be rewritten in indicial form as

δΠ(U,δU,Λ,Λ)=∫_{★V}χ_{ε}(δE_{IJ}S_{IJ}−δU_{I}B_{I})dV−∫_{S}_{^{h}}δU_{I}H_{I}dS+∫_{S}_{^{u}}[δU_{I}(α(U_{I}−U₀_{_{I}})+Λ_{I})+δΛ_{I}(U_{I}−U₀_{_{I}})]d S (5.80)

where lowercase and uppercase Latin indices refer to coordinates in the current, and reference configurations, respectively. Recalling that the variation of the second Piola-Kirchhoff stress is

δS_{IJ}=C_{IJKL}δE_{KL}, (5.81)

where C_{IJKL} is the elasticity tensor, the consistent tangent is then

ΔδΠ(U,δU,ΔU,δΛ,ΔΛ)=∫_{★V}χ_{ε}(δE_{IJ}C_{IJKL}ΔE_{KL}+ΔδE_{IJ}S_{IJ})d V+∫_{S}_{^{u}}(αδU_{I}ΔU_{I}+δU_{I}ΔΛ_{I}+δΛ_{I}ΔU_{I})dS. (5.82)

### 5.4.6 Push Forward to Current Configuration

We can push the weak form and consistent tangent into the current configuration by defining u [symbol] U∘(★ν[★V])⁻¹, b [symbol] B∘(★ν[★V])⁻¹, h [symbol] H∘(s^{h}[S^{h}])⁻¹, and λ [symbol] Λ∘(s^{u}[S^{u}])⁻¹ and using the relations

$$\begin{matrix}{δϵ}_{ij} = {( F )}_{Ii}^{- 1} δ {{E}_{IJ} ( F )}_{Jj}^{- 1} & ( 5.83 ) \\ = \frac{1}{2} ( δ {u}_{i , j} + δ {u}_{j , i} ) , & ( 5.84 ) \\ {Δδϵ}_{ij} = {( F )}_{Ii}^{- 1} Δδ {{E}_{IJ} ( F )}_{Jj}^{- 1} & ( 5.85 ) \\ = \frac{1}{2} ( δ {u}_{k , i} Δ {u}_{k , j} + Δ {u}_{k , i} δ {u}_{k , j} ) , & ( 5.86 ) \\ {c}_{ijkl} = {( det ( F ) )}^{- 1} {F}_{iI} {F}_{jJ} {F}_{kK} {F}_{lL} {C}_{IJKL} , & ( 5.87 ) \\ {σ}_{ij} = {( det ( F ) )}^{- 1} {F}_{iI} {F}_{jJ} {S}_{IJ} . & ( 5.88 )\end{matrix}$$

Note that δ∉ᵢⱼ and δ∉ᵢⱼ are not actual variations but are used for notational consistency. The weak form and consistent tangent in the current configuration can then be written as

δΠ(u,δu,λ,δλ)=∫_{★V}χ_{ε}(δεᵢⱼσᵢⱼ−δuᵢbᵢ)dν−∫_{S}_{^{h}}δuᵢhᵢd s+∫ₛ_{^{u}}[δuᵢ(α(uᵢ−u₀ᵢ)+λᵢ)+δλᵢ(uᵢ−u₀ᵢ)]d s (5.89)

and

ΔδΠ(u,δu,Δu,δλ,Δλ)=∫_{★V}χ_{ε}(δεᵢⱼcᵢⱼₖₗΔεₖₗ+Δδεᵢⱼσᵢⱼ)dν+∫ₛ_{^{u}}(αδuᵢΔuᵢ+δuᵢΔλᵢ+δλᵢΔuᵢ)d s. (5.90)

### 5.4.7 U-Spline Basis and Mapping

We make a standard Galerkin assumption which means that we construct finite dimensional U-spline subspaces U(★V)^{h}⊂U(★V), δU(★V)^{h}⊂δU(★V), [symbol] (S^{u})^{h}⊂ [symbol] (S^{u}), and δ [symbol] (S^{u})^{h}⊂δ [symbol] (S^{u}). This means that for U^{h}∉U(★V)^{h} we have that

U^{h}=Ū^{h}∘(★V[★\hat{Ω}])⁻¹∉ [symbol] (★V)^{h} (5.91)

where the U-spline Ū^{h}:★\hat{Ω}→ [symbol] ⁿ can be written as

$${\overline{U}}^{h} = {\sum }_{A} {U}_{A} {N}_{A}^{U} . \qquad ( 5.92 )$$

Likewise, for Λ^{h}∉ [symbol] (S^{u})^{h} we have that

Λ^{h}=\hat{Λ}^{h}∘(S^{u}[\hat{Γ}^{u}])⁻¹∉ [symbol] (S^{u})^{h} (5.93)

where the U-spline Λ̅^{h}:\hat{Γ}^{u}→ [symbol] ⁿ can be written as

$${\overline{Λ}}^{h} = {\sum }_{A} {Λ}_{A} {N}_{A}^{A} . \qquad ( 5.94 )$$

A similar construction is assumed for the test spaces δ [symbol] (★V)^{h} and δ [symbol] (S^{u})^{h}.

The mapping ★V[★\hat{Ω}]:★\hat{δ}→★V is also assumed to be a U-spline and ★ν[★V]:★V→★ν can be pulled back to ★\hat{Ω} through the composition

$$\begin{matrix}\overline{★ v [ ★ \hat{Ω} ]} = ★ v [ ★ V ] ∘ ★ V [ ★ \hat{Ω} ] & ( 5.95 ) \\ = ( I + {U}^{h} ) ∘ ★ V [ ★ \hat{Ω} ] & ( 5.96 ) \\ ( I + {\overline{U}}^{h} ∘ {( ★ V [ ★ \hat{Ω} ] )}^{- 1} ) ∘ ★ V [ ★ \hat{Ω} ] & ( 5.97 ) \\ ★ V [ ★ \hat{Ω} ] + {\overline{U}}^{h} . & ( 5.98 )\end{matrix}$$

This means that.

$$\overline{★ v [ ★ \hat{Ω} ]} = {\sum }_{A} ( {X}_{A}^{★ V} + {U}_{A} ) {N}_{A}^{U} . \qquad ( 5.99 )$$

This is sometimes called an isoparametric construction. i.e., the displacement and envelope manifolds are constructed from the same U-spline basis.

To efficiently evaluate s*[S*] we note that

s*[S*]=\overline{★ν[\hat{Ω}]}∘(★V[★\hat{Ω}])⁻¹∘S*[\hat{Γ}*]. (5.100)

The majority of the computational cost in computing s*[S*] is in inverting ★V[★\hat{Ω}]. However, (★V[★\hat{Ω}])⁻¹∘S*[\hat{Γ}*] does not depend on the motion and can be computed once and stored. Note that although S*⊂★V the associated U-spline manifold mappings S*[\hat{Γ}*]:\hat{Γ}→S* and ★V[★\hat{Ω}] may be unrelated.

### 5.4.8 Matrix Form

The vector residual associated with the continuous weak form Eq. (5.89) can be written as

$$R = [ \begin{matrix}{F}^{int} + {F}^{ext} + {F}^{α} + {F}^{λ1} \\ {F}^{λ2}\end{matrix} ] , \qquad ( 5.101 )$$

where F^{int}, F^{ext}, F^{α}, F^{λ1}, and F^{λ2} denote the internal force, the external force, displacement constraint correcting force from the penalty term, displacement constraint correcting force from the Lagrange multiplier term, and the displacement constraint force, respectively. For each force vector, the subvector components {F*}_{A} are

{F^{int}}_{A}=∫_{★ν}χ_{ε}(B_{A})^{T}\tilde{σ}dν, (5.102)

{F^{ext}}_{A}=∫_{★ν}χ_{ε}N_{A}^{U}b dν+fₛ_{^{h}}N_{A}^{U}h d s, (5.103)

{F^{α}}_{A}=α∫ₛ_{^{u}}N_{A}^{Λ}(u−u₀)ds, (5.104)

{F^{λ1}}_{A}=∫ₛ_{^{u}}N_{A}^{U}λd s, (5.105)

{F^{λ2}}_{A}=f∫ₛ_{^{u}}N_{A}^{Λ}(u−u₀)ds, (5.106)

where σ̅ is the Cauchy stress in Voigt form and B_{A} are the standard strain-displacement matrices in the current envelope configuration defined as

$$\begin{matrix}{B}_{A} = [ {N}_{A , {x}_{1}^{★ v}}^{U} ] ( n = 1 ) , & ( 5.107 ) \\ {B}_{A} = [ \begin{matrix}{N}_{A , {x}_{1}^{★ v}}^{U} & 0 \\ 0 & {N}_{A , {x}_{2}^{★ v}}^{U} \\ {N}_{A , {x}_{2}^{★ v}}^{U} & {N}_{A , {x}_{1}^{★ v}}^{U}\end{matrix} ] ( n = 2 ) , & ( 5.108 ) \\ {B}_{A} = [ \begin{matrix}{N}_{A , {x}_{1}^{★ v}}^{U} & 0 & 0 \\ 0 & {N}_{A , {x}_{2}^{★ v}}^{U} & 0 \\ 0 & 0 & {N}_{A , {x}_{3}^{★ v}}^{U} \\ 0 & {N}_{A , {x}_{3}^{★ v}}^{U} & {N}_{A , {x}_{2}^{★ v}}^{U} \\ {N}_{A , {x}_{3}^{★ v}}^{U} & 0 & {N}_{A , {x}_{1}^{★ v}}^{U} \\ {N}_{A , {x}_{2}^{★ v}}^{U} & {N}_{A , {x}_{1}^{★ v}}^{U} & 0\end{matrix} ] ( n = 3 ) . & ( 5.109 )\end{matrix}$$

If a Newton-Raphson method is used in a nonlinear set ting we require the matrix stiffness associated with the consistent tangent. The stiffness matrix can be written as

$$K = [ \begin{matrix}{K}^{m} + {K}^{9} + {K}^{α} & {K}^{Λ} \\ {( {K}^{Λ} )}^{T} & 0\end{matrix} ] [ \begin{matrix}{d}^{u} \\ {d}^{Λ}\end{matrix} ] \qquad ( 5.110 )$$

where K^{m}, K^{g}, K^{α}, K^{Λ}, d^{u}, and d^{Λ} are the material stiffness, the geometric stiffness, the penalty stiffness, the stiffness associated with the Lagrange multiplier terms, the vector of displacement control points, and the vector of Lagrange multipliers, respectively. The components of each stiffness submatrix [K*]_{AB} are

[K^{m}]_{AB}=∫_{★ν}χ_{ε}(B_{A})^{T}\tilde{c}B_{B}dν, (5.111)

[K⁹]_{AB}=Iₙ∫_{★ν}(∇^{x}^{^{★ν}}N_{A}^{U})^{T}σ∇^{x}^{^{★ν}}N_{B}^{U}dν, (5.112)

[K^{α}]_{AB}=αIₙ∫ₛ_{^{u}}N_{A}^{U}N_{B}^{U}ds, (5.113)

[K^{Λ}]_{AB}=Iₙ∫ₛ_{^{u}}N_{A}^{U}N_{B}^{Λ}dν (5.114)

where \tilde{c} is the elasticity tensor in the current configuration in Voigt form and Iₙ is the identity matrix of size n. The displacement and Lagrange multiplier solution vectors have components

{d^{u}}_{A}=U_{A}, (5.115)

{d^{Λ}}_{A}=Λ_{A}. (5.116)

### Penalty Specialization

The penalty method can be viewed as a specialization of the AL method, where the Lagrange multiplier term is eliminated from the energy function. In other words. Eq. (5.62) in the current configuration becomes

$${\prod }^{Λ} ( U , Λ ) = \frac{α}{2} {\int }_{{s}^{u}} {( u - {u}_{0} )}^{2} ds . \qquad ( 5.117 )$$

This method simplifies the implementation of the method and reduces the size of the final linear system. However, it comes at a cost of poorly conditioned linear systems. The matrix form of the penalty method can be written as

R=F^{int}+F^{ext}+F^{α}, (5.118)

K=(K^{m}+K^{g}+K^{α})d^{u}. (5.119)

### 5.4.9 Implementation Details

We conclude with a few remarks about the method including several adjustments to improve efficiency and make the method more robust under large deformations:
The choice for the penalty parameter ε can make a significant impact on the conditioning of the system and the accuracy of the resulting solution. As the penalty decreases in size the contribution of ★V\V is minimized but the impact of the discontinuities over the set of hybrid cells Δ^{⊚} increases. A value in the range of 1e⁻⁸<ε<1e⁻² is typically used for ε.
The primary purpose of ∈>0 is to stabilize the linear system. Since the term (χ_{ε}b·δu) does not impact the conditioning of the stiffness matrix we do not integrate it over ★V\V.
For problems that experience large strains, the deformation gradient F can become singular since strains in ★V\V can become large due to the reduced stiffness of the material in ★V\V. One method to counteract this behavior, presented in, modifies ★ν[★V] as follows:

$$★ v [ ★ V ] \vert ( {X}^{★ V} ) = \{ \begin{matrix}{X}^{★ V} + U ( {X}^{★ V} ) & {X}^{★ V} ∈ V , \\ {X}^{★ V} & {X}^{★ V} ∉ V .\end{matrix} \qquad ( 5.120 )$$

Note that this modification violates the variational consistency of the method but is a practical solution for large deformation applications of the approach.

### 5.5 Numerical Results

The foregoing has provided the background, tools, and techniques for applying and using the Flex Representation Method in computer aided design (CAD) and computer aided engineering (CAE). Several examples of the actual application and use of FRM are now provided. (Please note that these examples should be considered examples and illustrative but not in any way limiting)

### 5.5.1 U-Spline to CAD Fitting Examples

The construction of U-splines from CAD representations of the envelope domain is a central process in the flex representation method. We demonstrate the effectiveness of the U-spline to CAD fitting process on several surface and volume problems.

### Surface Fitting

A CAD Surface with a Raised Interior Planar Surface

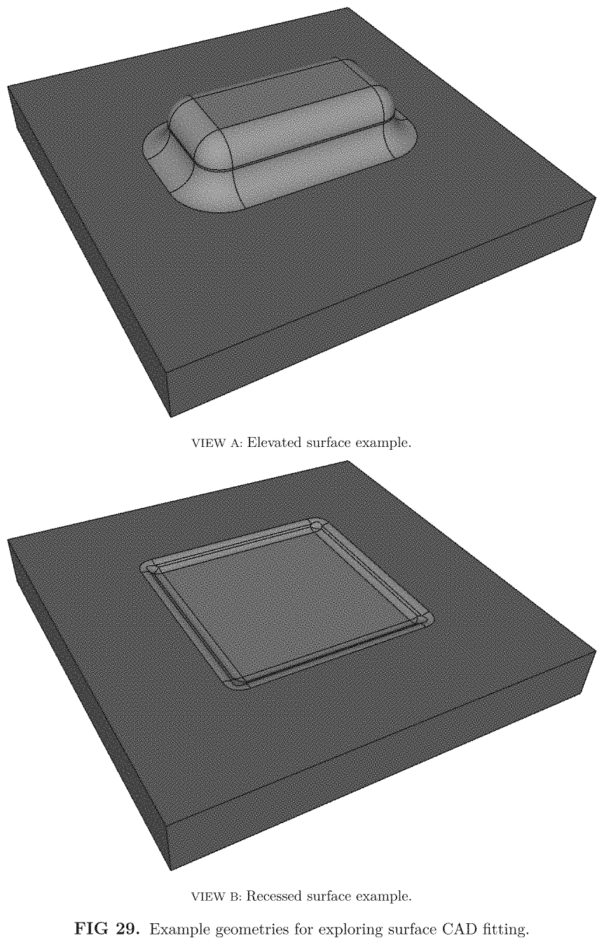

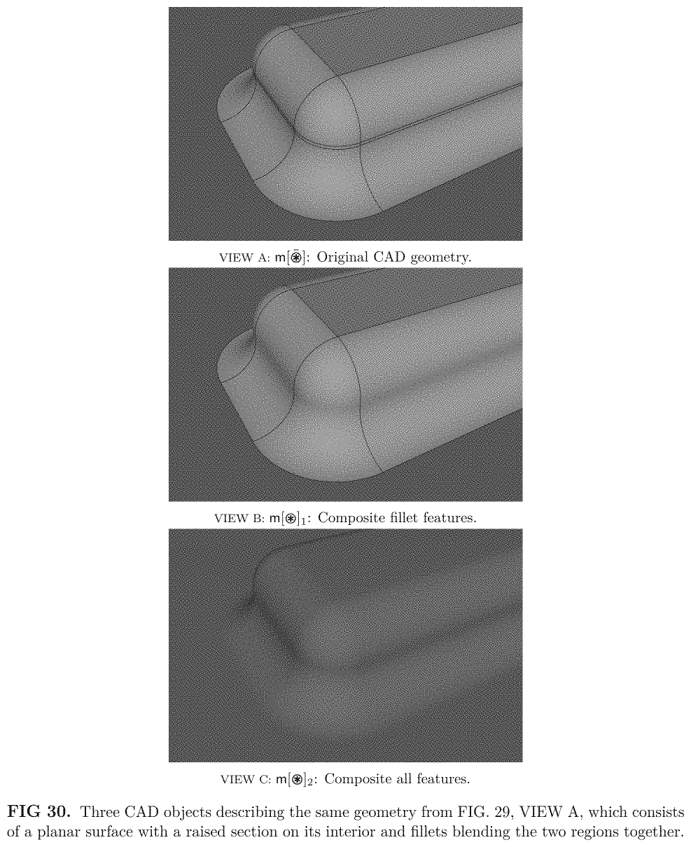

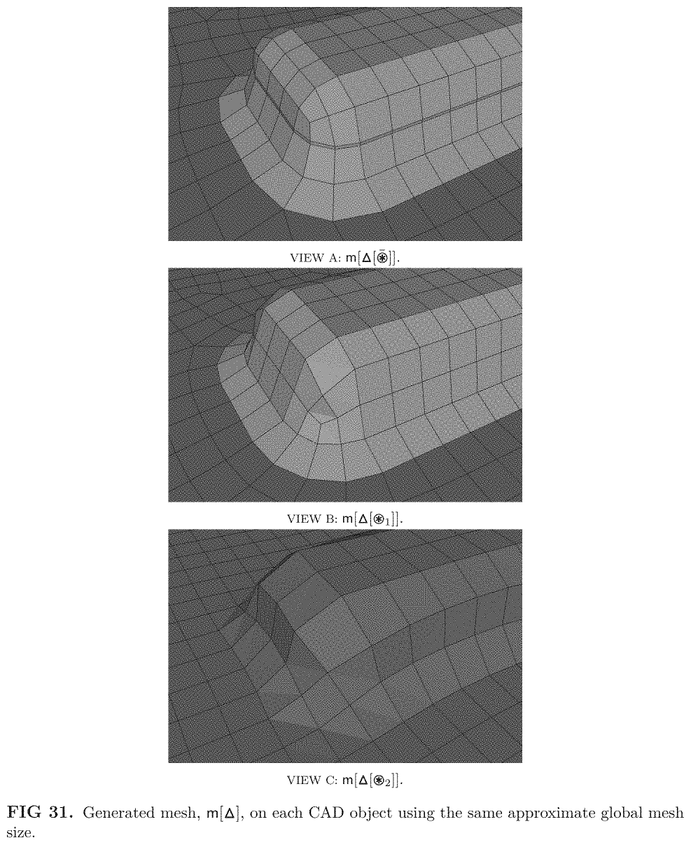

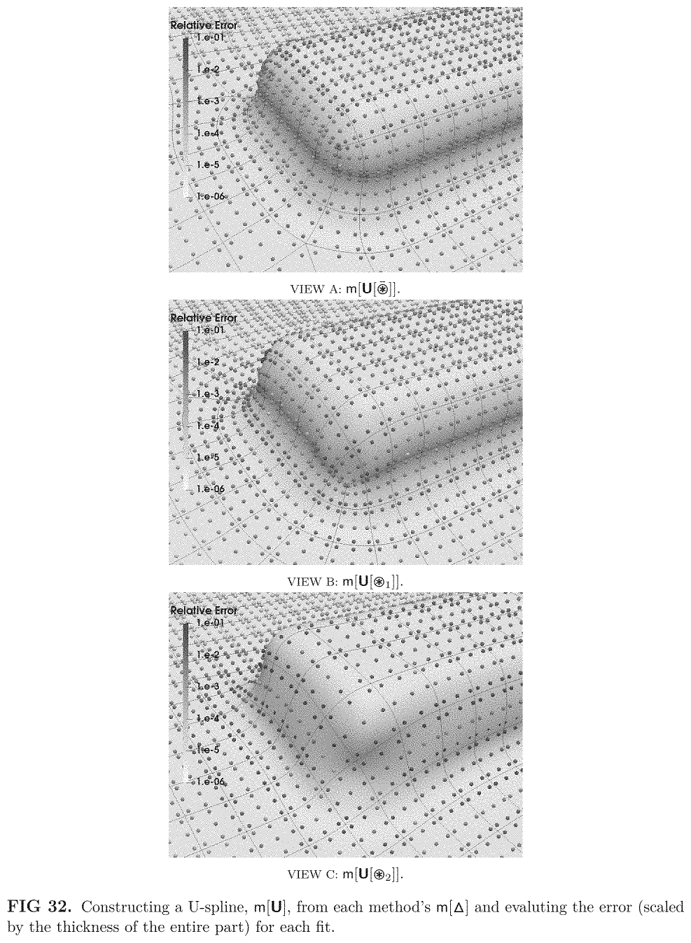

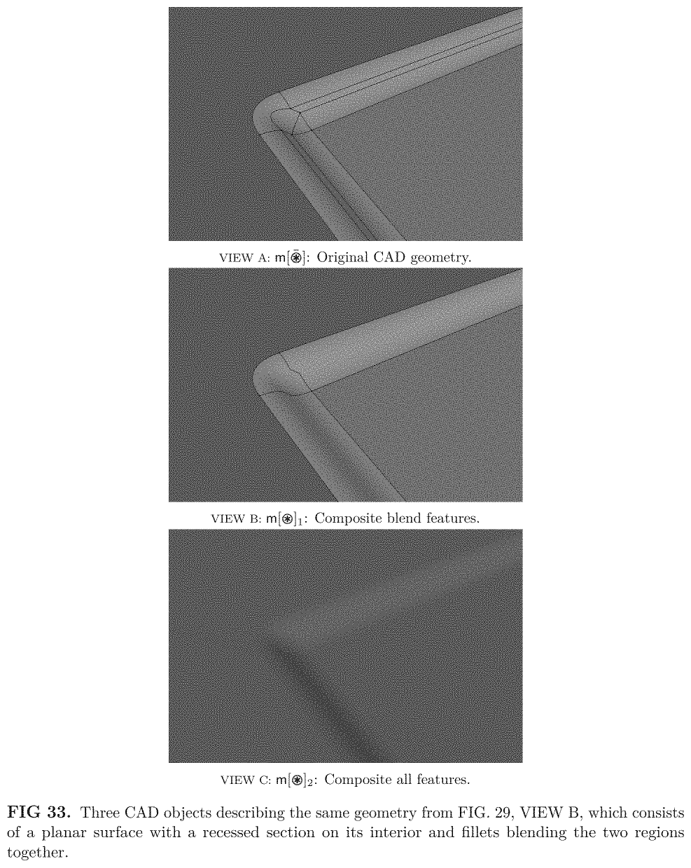

We demonstrate the use of virtual topology to guide the U-spline to CAD fitting algorithm in FIG. 29, VIEW A and 29. VIEW B. The problem is shown in FIGS. 30 to 32 and demonstrates three parameterization approaches for a planar surface with a raised interior planar surface that are joined via fillets. In FIG. 30, VIEW A the fillets on the original model, m[ [symbol] ], can be seen to have radii that result in thin planar strips between each fillet pair. These strips force a thin layer of d-cells to be generated in the resulting m[Δ] that conform to their boundaries (FIG. 31, VIEW A). Alternatively we can judiciously apply virtual topology to m[ [symbol] ], selecting each fillet pair and their associated planar strip, to composite into macrosurfaces resulting in m[ [symbol] ]₁ as seen in FIG. 30, VIEW B. The generated partitioning, m[Δ], shown in FIG. 31, VIEW B does not conform to these thin strips whose topology has been ignored through this virtual topology operation. Finally, another approach taken is to simply composite all the surfaces together resulting in a geometry, m[ [symbol] ]₂, comprised of a single macrosurface shown in FIG. 30, VIEW C. A structured m[Δ] is then constructed on this macrosurface (FIG. 31, VIEW C). Comparing these three approaches in FIG. 32. VIEW A to 32, VIEW C and Table 5.1 we see that applying virtual topology does decrease the fit accuracy, but is well-behaved. We would expect these errors to decrease if local U-spline refinement were applied.

TABLE 5.1
Error measures for the various parameterizations of
the elevated-surface model shown in FIGS. 30 to 32.

| Parameterization | Average error | Max error |
|---|---|---|
| m[ [symbol] ] | 5.42E−4 | 1.28E−2 |
| m[ [symbol] ]₁ | 7.81E−4 | 4.47E−2 |
| m[ [symbol] ]₂ | 2.76E−3 | 1.13E−1 |

A CAD Surface with a Shallow Recession

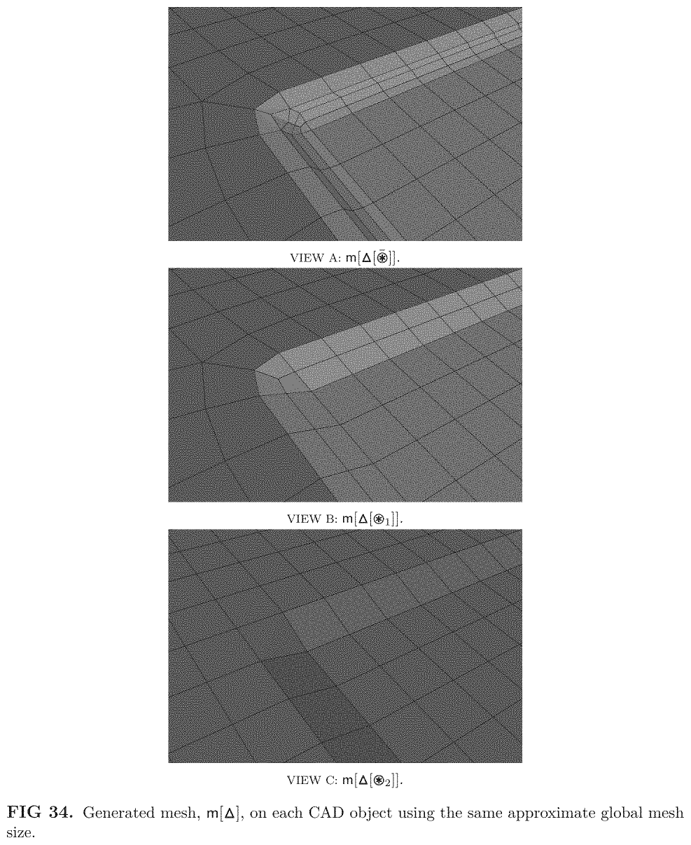

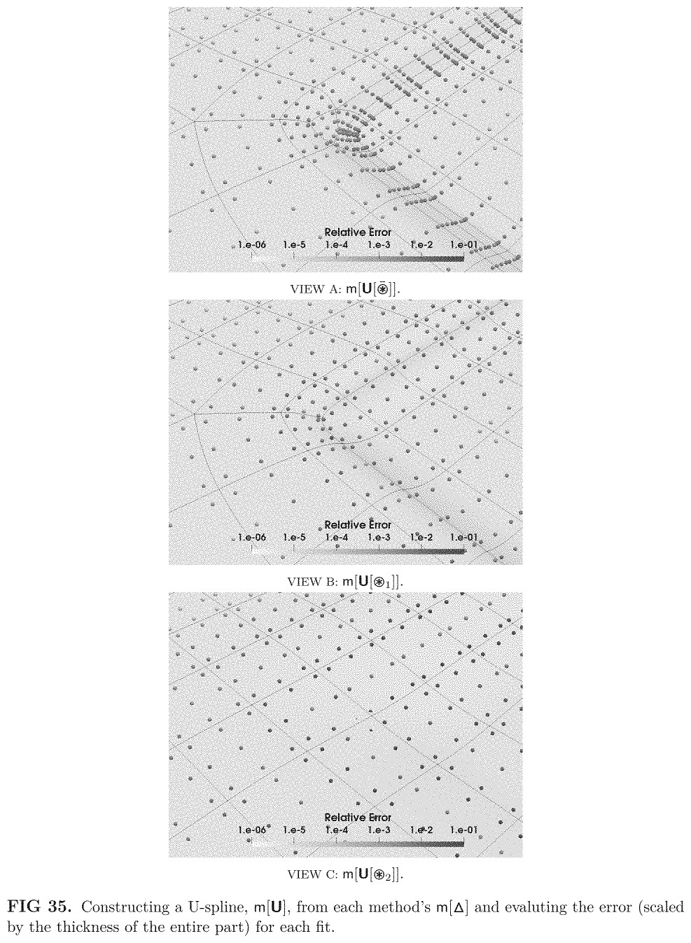

This example, shown in FIG. 33, VIEW A to 33. VIEW C, FIG. 34, VIEW A to 34, VIEW C, and FIG. 35, VIEW A to 35, VIEW C, is similar to the previous example, however the interior surface is now a shallow recession (FIG. 33, VIEW A). The fillets have the same topology as before and the user applies the same virtual topology procedures (FIG. 33, VIEW B and 33, VIEW C). Again the virtual topology removes small d-cells from the generated m[Δ] as well as reduces the number of extraordinary vertices. As shown in Table 5.2 the error in the fit does increase as more virtual topology is applied, however it appears well-behaved and would be expected to improve if local U-spline, refinement were applied.

TABLE 5.2
Error measures for the various fits of the recessed-
surface model shown in FIGS. 33 to 35.

| Parameterization | Average error | Max error |
|---|---|---|
| m[ [symbol] ] | 2.76E−4 | 6.86E−3 |
| m[ [symbol] ]₁ | 4.22E−4 | 4.33E−2 |
| m[ [symbol] ]₂ | 2.79E−3 | 9.69E−2 |

### Knuckle Solid Part

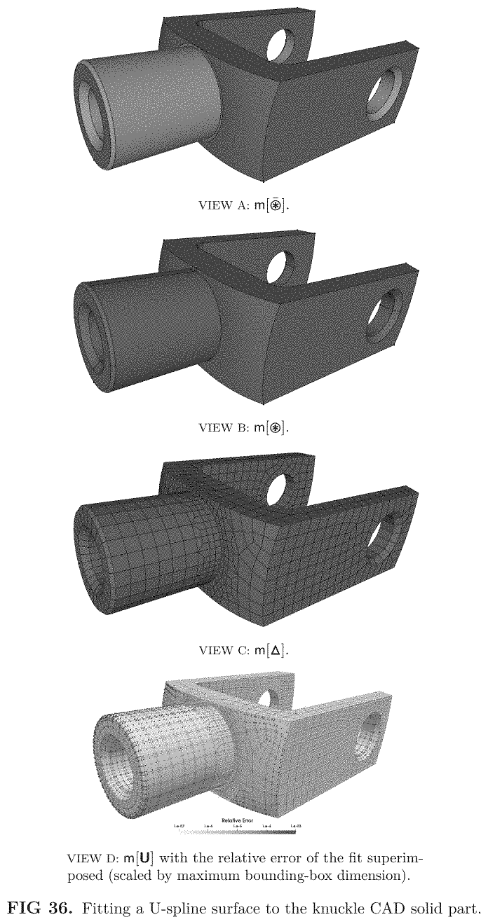

In FIG. 36, we fit a U-spline to the bounding surfaces of a knuckle CAD solid geometry. The m[ [symbol] ] representation, shown in FIG. 36, VIEW A, has several features that, to an experienced FEA analyst, appear to be suitable for structured meshing. In fact, these surfaces can be meshed with either a mapped or submapped meshing scheme. However, we recognize that these surfaces are periodic surfaces and based on our past experiences and preferences we might desire to split these periodic surfaces. Additionally, a thin surface is identified which will likely result in a poor quality m[Δ]. In FIG. 36, VIEW B, the we have constructed m[ [symbol] ] by splitting all periodic surfaces and by then compositing the thin surface with its neighbors before splitting this macrosurface in half. We then generate m[Δ], as shown in FIG. 36, VIEW C, including semi-local mesh refinement, along the base of the knuckle's cylindrical feature. Finally, we apply [symbol] Δ[\hat{Ω}^{Δ}](s) to produce m[U], as shown in FIG. 36, VIEW D.

### Automotive Sheet Metal Part

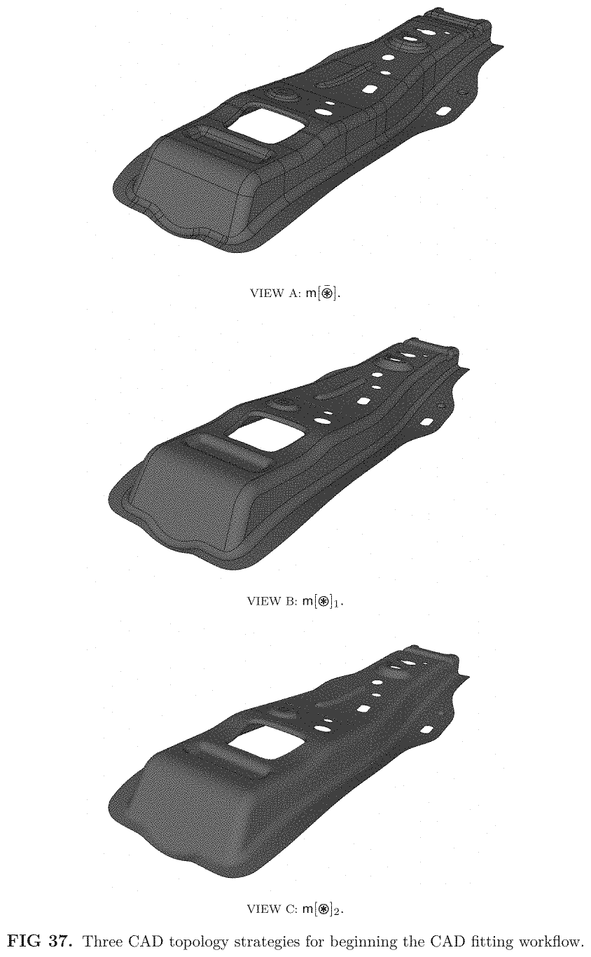

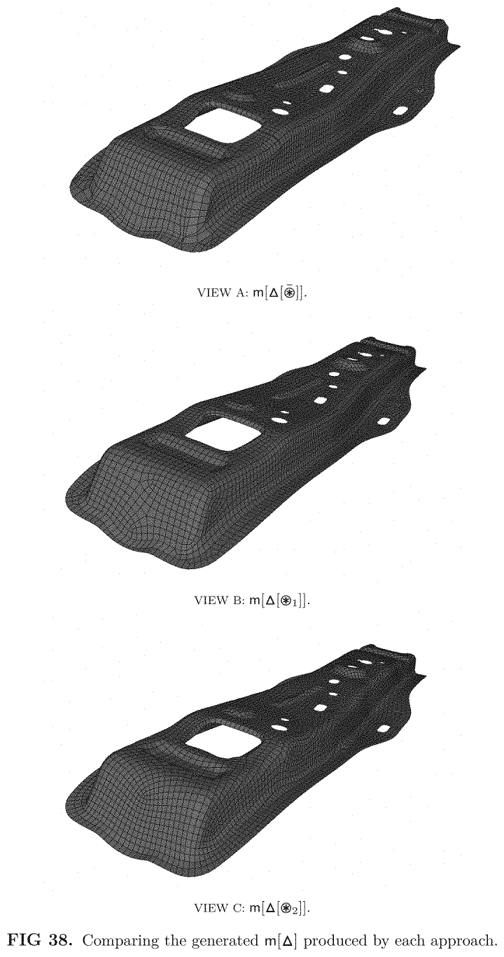

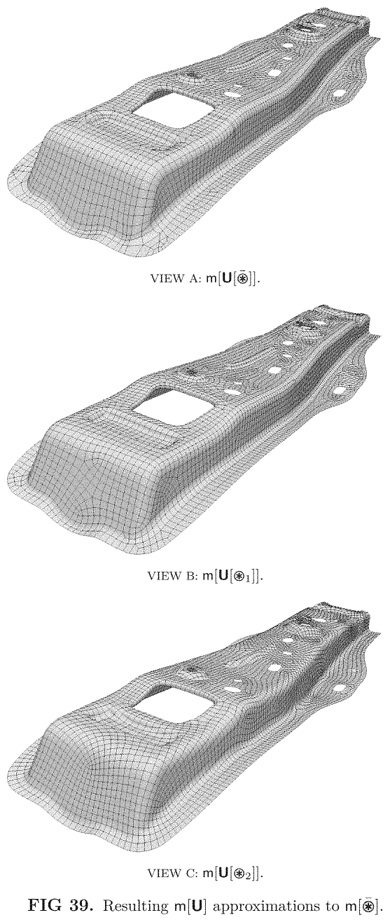

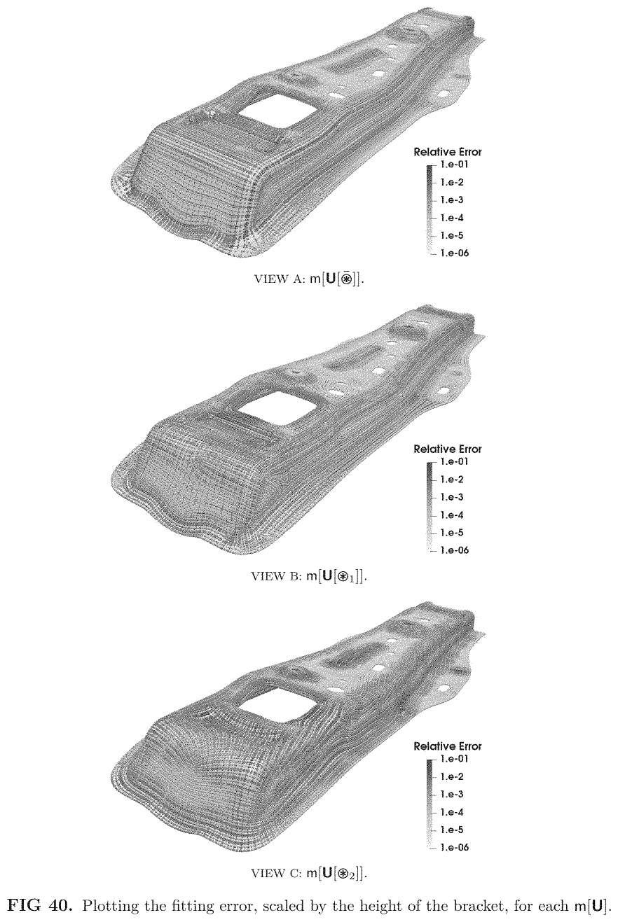

Next, we compare the m[U] produced by m[ [symbol] ] and two different approaches for constructing m[ [symbol] ] on the automotive sheet-metal part, shown in FIG. 37, VIEW A to 37, VIEW C and represented by a midsurface CAD geometry. In the first of these two approaches, m[ [symbol] ]₁, shown in FIG. 37, VIEW B, we selected general geometric features of m[ [symbol] ] to composite into macrosurfaces. In the second approach, m[ [symbol] ]₂, shown in FIG. 37, VIEW C, we have constructed a single macrosurface. While the creation of m[ [symbol] ]₁ requires human interaction, m[ [symbol] ]₂ can be completely automated and requires no human interaction. The various m[Δ] are compared in FIG. 38, VIEW A to 38, VIEW C, where it can be observed that the m[Δ] associated with m[ [symbol] ] has more highly skewed segments, and more regions of rapidly changing segment size than either of the m[ [symbol] ]ᵢ. It can also be observed that m[ [symbol] ]₁ appears to have d-cells that closely align with the main geometric features, while d-cells of m[ [symbol] ]₂ have a tendency to “crossover” fillets and blends at varying angles. We apply [symbol] Δ[\hat{Ω}^{Δ}](s) to produce the m[U], shown in FIG. 39, VIEW A to 39, VIEW C. The fitting error, superimposed on the U-spline and scaled by the vertical height of the geometry, is shown in FIG. 40, VIEW A to 40, VIEW C and summarized in Table 5.3. These results demonstrate the accuracy of the U-spline to CAD fitting algorithm.

TABLE 5.3
Comparing the fitting error between the constructed m[∪]
in FIG. 39 and the original CAD m[ [symbol] ].

| Mesh case | Average absolute deviation | Max absolute deviation |
|---|---|---|
| m[ [symbol] ] | 6.19E−4 | 6.04E−2 |
| m[ [symbol] ]₁ | 7.43E−4 | 3.43E−1 |
| m[ [symbol] ]₂ | 1.40E−3 | 8.93E−2 |

### Computational Efficiency

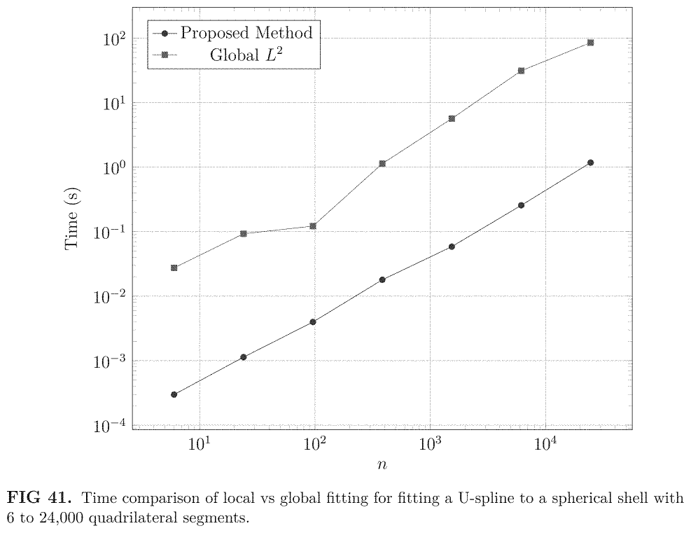

A key feature of the proposed CAD fitting algorithms is the use of Bézier projection. Bézier projection does not require a single global linear solve leading to CAD fitting schemes that are highly performant. FIG. 41 shows a comparison between global (i.e., [symbol] ₂ projection) and local (i.e., Bézier projection) fitting on a spherical shell meshed with six quads, progressively h-refined. Using local fitting rather than global fitting in this test gives a speed improvement of approximately two orders of magnitude.

### Convergence Properties

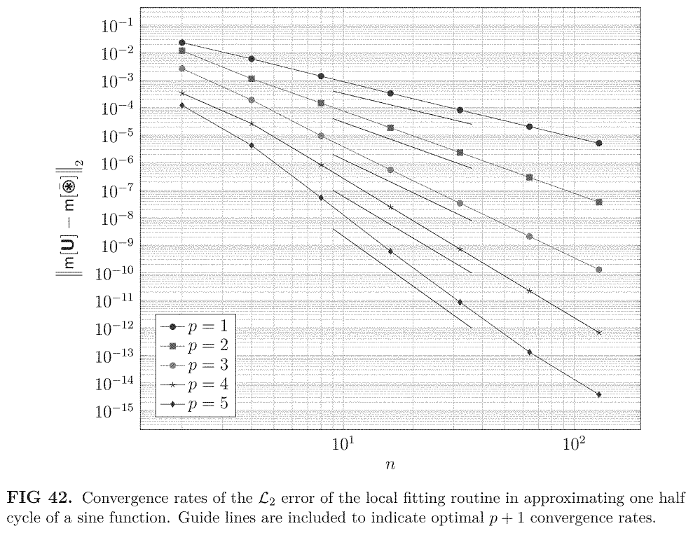

It is known that. Bézier projection combined with a local [symbol] ₂ projection possesses best approximation properties. The method we are proposing uses local interpolation, rather than local [symbol] ₂ projection. We perform convergence studies on this approach for approximating a half cycle of a sine function. The convergence of the [symbol] ₂ error is shown in FIG. 42, demonstrating that optimal convergence rates are achieved.

### Local Error Dissipation

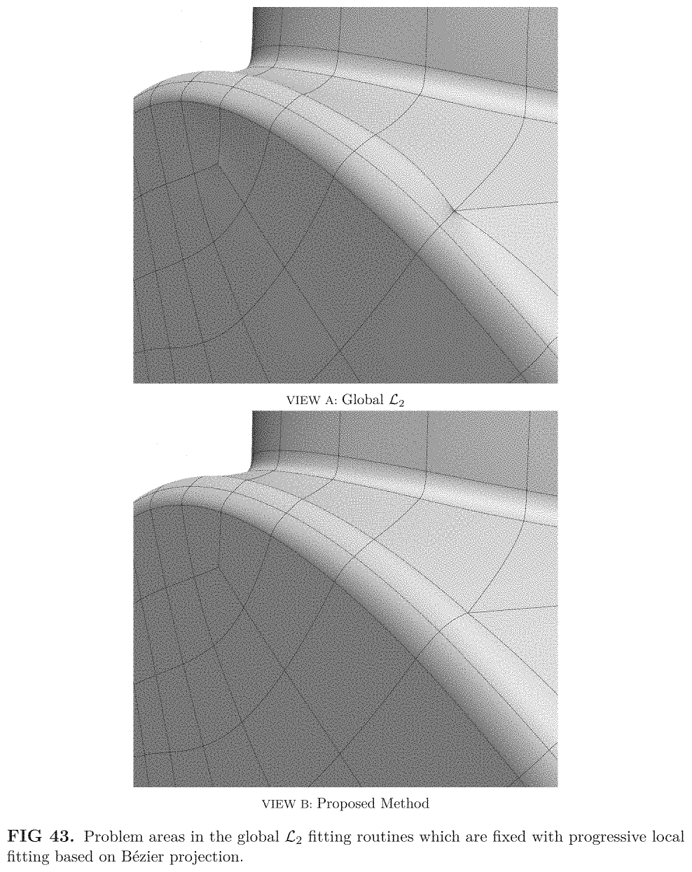

Global projection often creates unwanted artifacts near extraordinary vertices, and produces additional waviness near sharp corners because of the global nature of the method. CAD fitting based on Bézier projection mitigates many of these issues due to the local nature of the fitting procedure. For example, in FIG. 43, VIEW A there are two extraordinary vertices which protrude as sharp corners after a global [symbol] ₂ fitting routine, and a poorly fit fillet. The same area fit with the proposed progressive fitting scheme based on Bézier projection is shown in FIG. 43, VIEW B, where the extraordinary vertices are well fit and the fillet is a much better approximation to the original CAD.

### Fitting a Cubic U-Spline to the Sheet Metal Part

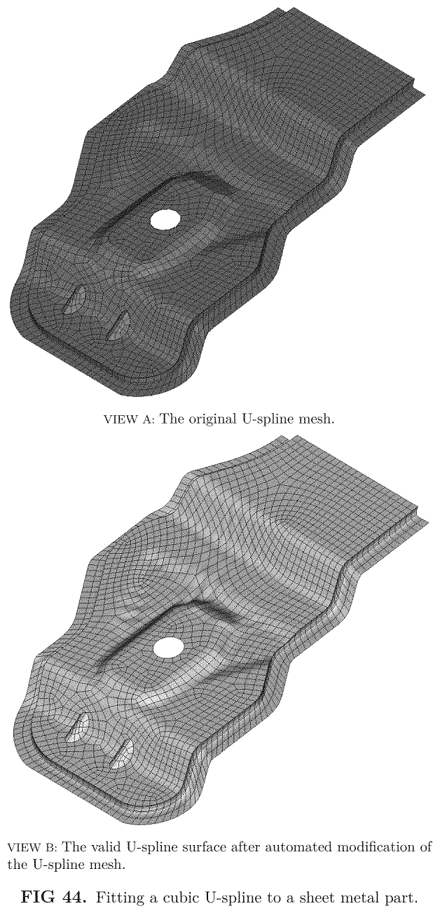

FIG. 44, VIEW A shows a cubic (p=3, ν=2) U-spline fit to the sheet metal part originally shown in FIG. 6. In particular, FIG. 44, VIEW B shows the importance of automated algorithms for ensuring that the underlying U-spline basis is admissible. Creasing of extraordinary points and geometric features of interest can lead to inadmissible U-spline mesh layouts. Resolving these inadmissible mesh layouts becomes increasingly challenging as the continuity of the U-spline basis increases.

### Fitting a Quadratic U-Spline to a Gasket Cover

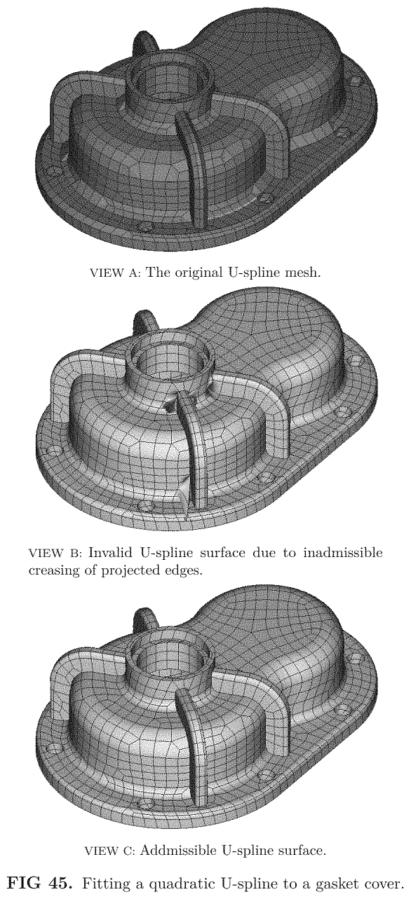

FIG. 45 shows how geometric features of interest in the physical model impose constraints on the underlying U-spline basis. In this case, capturing the sharp corners in the CAD geometry requires creasing the corresponding edges in the underlying U-spline mesh shown in FIG. 45, VIEW A. However, it is not enough to crease just, these lines, as shown in FIG. 45, VIEW B. We need to crease the edges in the U-spline mesh such that the U-spline mesh is also admissible as shown in FIG. 45, VIEW C.

### Volume Fitting

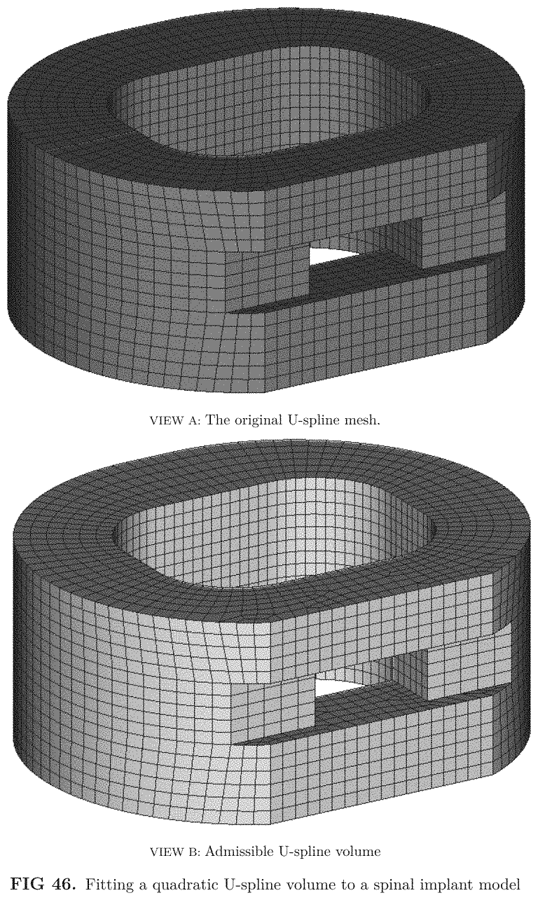

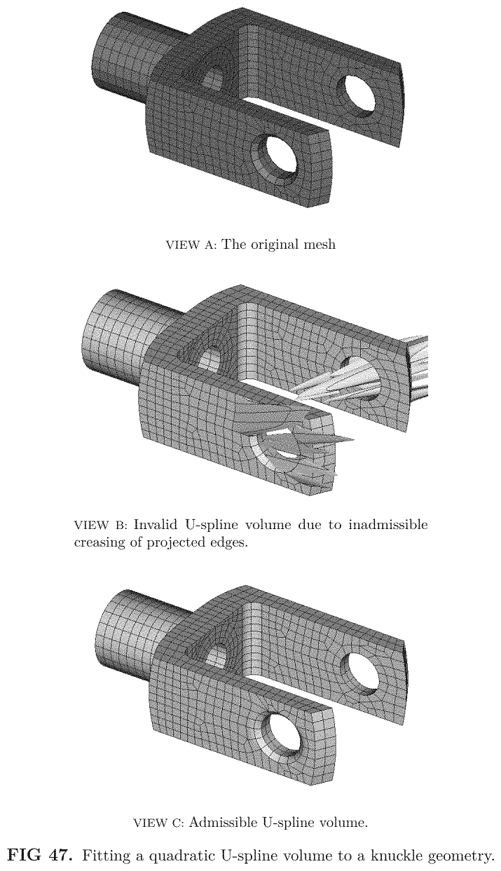

FIG. 46. VIEW A and 46, VIEW B and FIG. 47, VIEW A to 47, VIEW C illustrate the behavior of the U-spline to CAD fitting algorithm for U-spline volumes. As expected, high-quality approximations to the original CAD models is achieved in both cases.

### 5.5.2 C-Frame Failure: A Demonstration of a Flex Workflow

### Objective

Introduce the Flex Workflow and Describe how this Workflow Influences Modeling Descisions.

In this section we describe in detail a typical Flex workflow. In the Flex workflow the CAD geometry is decoupled from the envelope domain (i.e. the meshed geometry). This leads to different decisions compared to setting up an analysis model for traditional FEA approaches. For example, geometry simplification and defeaturing decisions are based on desired analysis traits and not on meshing constraints or restrictions. The workflow for the problem presented in this section includes the following steps:
1. A CAD model is created that includes all the geometric features that, are important for the simulation. Defeaturing to accommodate meshing is not needed.
2. Simulation attributes are set directly on the CAD model. Simulation attributes include boundary conditions, material properties, or any other attribute required to fully instantiate the physical model being simulated. The CAD may be further partitioned as needed to precisely describe the regions where certain types of simulation attributes are set.
3. A U-spline envelope CAD domain is defined. This step is the heart of the FRM. There are a variety of envelope domains that could be created, from a fully body-fitted mesh ( [symbol] _{0̅}) to a fully immersed model ( [symbol] _{∞}). For this problem we will create a mesh that captures the overall shape of the CAD but does not resolve features like holes and fillets.
4. Simulation results are generated. These results may include quantities of interest such as displacement and stress.

### Problem Definition

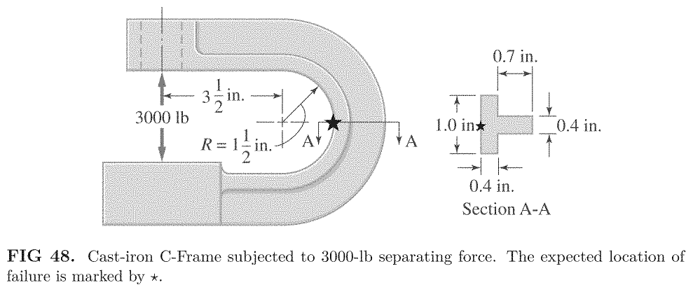

An engineer is asked to design a 1½-ton hydraulic press that is to be used for removing and reinstalling bearings in small to medium-size electric motors. The press will consist of a commercially available hydraulic cylinder mounted vertically in a C-Frame. The dimensions of the C-Frame are sketched in FIG. 48. It is being proposed to use ASTM A-48 (Class 50) gray cast iron for the C-Frame material. Predict whether the C-Frame can support the maximum load without failure.

### Geometry Definition

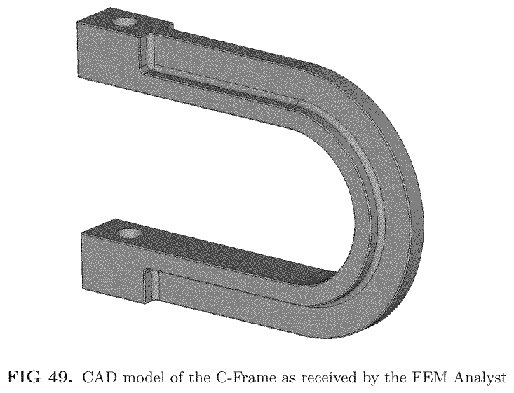

The problem schematic is shown in FIG. 48 and the provided CAD model is shown in FIG. 49. The dimensions in the schematic are represented in the CAD model, however, slight liberties were taken where there were no dimensions listed, such as fillets. Additional fillets were added as might be expected in a real CAD model, where fillets are often used to remove sharp edges that may pose a handling hazard.

### Analytic Solution

Before setting up the analysis model we first used an initially-curved beam deflection approach to calculate an estimate of the tensile stress at the expected location of failure indicated with a ★ in FIG. 48. From this calculation we estimated that the maximum principal stress at ★ is σ₁=127.2 ksi.

### FRM Analysis

### Load and Boundary Conditions

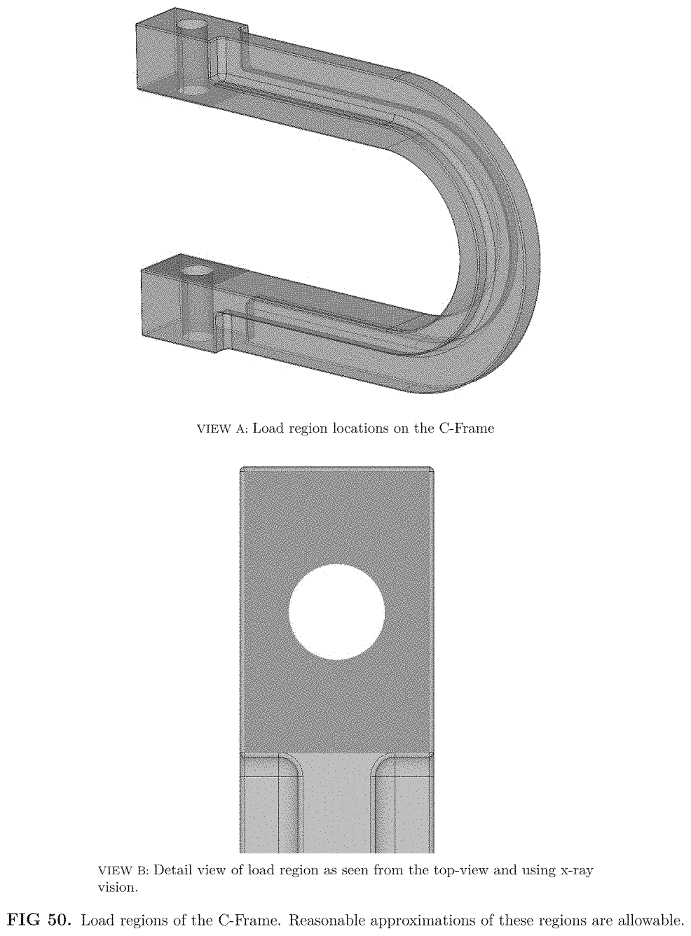

To specify the regions for the load condition shown in FIG. 48, we partition the relevant surfaces within the physical domain, resulting in two new surfaces (FIG. 50, VIEW A and 50, VIEW B) that will be assigned a uniform pressure. To minimize additional boundary conditions and constrain rigid body translations we add a nominal mass density to the material and apply the load over a small number of time steps to represent a quasi-static loading condition. Since brittle material typically fails at small strains a small-strain linear elastic material model is used.

### Material Parameters

As mentioned in the previous section, we will provide a nominal non-zero density for the material—the density will not correlate to the actual material density. We create and assign an isotropic linear elastic material model, with the parameters listed in Table 5.4.

TABLE 5.4
Material properties used for the isotropic linear elastic material model.

| Elastic Modulus | Poisson | Density |
|---|---|---|
| 20 × 10⁶ psi | 0.29 | $1 \times {10}^{- 6} \frac{lbf \cdot {s}^{2}}{{in}^{4}}$ |

### Mesh Generation

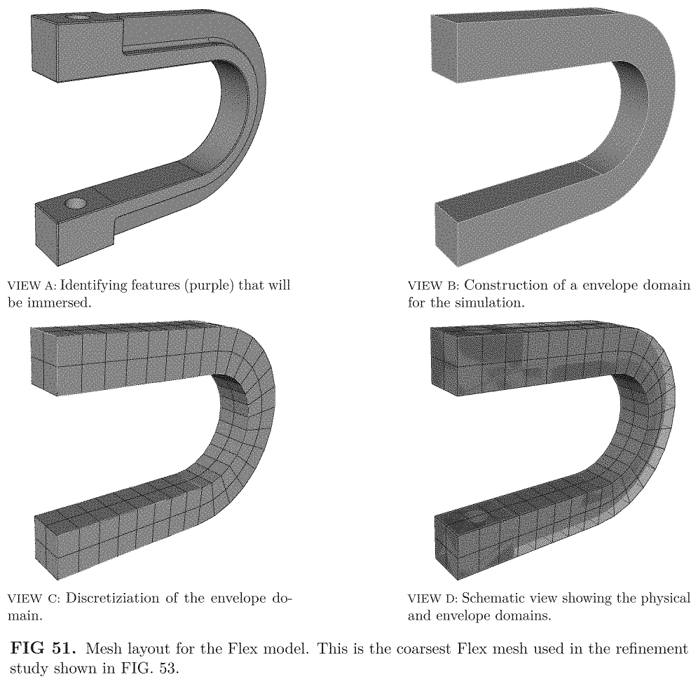

Once we have assigned loads, boundary conditions, and material parameters we then construct and mesh the envelope domain. This step is the heart of the FR M. There are a variety of envelope domains that could be created, from a fully body-fitted mesh ( [symbol] _{0̅}) to a fully immersed model ( [symbol] _{∞}). For this problem we choose to create a domain that is a balance between capturing the major features of the geometry while immersing less dominant features. We will create a envelope domain that does not include the fillets, holes, and the rib feature of the geometry, as shown in FIG. 51, VIEW A. The resulting envelope domain will have a constant square cross-section extruded along the length of the C-Frame (FIG. 51, VIEW B). The envelope domain is then trivial to mesh, requiring no geometry decomposition to produce a high-quality hex-mesh (FIG. 51, VIEW C). We compare the physical and envelope domains in FIG. 51, VIEW D. Once we have created and meshed the envelope domain, we then construct, a cubic U-spline on the discretized envelope domain, which will be used in combination with the boundary, load, and material parameters on the CAD geometry to calculate the simulation results.

### Results

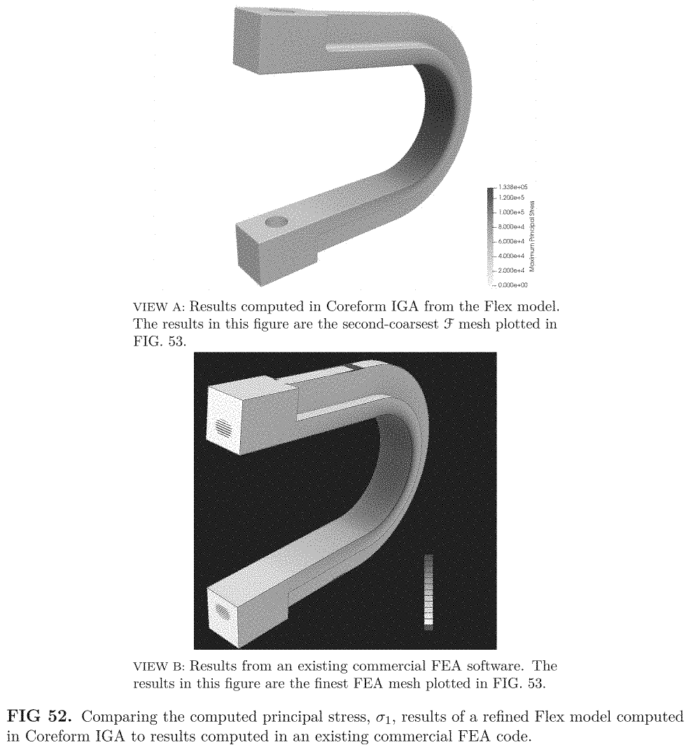

The results for the Flex model defined above are computed in Coreform IGA. (Coreform IGA is an isogeometric analysis structural solver for non-linear structural mechanics and is a product of Coreform LLC, Orem, Utah.) We have performed a refinement study for this problem to increase our confidence in these results, and we compare our results to results computed in a leading commercial FEA solver. The maximum principal stress, σ₁, is shown in the figure FIG. 52, VIEW A and 52, VIEW B, where the Flex and FEA results are compared for a refined model.

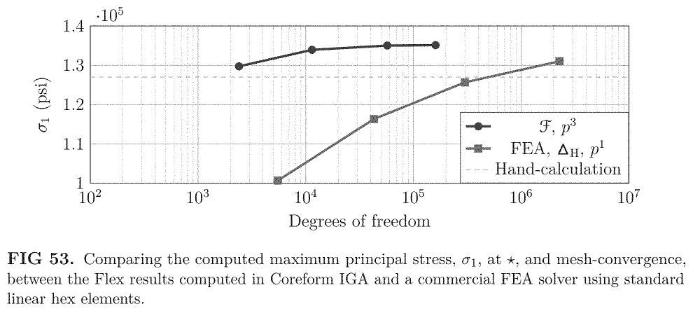

We plot the results from the convergence study in FIG. 53 where we compare the convergence of σ₁ at the point of expected maximum stress. Results from both the Flex simulation computed in Coreform IGA and the commercial FEA solver are shown. The computed stress results appear to be converging to a value ≈5% higher than our hand-calculations predict, which can be attributed to differing assumptions made in the hand-calculation vs the simulation models: small- vs finite-deformation, rigid vs real material stiffness, etc. The fact that these results are “in the ballpark” of a hand-calculation provides us with confidence that we have properly modeled this simulation.

Comparing the results from the Flex approach with the results from a traditional FEA approach it is clear that the Flex model converges to the solution much faster than traditional FEA approaches—thanks to the higher approximation power of a cubic basis than a linear basis. In fact, we see that the coarsest Flex model computes the result to the same accuracy as the finest resolution FEA model—using ≈5000× fewer elements and ≈1000× fewer degrees-of-freedom. We also note that while the Flex solution has converged to a solution, the traditional FEA approach has not yet converged.

### 5.5.3 Engine Bracket: Flex Workflow for Design Iteration and Optimization

### Objective:

Demonstrate a Flex Workflow where a Single Computational Model can be Used to Run Simulation for Many Design Iteration Models.

In this section we present a design iteration problem that illustrates how the Flex method can be integrated into a design iteration or optimization workflow. We have discussed the Flex spectrum where, for any given problem, there are a variety of computational domains that could be created, from a fully body-fitted mesh ( [symbol] _{0̅}) to a fully immersed model ( [symbol] _{∞}). For a single given design an analyst, can customize the computational domain to include as much or as little detail of the cad geometry as needed to meet the simulation requirements. For a design iteration problem, on the other hand, a computational domain can be created that creates a design envelope. Several iterations of a CAD geometry that fit within the design envelope can then be created and simulation results can be computed without recreating the computation domain. This effectively eliminates the cost of remeshing and can greatly reduce the cost of design iteration and optimization.

### Problem Definition

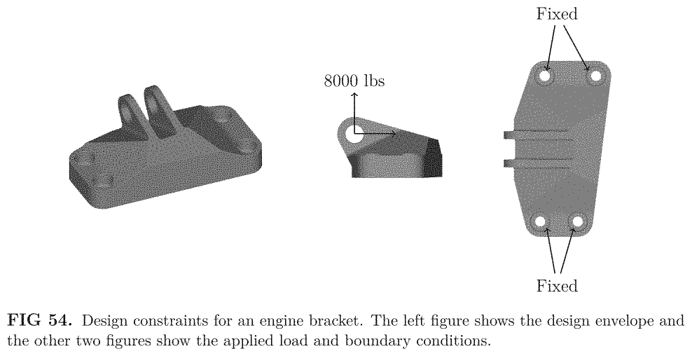

For this problem we will compute stress results for three design iterations of an engine bracket the must fit the design envelope and satisfy the load and boundary conditions shown in FIG. 54.

### Computational Domain and Results

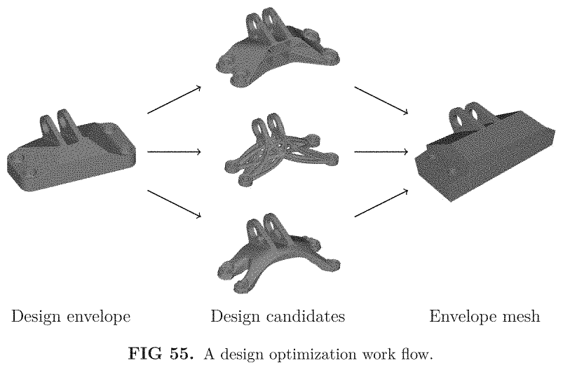

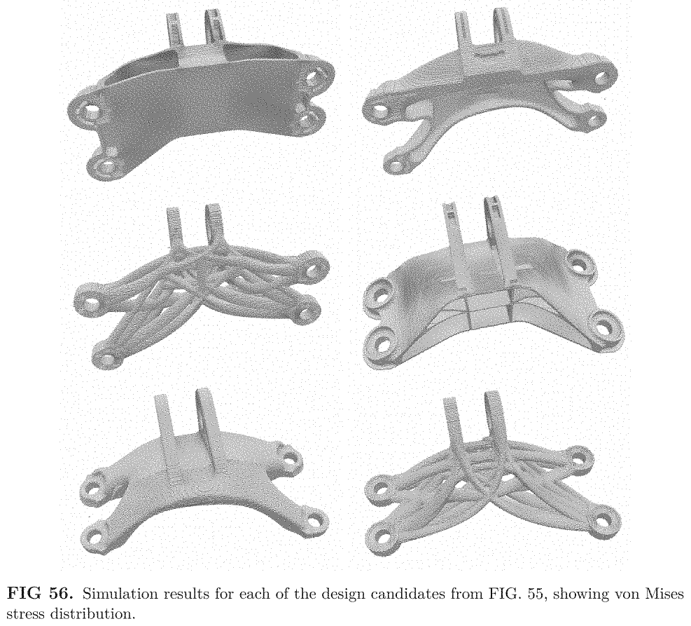

Since the design candidate must fit within the design envelope the computational domain must contain this envelope. However, the computational domain does not need to be a body-fitted mesh of the design envelope. In fact, for this problem we have chosen to create a computational domain that immerses many of the features of the design envelope but fits the surfaces where loads and boundary conditions will be applied as shown in FIG. 55.

Three design candidates are also shown in FIG. 55. Each of these designs contain features that would be very difficult to mesh in a traditional FEA context with the third design being nearly impossible to mesh. This difficulty would likely make a study of these candidates prohibitively expensive. In the FRM, however, the cost of meshing is effectively the same since the same mesh can be used for all three problems.

Results have been calculated in Coreform IGA for the three design candidates and contours of von Mises stress are plotted in FIG. 56. Once these results have been generated an analyst could then make recommendations on which design to pursue based on a maximum stress criteria, for example. Once the number of design candidates have been reduced more detailed computational models could be created to produce more accurate results if needed.

5.5.4 Infinite Plate with a Circular Hole

### Objective:

Generate Results for a Well Known Benchmark Problem that Show the Accuracy of the FRM Method in Terms of Convergence of Error Norms.

Calculating the stress concentration near a circular hole in an infinite plate is a classic problem in linear elasticity with a well known analytic solution for the stress field. In this section, we compute results for this problem using several different computational domains in the Flex spectrum from body-fitted to fully immersed. Although this is a relatively simple problem the existence of an analytical solution allows us to study the accuracy of the FRM as we change the mesh density and orientation in relation to the hole.

### Problem Definition

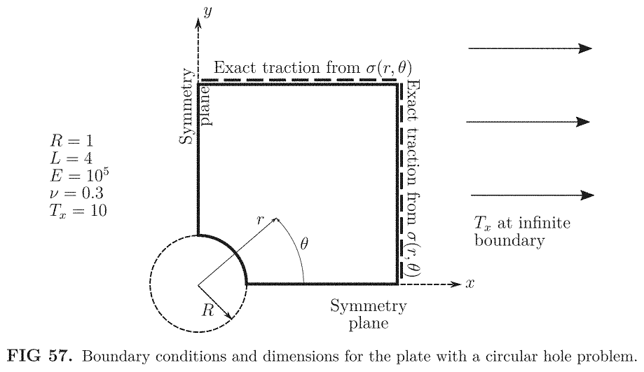

A uniform traction is applied to a plate at an infinite distance from a circular hole. For this problem the traction is applied in the x direction as shown in FIG. 57. The analytic stress field around the hole is given in polar coordinates as

$$\begin{matrix}{σ}_{rr} ( r , θ ) = \frac{{h}_{x}}{2} ( 1 - \frac{{R}^{2}}{{r}^{2}} ) + \frac{{h}_{x}}{2} ( 1 - 4 \frac{{R}^{2}}{{r}^{2}} + 3 \frac{{R}^{4}}{{r}^{4}} ) cos 2 θ , & ( 5.121 ) \\ {σ}_{θ θ} ( r , θ ) = \frac{{h}_{x}}{2} ( 1 + \frac{{R}^{2}}{{r}^{2}} ) - \frac{{h}_{x}}{2} ( 1 + 3 \frac{{R}^{4}}{{r}^{4}} ) cos 2 θ , & ( 5.122 ) \\ {σ}_{r θ} ( r , θ ) = - \frac{{h}_{x}}{2} ( 1 + 2 \frac{{R}^{2}}{{r}^{2}} - 3 \frac{{R}^{4}}{{r}^{4}} ) sin 2 θ , & ( 5.123 )\end{matrix}$$

where hₓ is the traction applied at infinity in the x direction, R is the radius of the hole, and (r,θ) are the polar coordinates with the origin at the center of the hole. For this simulation we model a symmetric finite section of the plate as shown in FIG. 57. We choose hₓ=10 and use the analytic stress value to apply exact traction values on the boundary of the simulation domain. The symmetry displacement constraints are enforced weakly using a penalty method with a penalty value of α=10⁹. The fictitious domain is penalized with a value of ε=10⁻⁹ for each problem.

### FRM Problem Setup

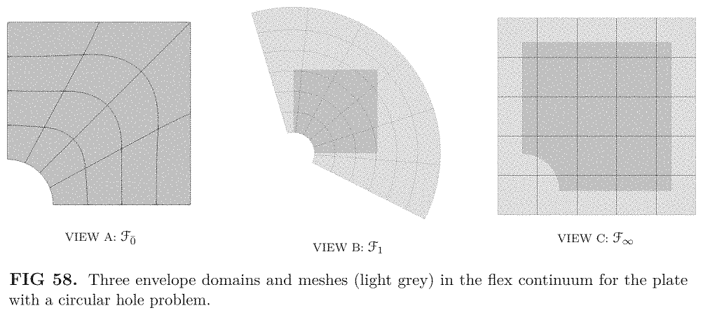

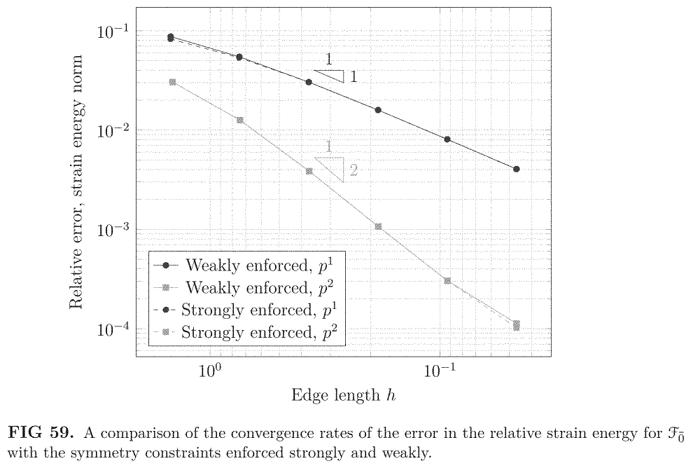

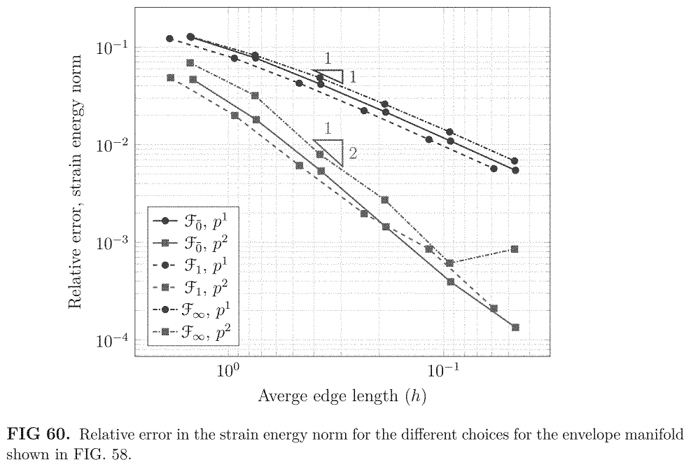

A CAD model was created that matches the dimensions shown in FIG. 57. We then created the three computational domains shown in FIG. 58. The base case that we have used as a benchmark for this problem is the fully body-fitted problem, [symbol] _{0̅}, shown in FIG. 58, VIEW A. At the other end of the Flex spectrum we have FIG. 58, VIEW C, which is a fully immersed problem. FIG. 58, VIEW B represents a model on the Flex spectrum where the computational domain fits part of the boundary, in this case the hole. We know that stress concentrations typically occur near holes so we have chosen to create a computational domain that, aligns with this feature in order to provide greater accuracy in this area.

Each of the models along the Flex spectrum shown in FIG. 57 represents a trade off between the cost of meshing and the accuracy of the results. The closer the computational domain is to [symbol] _{0̅} the higher cost is to generate the mesh. As you move along the Flex spectrum towards [symbol] _{∞} the cost of generating the mesh decreases at the expense of accuracy. However, as we will show in the convergence plots that follow, the drop in accuracy is often minimal.

Unless otherwise specified, a constant maximum level k=6 for adaptive quadrature refinement, is used on each hybrid segment. Each computational domain is constructed using U-spline technology with uniform degree p and p−1 continuity. This holds true with the exception of [symbol] _{0̅} where the interior edge adjacent to the square corner opposite the hole radius is creased to [symbol] ⁰ to preserve geometric accuracy.

### Results

### Error Calculation

For the following studies we examine the accuracy of our results in terms of the relative error in the strain energy norm. The relative error in the strain energy norm is defined as

$$e = \frac{{a ( {u}^{h} - u , {u}^{h} - u )}^{\frac{1}{2}}}{{a ( u , u )}^{\frac{1}{2}}} \qquad ( 5.124 )$$

where u^{h} is the computed displacement, u is the exact displacement, and a is the strain energy inner product.

### Accuracy of Weakly Enforced Symmetry Conditions

The symmetry constraints must be enforced on [symbol] ₁ and [symbol] _{∞} weakly because the symmetry boundaries are immersed. For consistency, we will also enforce the symmetry constraint on [symbol] _{0̅} weakly. The weak enforcement of displacement constraints is done using a standard penalty method. We compute solutions on [symbol] _{0̅} with a quadratic computational domain using both weakly enforced symmetry constraints and standard strong enforcement. The relative error in the strain energy norm for these two cases is shown in FIG. 59 for several levels of mesh refinement. As seen from this convergence plot, the impact of imposing constraints using a penalty method for this problem is negligible.

### Refinement Study

Solutions for several levels of refinement were computed for all problems in FIG. 58. This was repeated for linear and quadratic U-spline computational domains. Convergence of the relative error in the strain energy norm is plotted in FIG. 60. This plot shows that the Flex Representation Method is achieving optimal convergence rates when using linear and quadratic basis functions for the computational domain. The errors remain consistent for each Flex model.

Changing the Radius of the Hole for [symbol] _{∞}

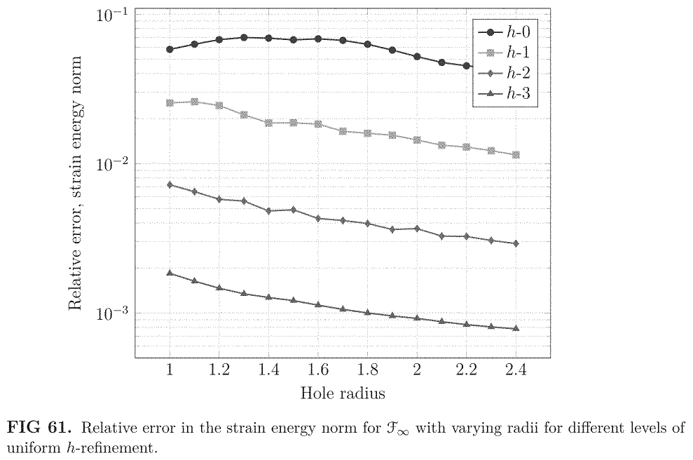

One of the distinct advantages to the Flex Representation Method is that the CAD geometry can be modified without changing the computational domain. This is especially useful when simulation results need to be computed for many design iterations, as for example in design optimization. We examine the effect this has on the accuracy of the method by changing the radius of the hole for the [symbol] _{∞} model while keeping the computation domain unchanged. The relative error in the energy norm is plotted in FIG. 61 for several levels of refinement. Note that the hole crosses the element, boundary of the coarsest mesh at r=2. These results show the stability of the Flex Representation Method with respect to changes in the CAD geometry and changes in the way that the mesh elements are cut. For the finest levels of refinement, the mesh is crossing element boundaries several times. For all cases, the magnitude of the relative error changes very little.

Rotating the Mesh on [symbol] ₁

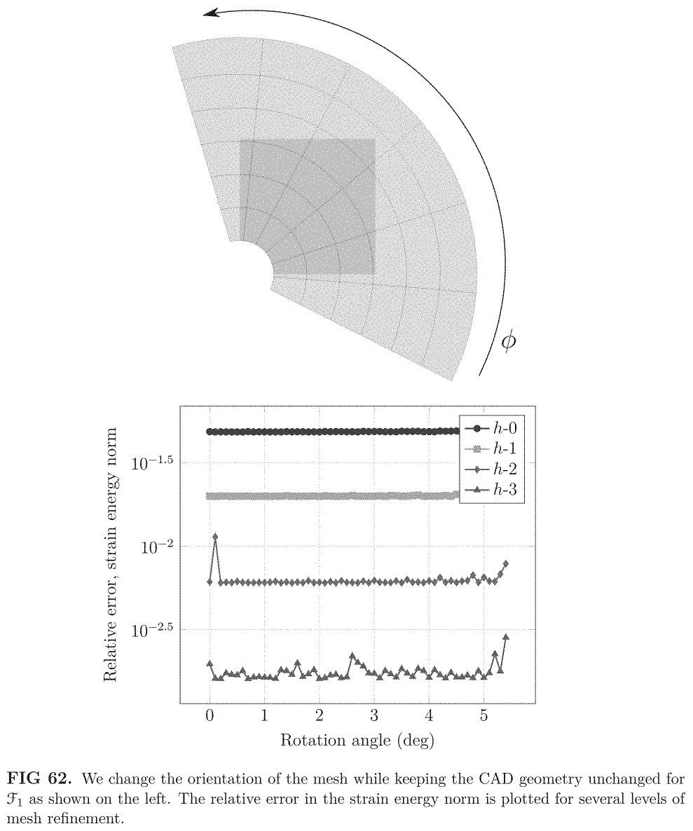

In this example we change the orientation of the mesh while keeping the CAD geometry unchanged. Using [symbol] ₁ we rotate the annular mesh so that the mesh elements cross the boundary of the CAD geometry. This allows us to explore the impact of hybrid elements on solution accuracy. In this case the hybrid elements are near a stress concentration, which would amplify any negative effect they have on solution accuracy. We start with the model shown in FIG. 58, VIEW B and rotate the mesh in increments of ϕ=0.1 degrees. For the initial mesh the radial mesh edge just inside the left boundary of the CAD model is at an angle of 5.5 degrees. As the mesh rotates the conditioning of the linear system will become worse because physical support of the hybrid cells becomes smaller near the left edge of the CAD model. The relative error in the strain energy is shown for several rotation increments and refinement levels in FIG. 62. As the rotation approaches 5.5 degrees the supported part of the hybrid cells becomes very small potentially leading to poor conditioning. Again, we see that the error is relatively stable as the mesh changes.

5.5.5 Plate with an Elliptical Hole

### Objective:

Study the Stability of Stress Calculations with Respect to Mesh Density and Envelope Domain Orientation.

A plate with an elliptical hole provides additional complexity in our study of the flex representation method. The eccentricity of the ellipse means that the nature of hybrid cells changes as the orientation of the envelope domain changes in relation to the axes of the ellipse. For this problem we will compute stress results for a plate with an elliptical hole at its center. The results will be computed for a number of different envelope orientations and refinement levels. The computations will be repeated for two ellipses with different eccentricity.

### Problem Definition

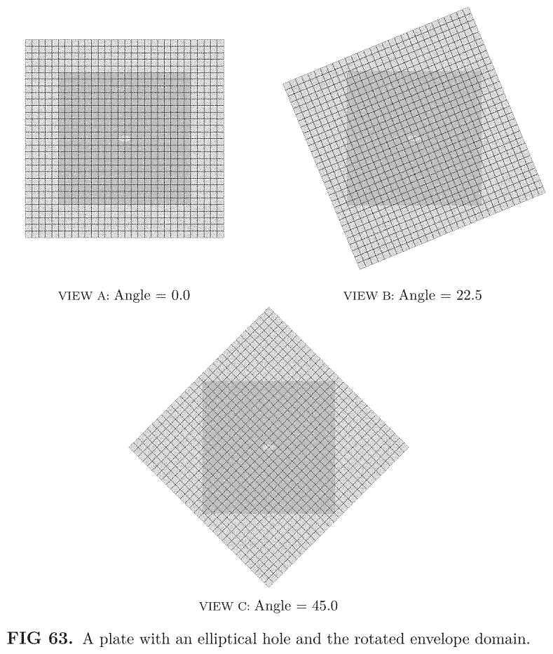

The geometry for this problem is a 20 by 20 square plate with an elliptical hole in the center of the plate. The bottom edge of the plate is constrained in the vertical direction and the left edge of the plate is constrained in the horizontal direction. A uniform upward traction of 1000 is applied to the top edge of the plate. A 30 by 30 square envelope domain is meshed at several levels of refinement and rotated as shown in FIG. 63, VIEW A to 63, VIEW C. For all problems the basis is degree 2 with C¹ continuity.

### Stress Concentration for an Infinite Plate

We can calculate an estimate for the stress concentration at the elliptical hole by considering an infinite plate that contains an elliptical hole. If the plate is subject to a uniform uniaxial stress at infinity that is orthogonal to the major radius of the hole then the maximum stress component at the hole is give by

$${σ}_{max} = {σ}_{∞} ( 1 + 2 \frac{a}{b} ) \qquad ( 5.125 )$$

where σ_{∞} is the stress at infinity, a is the major radius of the hole, and b is the minor radius of the hole.

### Results

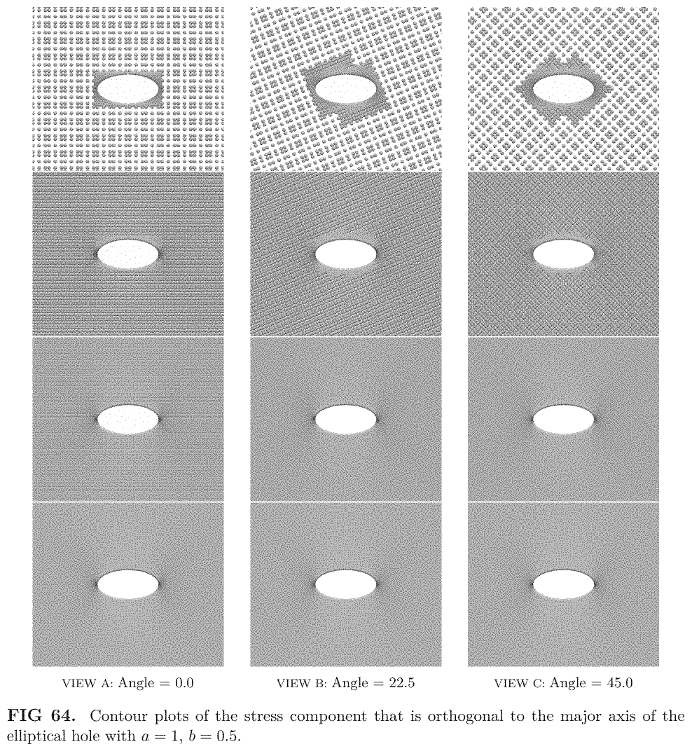

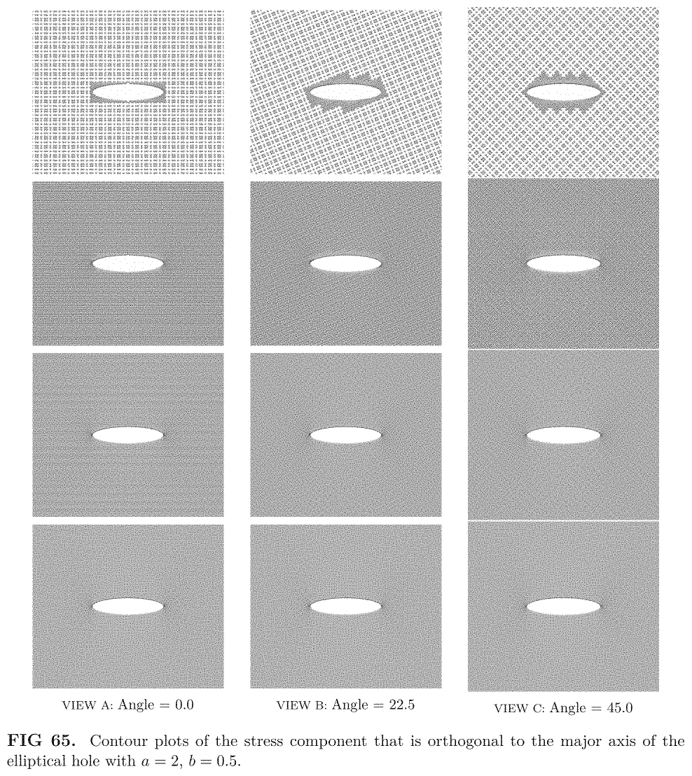

Results were computed for two elliptical holes with three envelope domain rotation angles and five levels of refinement. For both elliptical holes the minor radius was b=0.5 and the major radii were a=1.0 and a=2.0. The stress is computed at the integration points and the maximum stress component that is orthogonal to the major axis of the ellipse for each case is listed in Table 5.5 and Table 5.6. Contour plots of the stress component that is orthogonal to the major axis of the ellipse are shown in FIG. 64, VIEW A to 64, VIEW C and FIG. 65, VIEW A to 64, VIEW C.

For the case with a=1.0 and b=0.5 the estimated maximum stress component, σₘₐₓ, is 5000. Table 5.5 shows a consistent trend for each envelope rotation angle with the stress converging to a value near this estimate. Since we do not match the analytic boundary conditions for the infinite problem in the simulation we do not expect to converge to the exact value. The differences in the values computed for each rotation angle can be attributed to the orientation of the envelope domain and the differences in the location of the integration points, as seen in the coarsest refinements in FIG. 64. With the sharp stress gradients near the hole a small difference in the distance of the integration point from the hole will result in a relatively large difference in the computed stress value.

TABLE 5.5
Maximum value of the stress component that is orthogonal to the major
axis for the elliptical hole with a = 1, b = 0.5.

| | Angle = 0.0 | Angle = 22.5 | Angle = 45 |
|---|---|---|---|
| h = 1.0 | 2293 | 2465 | 2237 |
| h = 0.5 | 3849 | 3255 | 3628 |
| h = 0.25 | 5138 | 4691 | 4041 |
| h = 0.125 | 5477 | 5120 | 4959 |
| h = 0.0625 | 5229 | 5061 | 5021 |

The results for the case with a=2.0 and b=0.5 are shown in Table 5.6. These results follow a trend that is similar to what was observed for the hole with a=1.0 and b=0.5. The stress converges to a value slightly higher than the estimated σₘₐₓ=9000 but the trend is similar for each envelope orientation. The differences in value between the different envelope orientations are larger in this case. This is not surprising given the higher gradients near the boundary of the hole for this case.

TABLE 5.6
Maximum value of the stress component that is orthogonal to the major
axis for the elliptical holw with a = 2, b = 0.5.

| | Angle = 0.0 | Angle = 22.5 | Angle = 45 |
|---|---|---|---|
| h = 1.0 | 2995 | 3345 | 2854 |
| h = 0.5 | 4700 | 4671 | 2854 |
| h = 0.25 | 7368 | 7778 | 6749 |
| h = 0.125 | 9520 | 9038 | 8177 |
| h = 0.0625 | 10068 | 9814 | 9161 |

### 5.6 Exemplary Computing Environment

The processes, methods, systems, data structures, and computer program products as described herein may be accomplished, produced and may be practiced by and within computing systems. Computing systems may take on a variety of forms. Such computing systems may include one or more processors, computer memory, and computer-readable media. In particular, computer memory may store computer-executable instructions that when executed by one or more processors cause various processes or functions to be performed, such as the steps and acts as are recited in the embodiments.

A computing system may comprise one or more executable components. An executable component may exist on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

An executable component is also well understood by one having ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”. “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

Embodiments are described with reference to steps and acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

While not all computing systems require a user interface, in some embodiments, the computing system includes a user interface for use in interfacing with a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, holograms and so forth. Examples of input mechanisms might include, for instance, microphones, touchscreens, holograms, cameras, keyboards, mouse or other pointer input, sensors of any type, and so forth.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data and data structures. Such computer-readable media can be any available media that can be accessed by a general purpose or special purpose computer system. Computer-readable media that store computer-executable instructions are physical storage media. Computer-readable media that carry computer-executable instructions are transmission media. Transmission media may include signals such as radio waves. Thus, by way of example, and not limitation, embodiments of the invention can comprise at least two distinctly different kinds of computer-readable media: physical computer-readable storage media and transmission computer-readable media. Storage media comprises only physical media and expressly does not include transmission media.

Physical computer-readable storage media includes RAM, ROM. EEPROM, CD-ROM or other optical disk storage (such as CDs, DVDs, etc.), magnetic disk storage or other magnetic storage devices, or any other physical medium or hardware storage device which can be used to store desired data or program code means in the form of computer-executable instructions or data structures. Storage media and the data stored therein can be accessed by a general purpose or special purpose computer.

A network is defined as one or more data links that enable the transport of electronic data between computer systems, processes, and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired data or program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media such as a magnetic hard disc or CD-ROM at a computer system. Thus computer-readable physical storage media can be included in computer system components that also utilize or interface with transmission media. As noted above, however, storage media and transmission media are separate and distinct.

Computer-executable instructions comprise, for example, instructions and data which cause a general purpose computer, special purpose computer, or special purpose processing device to perform a certain function, process, or group of functions or processes. The computer-executable instructions may be for example binaries that are directly executable on a processor, intermediate format instructions such as assembly language, or source code such as a high-level programming language, computer-executable instructions may be instructions which must be compiled before execution on a processor or may be instructions that are interpretable by a runtime interpreter. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, mainframe computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments and so-called cloud computing systems where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

### 3.7 Exemplary Embodiments

The foregoing has provided the background, tools, and techniques for applying and using a Flex Representation Method in computer aided design (CAD) and computer aided engineering (CAE). Several illustrative (but non-limiting) examples of the actual application and use of FRM have also been provided. Embodiments of the foregoing novel and useful technology may comprise systems, computer-implemented methods, and computer program products. Systems may include computing systems, distributed processing systems, cloud computing systems, ad hoc and/or specialized CAD and CAE systems, structural design, analysis, and simulations systems, and other systems as are known to those having skill in the art.

For instance, there may be a system, such as is described in an exemplary computing environment discussed above, which is constructed and enabled to implement the Flex Representation Method. Such a system may include computer processors, computer memory, displays, I/O facilities, and include computer-executable instructions which, when executed upon the processors, causes the system to be enabled to perform (or to actually perform) particular functions and/or steps for implementing the Flex Representation Method.

Implementing the Flex Representation Method may include a number of steps or acts. Those steps or acts may include constructing a CAD model. The steps or acts may also include setting one or more simulation attributes on the CAD model. The steps or acts may also include determining a flex modeling spectrum for the CAD model with the simulation attributes. The steps or acts may also include constructing an envelope CAD domain from the flex modeling spectrum using a spline representation. The steps or acts may also include generating CAE simulation results using the envelope CAD domain and CAD model with the simulation attributes. The steps or acts may also include output the generated CAE simulation results.

Constructing an envelope CAD domain from the flex modeling spectrum may also include an interactive process wherein input is received by a computing system from a user, such as an engineer or an analyst. The received input may include data and information identifying or helping to identify envelope CAD domain. The envelope CAD domain may comprise a spline representation. The spline representation may comprise U-splines. A topology of the spline representation of the CAD envelope may be comprised of standard CAD entities and CAD decomposition, imprint, merge, and virtual topology operations. Constructing an envelope CAD domain may also include storing data in a data structure that identifies and defines the envelope CAD domain and properly associates the envelope CAD domain with the CAD model and/or the simulation attributes.

Setting one or more simulation attributes on the CAD model may also include an interactive process wherein input is received by a computing system from a user, such as an engineer or an analyst. The received input may include data and information identifying or helping to identify simulation attributes for a CAD model. Setting the simulation attributes may also include storing data in a data structure that identifies and defines the simulation attributes and properly associates the simulation attributes with the CAD model. The simulation attributes and the CAD model, as stored in one or more data structures, may be accessed by other components or processes within the system to use, analyze, or manipulate, and further process the data.

Determining a flex modeling spectrum for the CAD model with the simulation attributes may also include an interactive process wherein input is received by a computing system from a user, such as an engineer or an analyst. Received input may include data and information identifying or helping to identify a flex modeling spectrum for the CAD model with the simulation attributes. Determining a flex modeling spectrum may also include storing data in a data structure that identifies and defines the flex modeling spectrum and properly associates the flex modeling spectrum with the CAD model and/or the simulation attributes. The flex modeling spectrum, the simulation attributes, and the CAD model, as stored in one or more data structures, may be accessed by other components or processes within the system to use, analyze, or manipulate, and further process the data.

Constructing an envelope CAD domain from the flex modeling spectrum may also include an interactive process wherein input is received by a computing system from a user, such as an engineer or an analyst. The received input may include data and information identifying or helping to identify envelope CAD domain. The envelope CAD domain may comprise a spline representation. The spline representation may comprise U-splines. A topology of the spline representation of the CAD envelope may be comprised of standard CAD entities and CAD decomposition, imprint, merge, and virtual topology operations. Constructing an envelope CAD domain may also include storing data in a data structure that identifies and defines the envelope CAD domain and properly associates the envelope CAD domain with the CAD model and/or the simulation attributes. The constructed envelope CAD domain may reduce a total time required to generate accurate and robust. CAE simulation results.

An envelope CAD domain may approximate all geometric features of a CAD model. An envelope CAD domain may approximate one or more geometric features of a CAD model. An envelope CAD domain may approximate no geometric features of a CAD model. Capturing none, some, or all geometric features of a CAD domain may server to simplify the preparation of a simulation model. As previously discussed, constructing and utilizing an envelope CAD domain that captures only macroscopic geometric features of a CAD model can achieve more accurate simulation than is possible with prior or traditional immersed or finite element approaches to the problem. Further, such selective capture of geometric features can dramatically reduce both model preparation time and degree of freedom count.

Computer aided engineering (CAE) simulation results may then be generated using the envelope CAD domain and CAD model with the simulation attributes. These simulation results are an extremely important and necessary factor in the design and manufacture of nearly all mechanical parts and mechanical systems. Such simulations and results are relied upon by and designer of structural parts such as, for instance, automobile manufacturers, aerospace manufacturers, truss manufacturers, bridge builders, etc.

Once simulations results have been computed (i.e., generated), they may be output to a suitable, appropriate, or desired destination. The results may be output to a display device of a computing system. Results may be output to a display device which may enable an engineer or analyst to view and consider the results. Outputting the results may include storing the results in durable data storage for later retrieval by another design, engineering, or manufacturing component or process. Outputting the results may include communicating the results to another system or process to be used as input to another step or process in CAD, CAE, manufacturing, etc. Results stored in data storage may be aggregated and compared with other results to determine optimal (or at least improved) design details for a particular application.

Embodiments for making, using, applying a Flex Representation Method include computing systems which can enable, apply, or execute FRM. Embodiments also include methods for applying FRM which may be performed in suitable computational environments. Embodiments also include computer program products which include computer readable media having computer executable instructions encoded thereon which when read and executed by appropriate computing system-s can enable those systems to perform functions associated with FR M.

### 5.8 Conclusion

Described herein are embodiments related to the application, construction, use, and storage of the Flex Representation Method within computer aided design and computer aided engineering. The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for performing a flexible representation method (FRM) in computer aided design (CAD) and computer aided engineering (CAE), the system comprising:
one or more computer processors; and
computer readable memory having stored therein computer-executable instructions which, when executed by the one or more computer processors, configures the system to:
construct a CAD model;
set one or more simulation attributes on the CAD model;
determine a flex modeling spectrum for the CAD model with the simulation attributes;
construct an envelope CAD domain from the flex modeling spectrum using a spline representation;
generate CAE simulation results using the envelope CAD domain and CAD model with the simulation attributes; and
output the generated CAE simulation results.

2. The system of claim 1 wherein the spline representation comprises U-splines.

3. The system of claim 1 wherein a topology of the spline representation of the CAD envelope is comprised of standard CAD entities and CAD decomposition, imprint, merge, and virtual topology operations.

4. The system of claim 1 wherein the envelope CAD domain approximates all geometric features of the CAD model.

5. The system of claim 1 wherein the envelope CAD domain approximates one or more geometric features of the CAD model.

6. The system of claim 1 wherein the envelope CAD domain approximates no geometric features of the CAD model.

7. The system of claim 1 wherein the envelope CAD domain reduces a total time required to generate accurate and robust CAE simulation results.

8. The system of claim 1 wherein outputting the generated CAE simulation results comprises storing the simulation results in durable computer-readable data storage.

9. The system of claim 1 wherein outputting the generated CAE simulation results comprises displaying the simulation results on a display device.

10. A method for performing a flexible representation method (FRM) in computer aided design (CAD) and computer aided engineering (CAE), the method comprising:
constructing a CAD model;
setting one or more simulation attributes on the CAD model;
determining a flex modeling spectrum for the CAD model with simulation attributes;
constructing an envelope CAD domain from the flex modeling spectrum using a spline representation;
generating CAE simulation results using the envelope CAD domain and CAD model with the simulation attributes; and
outputting the generated CAE simulation results.

11. The system of claim 10 wherein the spline representation comprises U-splines.

12. The system of claim 10 wherein the topology of the spline representation of the CAD envelope domain is described through standard CAD decomposition, imprint, merge, and virtual topology operations.

13. The system of claim 10 wherein the envelope CAD domain approximates all geometric features of the CAD model.

14. The system of claim 10 wherein the envelope CAD domain approximates one or more geometric features of the CAD model.

15. The system of claim 10 wherein the envelope CAD domain approximates no geometric features of the CAD model.

16. The system of claim 10 wherein the envelope CAD domain is selected such that accuracy and robustness of the generated CAE simulation results improve.

17. The system of claim 10 wherein outputting the generated CAE simulation results comprises storing the simulation results in durable computer-readable data storage.

18. The system of claim 10 wherein outputting the generated CAE simulation results comprises displaying the simulation results on a digital display device.

19. A computer program product for performing a flexible representation method (FRM) in computer aided design (CAD), the computer program product comprising:
one or more computer readable storage devices having encoded therein computer-executable instructions which, when executed by one or more computer processors of a computing system, causes the processors to:
construct a CAD model;
set one or more simulation attributes on the CAD model;
determine a flex modeling spectrum for the CAD model with simulation attributes;
construct an envelope CAD domain from the flex modeling spectrum using a spline representation;
generate CAE simulation results using the envelope CAD domain and CAD model with simulation attributes; and
output the generated CAE simulation results.

20. The system of claim 19 wherein the spline representation comprises U-splines.

21. The system of claim 19 wherein the topology of the spline representation of the CAD envelope domain is described through standard CAD decomposition, imprint, merge, and virtual topology operations.

22. The system of claim 19 wherein the envelope CAD domain approximates all geometric features of the CAD model.

23. The system of claim 19 wherein the envelope CAD domain approximates one or more geometric features of the CAD model.

24. The system of claim 19 wherein the envelope CAD domain approximates no geometric features of the CAD model.

25. The system of claim 19 wherein the envelope CAD domain is selected such that accuracy and robustness of the generated CAE simulation results is improved.

26. The system of claim 19 wherein outputting the generated CAE simulation results comprises storing the simulation results in durable computer-readable data storage.

27. The system of claim 19 wherein outputting the generated CAE simulation results comprises displaying the simulation results on a digital display device.
